(19) United States
(12) Patent Application Publication
(10) Pub. No.: US 2014/0363184 A1
(43) Pub. Date: Dec. 11, 2014

(54) IMAGE FORMING APPARATUS AND IMAGE FORMING METHOD

(71) Applicants: Hideyuki Santo, Kanagawa (JP); Yukiko Iwasaki, Kanagawa (JP); Takamasa Hase, Shizuoka (JP)

(72) Inventors: Hideyuki Santo, Kanagawa (JP); Yukiko Iwasaki, Kanagawa (JP); Takamasa Hase, Shizuoka (JP)

(73) Assignee: RICOH COMPANY, LTD., Tokyo (JP)

(21) Appl. No.: 14/289,851

(22) Filed: May 29, 2014

(30) Foreign Application Priority Data
Jun. 5, 2013 (JP) 2013-118712

(51) Int. Cl. G03G 15/20

(52) U.S. Cl. CPC G03G 15/2053
USPC 399/68; 399/322

(57) ABSTRACT

An image forming apparatus, including: electrostatic latent image bearing member; electrostatic latent image forming unit; developing unit configured to develop with toner to form visible image; transferring unit; fixing unit; and discharging unit, the toner containing binder resin, colorant, and releasing agent, the binder resin containing crystalline resin containing urethane or urea bond, or both, the toner satisfying: C/(C+A)≧0.15, C being integrated intensity of part of spectrum derived from crystalline structure of the binder resin, A being integrated intensity of part of the spectrum derived from non-crystalline structure, the spectrum being diffraction spectrum of the toner as obtained by X-ray diffraction spectroscopy, storage elastic modulus G′(70) of the toner at 70° C. being 5.0×10⁴ Pa≦G′(70)≦1.0×10⁶ Pa, and storage elastic modulus G′(160) thereof at 160° C. being 1.0×10³ Pa≦G′(160)≦1.0×10⁴ Pa, and the image forming apparatus satisfying S1−S2>0, S1 and S2 being passing speeds of the recording medium in the fixing unit and the discharging unit, respectively.

### BACKGROUND OF THE INVENTION

1. Field of the Invention

The present invention relates to an image forming apparatus and image forming method, which are used for electrophotographic image formation, such as a photocopier, electrostatic printing, a facsimile, a printer, and electrostatic recording.

2. Description of the Related Art

Conventionally, an electric or magnetic image is visualized with a toner in an electrophotographic image forming apparatus or an electrostatic recording apparatus. In electrophotography, for example, after forming an electrostatic image (latent image) on a photoconductor, the latent image is developed with a toner, to form a toner image. The toner image is typically transferred onto a recording medium, such as paper, followed by being fixed by a method, such as heating. In an image forming apparatus employing the heat fixing system, a large quantity of electricity is required in a process for heating and melting the toner, and fixing on a recording medium, such as paper. Therefore, low temperature fixing ability is one of important qualities of a toner, in view of energy saving.

In order to improve low temperature fixing ability of the toner, for example, there is an attempt that a crystalline resin, which immediately melts upon application of heat during fixing, is used as a binder resin of the toner. Moreover, there is also a proposal of a toner using a crystalline resin as a main component of a binder resin in order to further improve low temperature fixing ability of the toner.

However, the temperature at which the toner containing a crystalline resin as a main component melts and is recrystallized during fixing is low, elasticity of the toner just after the fixing is low. Therefore, a surface of a resulting image causes plastic deformation as a result of contact with a discharging unit, such as discharging rollers (transport rollers) after the fixing, to thereby form a mark due to the discharging unit.

In Japanese Patent Application Laid-Open (JP-A) No. 2006-091131, for example, a mark is formed when a recording medium, on which a toner image has been fixed by a fixing unit, is brought into contact with a transfer roller before sufficiently cooling the recording medium, as wax therein is crystallized to give high gloss, and a difference in glossiness is formed. As a countermeasure for this, a problem of the glossiness difference is solved by setting the temperature of the discharging unit close to the temperature of the recording medium just after the fixing. The glossiness difference actually occurred in this phenomenon is, however, about a few percents, which can be hardly visually recognized, and the method cannot resolve a problem of a mark formed as a result of deformation of the toner.

Moreover, disclosed is a method, in which a nip pressure on a surface of an image is reduced by using a hollow elastic body as a transport roller to thereby prevent formation of a mark (see JP-A No. 2006-189568). Since a low temperature fixing toner uses a binder resin containing a crystalline resin as a main component, however, the toner has low resistance to abrasion caused by a transport roller, although the toner is relatively resistant to deformation caused by pressure. Therefore, it is difficult to inhibit formation of a mark due to a discharging unit only through the proposed method, which is reducing the nip pressure.

Moreover, disclosed is a method, in which a temperature difference of a cooled state between an image area passing through an discharging roller and an area not passing through the discharging roller, by setting a difference of the image temperature before and after passing through the discharging roller just after the fixing to less than 20° C., that is heating the discharging roller, to thereby inhibit formation of a mark (see JP-A No. 2005-284245). Also in this proposed method, however, the mark is formed due to a glossiness difference, as in JP-A No. 2006-091131. The method cannot inhibit formation of a mark caused due to deformation of the toner.

Moreover, disclosed is a method, in which a cooling unit is provided to effect just after fixing, and formation of a mark due to a discharging roller is prevented by blowing air to a toner image using the cooling unit to cool and cure the toner image before sent to the discharging roller (see JP-A No. 2006-078816). If a cooling unit is newly provided in an image forming apparatus as in this proposed method, it is difficult to achieve low cost and downsizing of the apparatus, and also there is a problem in terms of energy saving.

Accordingly, there is a need for providing an image forming apparatus, which gives excellent low temperature fixing ability, hot offset resistance, and heat resistant storage stability, and can inhibit formation of marks caused by a discharging unit.

### SUMMARY OF THE INVENTION

The present invention aims to provide an image forming apparatus, which gives excellent low temperature fixing ability, hot offset resistance, and heat resistant storage stability, and can inhibit formation of marks caused by a discharging unit.

As means for solving the aforementioned problem, the image forming apparatus of the present invention, contains:

an electrostatic latent image bearing member;

an electrostatic latent image forming unit configured to form an electrostatic latent image on the electrostatic latent image bearing member;

a developing unit configured to develop the electrostatic latent image with a toner, to thereby form a visible image;

a transferring unit configured to transfer the visible image onto a recording medium;

a fixing unit configured to fix the transferred image on the recording medium; and

a discharging unit configured to discharge the recording medium, on which the transferred image has been fixed, to outside the image forming apparatus,

wherein the toner contains a binder resin, a colorant, and a releasing agent,

wherein the binder resin contains a crystalline resin containing a urethane bond, or a urea bond, or both thereof and the toner satisfies:

C/(C+A)≧0.15

where C is an integrated intensity of part of a spectrum derived from a crystalline structure of the binder resin, and A is an integrated intensity of part of the spectrum derived from a non-crystalline structure, and the spectrum is a diffraction spectrum of the toner as obtained by X-ray diffraction spectroscopy,

wherein a storage elastic modulus G′(70) of the toner at 70° C. is 5.0×10⁴ Pa≦G′(70)≦1.0×10⁶ Pa, and a storage elastic modulus G′(160) of the toner at 160° C. is 1.0×10³ Pa≦G′(160)≦1.0×10⁴ Pa, and wherein the image forming apparatus satisfies the following formula:

S1−S2>0

where S1 is a passing speed of the recording medium in the fixing unit, and S2 is a passing speed of the recording medium in the discharging unit.

The present invention can solve the aforementioned various problems in the art, and can provide an image forming apparatus, which gives excellent low temperature fixing ability, hot offset resistance, and heat resistant storage stability, and can inhibit formation of marks caused by a discharging unit.

### BRIEF DESCRIPTION OF THE DRAWINGS

FIG. 1 is a schematic diagram illustrating one example of the image forming apparatus of the present invention.

FIG. 2 is an enlarged schematic diagram illustrating one example of an image forming unit in the image forming apparatus of FIG. 1.

FIG. 3 is an enlarged schematic diagram illustrating one example of a fixing unit in the image forming apparatus of FIG. 1.

FIG. 4 is a diagram depicting one example of a diffraction spectrum obtained by X-ray diffraction spectroscopy.

FIG. 5 is a diagram depicting one example of a diffraction spectrum obtained by X-ray diffraction spectroscopy.

FIG. 6 is a ¹³C-NMR spectrum diagram of polyurea in the region of carbonyl carbon.

### DETAILED DESCRIPTION OF THE INVENTION

### (Image Forming Apparatus and Image Forming Method)

The image forming apparatus of the present invention contains at least an electrostatic latent image bearing member, an electrostatic latent image forming unit, a developing unit, a transferring unit, a fixing unit, and a discharging unit, and may further contain appropriately selected other units, such as a cleaning unit, a diselectrification unit, a recycling unit, and a controlling unit, as required.

Note that, the electrostatic latent image forming unit, the developing unit, the transferring unit, the cleaning unit, and the diselectrification unit may be collectively referred to as an image forming unit.

The image forming method of the present invention contains at least an electrostatic latent image forming step, a developing step, a transferring step, a fixing step, and a discharging step, and may further contain appropriately selected other steps, such as a cleaning step, a diselectrification step, a recycling step, and a controlling step, as required.

Note that, the electrostatic latent image forming step, the developing step, the transferring step, the cleaning step, and the diselectrification step may be collectively referred to as an image forming step.

The image forming method of the present invention can be suitably carried out by the image forming apparatus of the present invention. The electrostatic latent image forming step can be carried out by the electrostatic latent image forming unit, the developing step can be carried out by the developing unit, the transferring step can be carried out by the transferring unit, the fixing step can be carried out by the fixing unit, the discharging step can be carried out by the discharging unit, and the aforementioned other steps can be carried out by the aforementioned other unite.

In the course of a research conducted by the present inventor for achieving low temperature fixing ability of a toner, the following problem has been found. As an amount of a crystalline resin is increased in a toner containing the crystalline resin as a binder resin, low temperature fixing ability of the toner is excellent, but hardness of the toner reduces as the hardness of the resin reduces, and moreover hardness of an image obtained by transferring the toner on a recording medium and heat-press fixed on the recording medium becomes low, especially in the case where the crystalline resin is a main component of the binder resin. Therefore, the fixed image on the recording medium just after the fixing is rubbed with a discharging unit, and a mark of the discharging unit is formed on the image.

As a result of the research diligently conducted by the present inventors based on the aforementioned problem, they have come to the following insight. As well as achieving excellent low temperature fixing ability, hot offset resistance, and heat resistant storage stability, formation of a mark due to a discharging unit is prevented by using a crystalline resin a urethane bond, a urea bond, or both thereof as a binder resin of a toner, satisfying the following formula: S1−S2>0, where S1 is passing speed of a recording medium in a fixing unit, and S2 is passing speed of the recording medium in the discharging unit, and preferably satisfying the following formula: 2%≦[(S1−S2)/S1]×100≦5%.

### <Electrostatic Latent Image Forming Step and Electrostatic Latent Image Forming Unit>

The electrostatic latent image forming step contains forming an electrostatic latent image on an electrostatic latent image bearing member.

A material, shape, structure, and size of the electrostatic latent image bearing member (may be referred to as an “electrophotographic photoconductor” or a “photoconductor” hereinafter) are appropriately selected from those known in the art without any limitation. Examples of the shape thereof include a drum shape. Examples of the material thereof include an inorganic photoconductor (e.g., non-crystalline silicon, and selenium) and an organic photoconductor (OPC) (e.g., polysilane, and phthalopolymethine). Among them, non-crystalline silicon is preferable because of its long service life.

Formation of the electrostatic latent image can be performed, for example, by uniformly charging a surface of the electrostatic latent image bearing member, followed by exposing the electrostatic latent image bearing member to light image wise. The formation of the electrostatic latent image can be carried out by the electrostatic latent image forming unit.

The electrostatic latent image forming unit is, for example, equipped with at least a charging device configured to uniformly charge a surface of the electrostatic latent image bearing member, and an exposing device configured to expose the surface of the electrostatic latent image bearing member to light image wise.

The charging can be carried out, for example, by applying voltage on a surface of the electrostatic latent image bearing member using the charging device. The charging device is appropriately selected depending on the intended purpose without any limitation, and examples thereof include a conventional contact charging device equipped with an electroconductive or semiconductive roller, brush, film, or rubber blade, and a non-contact charging device utilizing corona discharge, such as corotron, and scorotron.

As for the charging device, preferred is a charger, which is provided in contact with or without contacting the electrostatic latent image bearing member, and is configured to apply superimposed DC and AC voltage to thereby charge a surface of the electrostatic latent image bearing member.

Moreover, the charging device is preferably a charging roller provided adjacent to the electrostatic latent image bearing member via a gap tape in a non-contact manner, and superimposed DC and AC voltage is applied to the charging roller to thereby charge a surface of the electrostatic latent image bearing member.

The exposing can be carried out, for example, by exposing a surface of the electrostatic latent image bearing member to light image wise using the exposing device. The exposing device is appropriately selected depending on the intended purpose without any limitation, provided that it is capable of exposing the surface of the electrostatic latent image bearing member, which has been charged by the charging device, to light image wise corresponding to an image to be formed. Examples of the exposing device include various exposing devices, such as a reproduction optical exposing device, a rod-lens array exposing device, a laser optical exposure device, and a liquid crystal shutter optical device. Note that, in the present invention, a black light system, where image wise exposure is performed from a back side of the electrostatic latent image bearing member, may be employed.

### <Developing Step and Developing Unit>

The developing step contains developing the electrostatic latent image with a toner to form a visible image, and can be carried out by the developing unit. The developing unit is appropriately selected from those known in the art without any limitation, provided that it can perform developing using the toner. As for the developing unit, for example, a developing device, which houses the toner, and is capable of applying the toner to the electrostatic latent image in a contact or non-contact manner, is preferable, and a developing device equipped with a toner container housing the toner therein is more preferable.

The developing device may be a developing device for a single color, or a developing device for multiple colors. Suitable examples of the developing device include a developing device containing a stirrer configured to stir the developer to charge the developer through frictions, and a rotatable magnet roller. Inside the developing device, for example, the toner and a carrier are mixed and stirred together to charge the toner from the frictions caused by stirring. The charged toner is held on a surface of the rotating magnet roller in the form of a brush, to thereby form a magnetic brush. Since the magnet roller is provided adjacent to the electrostatic latent image bearing member, part of the toner constituting the magnetic brush formed on the surface of the magnet roller is transferred onto a surface of the electrostatic latent image bearing member by electric suction force. As a result, the electrostatic latent image is developed with the toner, and a visible image formed with the toner is formed on the surface of the electrostatic latent image bearing member. The toner housed in the developing device is the aforementioned toner.

### <<Toner>>

The toner contains a binder resin, a colorant, and a releasing agent, and may further contain other components, as required.

### <<<Binder Resin>>>

The binder resin contains at least a crystalline resin, and may further contain other components, such as a non-crystalline resin, as required.

### —Crystalline Resin—

The crystalline resin contains at least a crystalline resin containing a urethane bond, or a urea bond, or both thereof and may further contain other components, as required.

——Crystalline Resin containing Urethane Bond, or Urea Bond, or Both——

The crystalline resin containing a urethane bond, or a urea bond, or both thereof is appropriately selected depending on the intended purpose without any limitation, and examples thereof include a crystalline resin containing a urethane bond and/or a urea bond, and a crystalline polyester unit, a crystalline polyurethane resin, and a crystalline polyurea resin. Among them, preferred is a crystalline resin containing a urethane bond and/or a urea bond, and a crystalline polyester unit.

In the present invention, the crystalline resin is a resin contains a segment having a crystalline structure, and a diffraction spectrum thereof as measured by an X-ray diffraction spectrometer has a diffraction peak derived from the crystalline structure. For example, the crystalline resin has a ratio (softening temperature/maximum peak temperature of heat of melting) of 0.8 to 1.6, where the ratio is a ratio of softening temperature of the crystalline resin, as measured by a capillary rheometer to the maximum peak temperature of heat of melting thereof as measured by a differential scanning calorimeter (DSC), and the crystalline resin has characteristics that it is sharply soften upon application of heat.

In the present invention, moreover, the non-crystalline resin is a resin that does not have a crystalline structure, and a diffraction spectrum thereof as measured by X-ray diffraction spectrometer does not have a diffraction peak derived from a crystalline structure. For example, the non-crystalline resin has the ratio (softening temperature/maximum peak temperature of heat of melting) that is greater than 1.6, where the ratio is a ratio of the softening temperature thereof to the maximum peak temperature of heat of melting thereof, and has characteristics that it is gradually soften upon application of heat.

The softening temperature of the resin can be measured by a capillary rheometer (e.g., CFT-500D (manufactured by Shimadzu Corporation)). While heating 1 g of a resin serving as a sample at the heating rate of 3° C./min, a load of 2.94 MPa is applied to the sample by a plunger, to extrude the sample from a nozzle having a diameter of 0.5 mm, and a length of 1 mm. A dropped amount of the plunger of the capillary rheometer to the temperature is plotted, and the temperature at which a half the amount of the sample is extruded is determined as softening temperature.

The maximum peak temperature of heat of melting of the resin can be measured by means of a differential scanning calorimeter (DSC) (differential scanning calorimeter Q2000 (manufactured by TA Instruments)). As for a pre-treatment, a sample that is provided to a measurement of the maximum peak temperature of heat of melting is melted at 130° C., followed by cooling to the sample from 130° C. to 70° C. at the rate of 1.0° C./min., and then is cooled from 70° C. to 10° C. at the rate of 0.5° C./min. Then, the sample is heated at the heating rate of 10° C./min to measure a variation in an endothermic and exothermic value by DSC, and a graph of “endothermic-exothermic value” and “temperature” is drawn. The endothermic peak temperature observed in the range of 20° C. to 100° C. is determined as “Ta*.” In the case where there are a plurality of endothermic peaks, the temperature of the peak having the largest endothermic value is determined as Ta*. Thereafter, the sample is stored for 6 hours at (Ta*−10)° C., followed by storing for 6 hours at (Ta*−16)° C. Subsequently, the sample is cooled to 0° C. at the cooling rate of 10° C./min and then heated at the heating rate of 10° C./min by DSC to measure a variation in an endothermic and exothermic value, and a similar graph to the above is drawn. The temperature corresponding to the maximum peak of the endothermic value is determined as the maximum peak temperature of heat of melting.

The maximum peak temperature of heat of melting of the crystalline resin is preferably 50° C. to 70° C., more preferably 55° C. to 68° C., and particularly preferably 60° C. to 65° C., in view of achieving both low temperature fixing ability and heat resistant storage stability. When the maximum peak temperature is lower than 50° C., low temperature fixing ability of a toner is desirable, but heat resistant storage stability thereof is insufficient. When the maximum peak temperature thereof is higher than 70° C., on the other hand, heat resistant storage stability of a toner is desirable, but low temperature fixing ability thereof is insufficient.

An amount of the crystalline resin relative to the binder resin is preferably 50% by mass or greater, more preferably 65% by mass or greater, even more preferably 80% by mass or greater, and particularly preferably 95% by mass or greater, in view of exhibiting both excellent low temperature fixing ability and excellent heat resistant storage stability due to the crystalline resin, as much as possible. When the amount thereof is less than 50% by mass, sharp melting of the binder resin is not exhibited in viscoelastic properties of a resulting toner, and therefore it is difficult to attain both low temperature fixing ability and heat resistant storage stability.

In the diffraction spectrum of the toner as obtained by X-ray diffraction spectroscopy, the ratio C/(C+A) is 0.15 or greater, preferably 0.20 or greater in view of achieving both low temperature fixing ability and heat resistant storage stability, more preferably 0.30 or greater, and particularly preferably 0.45 or greater, where C is an integrated intensity of part of the spectrum derived from the crystalline structure of the binder resin, and A is an integrated intensity of part of the spectrum derived from the non-crystalline structure. When the ratio C/(C+A) is less than 0.15, there are low sharp-melt characteristics, as an amount of the segment having a crystalline structure is small in the toner, and therefore it is difficult to attain desirable balance of heat resistant storage stability and low temperature fixing ability. As a result, aggregation of toner particles occur, and defective images may be formed.

The ratio C/(C+A) is an index for an amount of the crystalline unit in the binder resin, and is an area ratio of a main diffraction peak derived from the crystalline structure to a halo in a diffraction spectrum of the binder resin as obtained by X-ray diffraction spectroscopy.

The diffraction spectrum obtained in accordance with the X-ray diffraction spectroscopy can be measured by means of an X-ray diffractometer equipped with a 2D detector (D8 DISCOVER with GADDS, of Bruker Japan). As for a capillary tube for use in the measurement, a marked tube (Lindemann glass) having a diameter of 0.70 mm is used. A sample is loaded in the capillary tube up to the top of the capillary tube to carry out the measurement. At the time when the sample is loaded, tapping is performed, and a number of taps is 100 times. Specific conditions for the measurement are as follows:

Tube current: 40 mA
Tube voltage: 40 kV
Goniometer 2θ axis: 20.0000
Goniometer Ω axis: 0.0000°
Goniometer φ axis: 0.0000°
Detector distance: 15 cm (wide angle measurement)
Measuring range: 3.2≦2θ(°)≦37.2
Measuring time: 600 sec

As for an incident optical system, a collimator having a pin hole having a diameter of 1 mm is used. The obtained 2D data was integrated using the supplied software (x axis: 3.2° to 37.2°) to invert the 2D data into 1D data of diffraction intensity and 2θ.

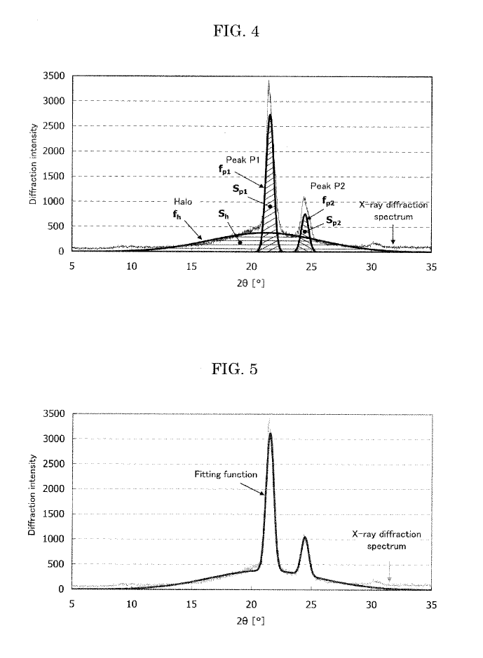

A method for calculating the ratio C/(C+A) based on the result obtained from the X-ray diffraction spectroscopy is explained hereinafter. Examples of the diffraction spectrums obtained by X-ray diffraction spectroscopy are depicted in FIGS. 4 and 5. The horizontal axis represents 2θ, and the vertical axis represents X-ray diffraction intensity. In the X-ray diffraction spectrum depicted in FIG. 4, there are main peaks (P1, P2) at 2θ=21.3°, 24.2°, and a halo (h) is observed over a wide range including these two peaks. Here, the main peaks are derived from a crystalline structure, and the halo is derived from a halo. The two main peaks, and halo are respectively represented with Gaussian functions of the following formulae A(1) to A(3).

fₚ₁(2θ)=aₚ₁exp{−(2θ−bₚ₁)²/(2cₚ₁²)} Formula A(1)

fₚ₂(2θ)=aₚ₂exp{−(2θ−bₚ₂)²/(2cₚ₂²)} Formula A(2)

fₕ(2θ)=aₕexp{−(2θ−bₕ)²/(2cₕ²)} Formula A(3)

In the formulae above, fₚ₁(2θ), fₚ₂(2θ), fₕ(2θ) are functions corresponding to the main peaks P1, P2, and halo, respectively.

Then, the following formula A(4) represented as a sum of these three functions is used as a fitting function (depicted in FIG. 5) of the entire X-ray diffraction spectrum, and fitting is performed by the least-squares method.

f(2θ)=fₚ₁(2θ)+fₚ₂(2θ)+fₕ(2θ) Formula A(4)

The variables for the fitting are 9 variables, i.e., aₚ₁, bₚ₁, cₚ₁, aₚ₂, bₚ₂, cₚ₂, aₕ, bₕ, and cₕ. As for a fitting initial value of each variable, peak positions of X-ray diffraction (bₚ₁=21.3, bₚ₂=24.2, bₕ=22.5, in the examples depicted in FIGS. 4 and 5) are set for bₚ₁, bₚ₂, and bₕ, and for other variables, values are appropriately assigned, and the values with which the two main peaks and halo are matched to the X-ray diffraction spectrum as close as possible are set as the fitting initial values of the aforementioned other variables. The fitting can be performed, for example, using a solver, Excel 2003 (of Microsoft Corporation).

The ratio [C/(C+A)], which is an index for an amount of the crystalline segments, can be calculated from the integrated areas (S_{P1}, Sₚ₂, Sₕ) of Gaussian functions fₚ₁(2θ) and fₚ(2θ), which are corresponded to the two main peaks after the fitting (P1, P2), and Gaussian function fₕ(28), which is corresponded to the halo, where (Sₚ₁+Sₚ₂) is determined as (C), and (Sₕ) is determined as (A).

The weight average molecular weight Mw of the crystalline resin is preferably 2,000 to 100,000, more preferably 5,000 to 60,000, and particularly preferably 8,000 to 30,000, in view of low temperature fixing ability. When the weight average molecular weight thereof is smaller than 2,000, hot offset resistance of a resulting toner tends to be insufficient. When the weight average molecular weight thereof is greater than 100,000, low temperature fixing ability of a resulting toner tends to be insufficient.

The weight average molecular weight Mw of the crystalline resin can be measured by means of a gel permeation chromatography (GPC) measuring device (e.g., GPC-8220GPC, manufactured by Tosoh Corporation). As for a column, for example, TSKgel Super HZM-H, 15 cm, three connected columns (of Toeoh Corporation) are used. A resin to be measured is formed into a 0.15% solution with tetrahydrofuran (THF) (containing a stabilizer, manufactured by Wako Chemical Industries, Ltd.), the obtained solution is filtered with a filter having an opening size of 0.2 μm, and the filtrate is used as a sample. The THF sample solution (100 μL) is injected into the measuring device, and the measurement is performed in the environment having the temperature of 40° C. at the flow rate of 0.35 mL/min. For the measurement of the molecular weight of the sample, a molecular weight of the sample is calculated from the relationship between the logarithmic value of the calibration curve prepared from a several monodisperse polystyrene standard samples and the number of counts. As for the monodisperse polystyrene standard sample, Showdex STANDARD Std. Nos. S-7300, S-210, S-390, S-875, S-1980, S-10.9, S-629, S-3.0, and S-0.580 of SHOWA DENKO K.K., and toluene are used. As the detector, a refractive index (RI) detector is used.

### ——Resin Containing Crystalline Polyester Unit——

The crystalline resin preferably contains a resin containing a crystalline polyester unit, because a melting point of a resulting toner is easily set, and the resulting toner has excellent binding ability to paper.

An amount of the resin containing a crystalline polyester unit is preferably 50% by mass or greater, more preferably 60% by mass or greater, even more preferably 75% by mass or greater, and particularly preferably 90% by mass or greater, relative to a total amount of the binder resin. This is because low temperature fixing ability of a resulting toner is more excellent, as an amount of the resin containing a crystalline polyester unit therein increases.

Examples of the resin containing a crystalline polyester unit include a resin composed only of a crystalline polyester unit (may be also referred to merely as a “crystalline polyester resin”), a resin, in which a crystalline polyester unit is linked, and a resin, in which a crystalline polyester unit is bonded to another polymer (so-called a block polymer, or a graft polymer).

A majority of area of the resin composed only of the crystalline polyester unit has a crystalline structure, but such the resin tends to be easily deformed by external force. The reasons thereof are considered as follows. It is difficult to crystallize the entire part of the crystalline polyester, and the part where it is not crystallized (non-crystalline segment) is easily deformed as a degree of freedom of molecular chains thereof is high. Even in the part having a crystalline structure, a high-order structure thereof is typically so-called a lamella structure where planes are formed by folding a molecular chain, and the planes are laminated. As a large bonding force does not work between lamella layers, the lamella layers are easily dislocated.

If the binder resin for a toner is easily deformed by external force, problems may occur, such as deformation and aggregation of the toner in an image forming apparatus, deposition or adhesion of the toner to a member, and a tendency that a finally output image is damaged. Therefore, the binder resin needs to be resistant to deformation to some degree upon application of external force, and to have toughness. In view of giving toughness to the resin, preferred are a resin, in which a crystalline polyester unit having a urethane bond segment, a urea bond segment, or a phenylene segment, which has large cohesive energy, is bonded, and a resin in which a crystalline polyester unit and another polymer are bonded (so-called a block polymer, and graft polymer). Among them, the resin, in which a crystalline polyester unit having a urethane bond segment or a urea bond segment is bonded, is preferable, as the presence of the urethane bond segment or urea bond segment in a molecular chain is considered to form an apparent crosslink point at the non-crystalline segment or between lamella layers due to large intermolecular force, and the resin is wettable to paper even after fixing to paper to enhance fixing strength.

### ———Crystalline Polyester Unit———

The crystalline polyester unit is appropriately selected depending on the intended purpose without any limitation, and examples thereof include a polycondensation polyester unit synthesized from polyol and polycarboxylic acid, a lactone ring-opening polymerization product, polyhydroxycarboxylic acid. Among them, a polycondensation polyester unit synthesized from diol and dicarboxylic acid is preferably in view of exhibition of crystallinity.

Examples of the polyol include diol, and trihydric to octahydric or higher polyol.

The diol is appropriately selected depending on the intended purpose without any limitation, and examples thereof include: aliphatic diol, such as straight-chain aliphatic diol, and branched-chain aliphatic diol; C4-C36 alkylene ether glycol; C4-C36 alicyclic diol; alkylene oxide of the alicyclic diol (“alkylene oxide” may be referred to as “AO” hereinafter); bisphenol AO adduct; polylactone diol; polybutadiene diol; diol containing a carboxyl group; diol containing a sulfonic acid group or a sulfamic acid group; and diol containing another functional group, such as a salt thereof. These may be used alone, or in combination. Among them, aliphatic diol in which a number of carbon atoms in a chain thereof is 2 to 36 is preferable, and straight-chain aliphatic diol in which a number of carbon atoms in a chain thereof is 2 to 36 is more preferable.

An amount of the straight-chain aliphatic diol in the entire amount of diols is appropriately selected depending on the intended purpose without any limitation, but the amount thereof is preferably 80 mol % or greater, more preferably 90 mol % or greater. The amount thereof being 80 mol % or greater is advantageous, because crystallinity of a resulting resin improves, both low temperature fixing ability and heat resistant storage stability are desirably achieved, and the resin hardness tends to improve.

The straight-chain aliphatic diol is appropriately selected depending on the intended purpose without any limitation, and examples thereof include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among them, preferred are ethylene glycol, 1,3-propanediol, 1,4-butanediol, 1,6-hexanediol, 1,9-nonanediol, and 1,10-decanediol, as they are readily available.

The branched-chain aliphatic diol in which a number of carbon atoms in a chain thereof is 2 to 36 is appropriately selected depending on the intended purpose without any limitation, and examples thereof include 1,2-propylene glycol, butane diol, hexane diol, octane diol, decane diol, dodecane diol, tetradecane diol, neopentyl glycol, and 2,2-diethyl-1,3-propanediol.

The C4-C36 alkylene ether glycol is appropriately selected depending on the intended purpose without any limitation, and examples thereof include diethylene glycol, triethylene glycol, dipropylene glycol, polyethylene glycol, polypropylene glycol, and polytetramethylene ether glycol.

The C4-C36 alicyclic diol is appropriately selected depending on the intended purpose without any limitation, and examples thereof include 1,4-cyclohexane dimethanol, and hydrogenated bisphenol A.

The alkylene oxide (may be abbreviated as AO hereinafter) of the alicyclic diol is appropriately selected depending on the intended purpose without any limitation, and examples thereof include adducts (a number of moles added: 1 to 30) of ethylene oxide (may be abbreviated as EO hereinafter), propylene oxide (may be abbreviated as PO hereinafter), and butylenes oxide (may be abbreviated as BO hereinafter).

The bisphenol is appropriately selected depending on the intended purpose without any limitation, and examples thereof include AO (e.g., EO, PO, and BO) adducts (a number of moles added: 2 to 30) of bisphenol A, bisphenol F, or bisphenol S.

The polylactone diol is appropriately selected depending on the intended purpose without any limitation, and examples thereof include poly ε-caprolacone diol.

The diol containing a carboxyl group is appropriately selected depending on the intended purpose without any limitation, and examples thereof include C6-C24 dialkylol alkanoic acid, such as 2,2-dimethylol priopionic acid (DMPA), 2,2-dimethylol butanoic acid, 2,2-dimethylol heptanoic acid, and 2,2-dimethylol octanoic acid.

The diol containing a sulfonic acid group or sulfamic acid group is appropriately selected depending on the intended purpose without any limitation, and examples thereof include: sulfamic acid diol, such as N,N-bis(2-hydroxyethyl)sulfamic acid, and N,N-bis(2-hydroxyethyl) sulfamic acid PO (2 mol) adduct; N,N-bis(2-hydroxyalkyl)sulfamic acid (a number of carbon atoms in the alkyl group: 1 to 6) AO adduct (e.g., EO and PO, number of moles of AO added: 1 to 6); and bis(2-hydroxyethyl)phosphate.

The neutralized salt group contained in the diol having a neutralized salt group is appropriately selected depending on the intended purpose without any limitation, and examples thereof include C3-C30 tertiary amine (e.g., triethyl amine), and alkali metal (e.g., sodium salt). Among them, the C2-C12 alkylene glycol, diol having a carboxyl group, an AO adduct of bisphenols, and any combination thereof are preferable.

Moreover, the trihydric to octahydric or higher polyol, which is optionally used, is appropriately selected depending on the intended purpose without any limitation, and examples thereof include: alkane polyol and intramolecular or intermolecular dehydrate thereof (e.g., glycerin, trimethylol ethane, trimethylol propane, pentaerythritol, sorbitol, sorbitan, and polyglycerin); C3-C36 trihydric to octahydric or higher polyhydric aliphatic alcohol such as saccharide and a derivative thereof (e.g., sucrose, and methyl glucoside); a trisphenol (e.g. trisphenol PA) AO adduct (a number of moles added: 2 to 30); a novolak resin (e.g., phenol novolak, and cresol novolak) AO adduct (a number of moles added: 2 to 30); and acryl polyol, such as a copolymer of hydroxyethyl (meth)acrylate and another vinyl-based monomer. Among them, preferred are trihydric to octahydric or higher polyhydric aliphatic alcohol and a novolak resin AO adduct, and more preferred is the novolak resin AO adduct.

Examples of the polycarboxylic acid include dicarboxylic acid, and trivalent to hexavalent or higher polycarboxylic acid.

The dicarboxylic acid is appropriately selected depending on the intended purpose without any limitation, and examples thereof include aliphatic dicarboxylic acid (e.g., straight-chain aliphatic dicarboxylic acid, and branched-chain aliphatic dicarboxylic acid), and aromatic dicarboxylic acid. Among them, preferred is straight-chain aliphatic dicarboxylic acid.

The aliphatic dicarboxylic acid is appropriately selected depending on the intended purpose without any limitation, and examples thereof include: C4-C36 alkane dicarboxylic acid, such as succinic acid, adipic acid, sebacic acid, azelaic acid, dodecane dicarboxylic acid, octadecane dicarboxylic acid, and decyl succinic acid; alkenyl succinic acid, such as dodecenyl succinic acid, pentadecenyl succinic acid, and octadecenyl succinic acid; C4-C38 alkene dicarboxylic acid, such as maleic acid, fumaric acid, and citraconic acid; and C6-C40 alicyclic dicarboxylic acid, such as dimmer acid (e.g., linoeic acid dimer).

The aromatic dicarboxylic acid is appropriately selected depending on the intended purpose without any limitation, and examples thereof include C8-C36 aromatic dicarboxylic acid, such as phthalic acid, isophthalic acid, terephthalic acid, t-butylisophthalic acid, 2,6-naphthalene dicarboxylic acid, and 4,4′-biphenyl dicarboxylic acid.

Moreover, examples of the optional trivalent to hexavalent or higher polycarboxylic acid include C9-C20 aromatic polycarboxylic acid, such as trimellitic acid, and pyromellitic acid.

Note that, as the dicarboxylic acid or trivalent to hexavalent or higher polycarboxylic acid, acid anhydrides or C1-C4 alkyl ester (e.g., methyl ester, ethyl ester, and isopropyl ester) of the above-listed acids may be used.

Among the dicarboxylic acid, single use of the aliphatic dicarboxylic acid (preferably adipic acid, sebacic acid, dodecanedicarboxylic acid, terephthalic acid, or isophthalic acid) is particularly preferable. Similarly, use of a copolymer of the aliphatic dicarboxylic acid with the aromatic dicarboxylic acid (preferably terephthalic acid, isophthalic acid, t-butylisophthalic acid, or low alkyl ester thereof) is preferable. An amount of the aromatic dicarboxylic acid in the copolymer is preferably 20 mol % or less.

The lactone ring-opening polymerization product is appropriately selected depending on the intended purpose without any limitation, and examples thereof include: a lactone ring-opening polymerization product obtained through ring-opening polymerization of lactone, such as C3-C12 monolactone (number of ester groups in a ring: one) (e.g., β-propiolactone, γ-butylolactone, δ-valerolactone, and γ-caprolactone) using a catalyst, such as metal oxide, and an organic metal compound; and a lactone ring-opening polymerization product having a hydroxyl group at a terminal thereof obtained through ring-opening polymerization of the C3-C12 monolactone using glycol (e.g., ethylene glycol, and diethylene glycol) as an initiator.

The C3-C12 monolactone is appropriately selected depending on the intended purpose without any limitation, but it is preferably ε-caprolactone in view of crystallinity.

The lactone ring-opening polymerization product may be selected from commercial products, and examples of the commercial products include highly crystalline polycaprolactone such as HIP, H4, H5, and H7 of PLACCEL series manufactured by Daicel Corporation.

The preparation method of the polyhydroxycarboxylic acid is appropriately selected depending on the intended purpose without any limitation, and examples thereof include: a method in which hydroxycarboxylic acid such as glycolic acid, and lactic acid (e.g., L-lactic acid, D-lactic acid, and racemic lactic acid) is directly subjected to a dehydration-condensation reaction; and a method in which C4-C12 cyclic ester (the number of ester groups in the ring is 2 to 3), which is an equivalent to a dehydration-condensation product between 2 or 3 molecules of hydroxycarboxylic acid, such as glycolide or lactide (e.g., L-lactide acid, D-lactide, and racemic lactic acid) is subjected to a ring-opening polymerization using a catalyst such as metal oxide and an organic metal compound. Among them, the method using ring-opening polymerization is preferable because of easiness in adjusting a molecular weight of a resultant.

Among the cyclic esters listed above, L-lactide and D-lactide are preferable in view of crystallinity. Moreover, terminals of the polyhydroxycarboxylic acid may be modified to have a hydroxyl group or carboxyl group.

——Resin in which Crystalline Polyester Unit is Linked——

Examples of a method for obtaining a resin, in which a crystalline polyester unit is linked include a method containing producing a crystalline polyester resin containing an active hydrogen, such as a hydroxyl group, at a terminal thereof in advance, and linking the crystalline polyester unit with polyisocyanate. In accordance with this method, a urethane bond site can be introduced into a skeleton of a resin, and therefore toughness of the resin can be enhanced.

Examples of the polyisocyanate include diisocyanate, and trivalent or higher polyisocyanate.

The diisocyanate is appropriately selected depending on the intended purpose without any limitation, and examples thereof include aromatic diisocyanate, aliphatic diisocyanate, alicyclic diisocyanate, and aromatic aliphatic diisocyanate. Among them, preferred are aromatic diisocyanate, in which a number of carbon atoms excluding carbon atoms in the NCO group is 6 to 20, aliphatic diisocyanate, in which the number of the carbon atoms are 2 to 18, alycyclic diisocyanate, in which the number of the carbon atoms are 4 to 15, aromatic aliphatic diisocyanate, in which the number of the carbon atoms are 8 to 15, modified products (modified product containing urethane group, carbodiimide group, allophanate group, urea group, biuret group, uretdione group, uretimine group, isocyanurate group, or oxazolidone group) of these diisocyanates, and a mixture thereof. Moreover, trivalent or higher isocyanate may be optionally used in combination.

The aromatic diisocyanate is appropriately selected depending on the intended purpose without any limitation, and examples thereof include 1,3-phenylene diisocyanate, 1,4-phenylene diisocyanate, 2,4-tolylene diisocyanate (TDI), 2,6-tolylene diisocyanate (TDI), crude TDI, 2,4′-diphenyl methane diisocyanate (MDI), 4,4′-diphenyl methane diisocyanate (MDI), crude MDI [a phosgenated product of crude diaminophenyl methane [a condensation product of formaldehyde and aromatic amine (aniline) or a mixture thereof and a mixture of diaminodiphenyl methane, and a small amount (e.g., 5% by mass to 20% by mass) of trifunctional or higher polyaminel, and polyaryl polyisocyanate (PAPI)], 1,5-naphthylene diiocyanate, 4,4′,4″-triphenylmethane triisocyanate, m-isocyanatophenylsulfonyl isocyanate, and p-isocyanatophenylsulfonyl isocyanate.

The aliphatic diisocyanate is appropriately selected depending on the intended purpose without any limitation, and examples thereof include ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethylcaproate, bis(2-isocyanatoethyl)fumarate, bis(2-isocyanatoethyl)carbonate, and 2-isocyanatoethyl-2,6-diisocyanatohexanoate.

The alicyclic diisocyanate is appropriately selected depending on the intended purpose without any limitation, and examples thereof include isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5-norbornanediisocyanate, and 2,6-norbornanediisocyanate.

The aromatic aliphatic diisocyanate is appropriately selected depending on the intended purpose without any limitation, and examples thereof include m-xylene diisocyanate (XDI), p-xylene diisocyanate (XDD, and α,α,α′,α′-tetramethylxylene diisocyanate (TMXDI).

The modified product of the diisocyanate is appropriately selected depending on the intended purpose without any limitation, and examples thereof include a modified product containing a urethane group, a modified product containing carbodiimide group, a modified product containing an allophanate group, a modified product containing a urea group, a modified product containing a biuret group, a modified product containing a uretdione group, a modified product containing a uretimine group, a modified product containing an isocyanurate group, and a modified product containing an oxazolidone group. Specific examples thereof include: a modified product of diisocyanate, such as modified MDI (e.g., urethane-modified MDI, carbodiimide-modified MDI, and trihydrocarbylphoephate-modified MDI), and urethane-modified TDI (e.g., isocyanurate-containing prepolymer); and a mixture of these modified products of the diisocyanate (e.g., a combination of modified MDI and urethane-modified TDI).

Among these diisocyanates, preferred are aromatic diisocyanate, in which a number of carbon atoms excluding carbon atoms in the NCO group is 6 to 15, aliphatic diisocyanate, in which the number of the carbon atoms is 4 to 12, and alicyclic diisocyanate, in which the number of the carbon atoms is 4 to 15. Particularly preferred are TDI, MDI, HDI, hydrogenated MDI, and IPDI.

——Resin in which Crystalline Polyester Unit is Bonded to Another Polymer——

As for a method for obtaining a resin, in which the crystalline polyester unit and another polymer are bonded, there are a method, in which a crystalline polyester unit and another polymer unit are separately produced in advance, and these units are bonded, a method, in which either a crystalline polyester unit or another polymer unit is produced in advance, and the other polymer is polymerized in the presence of the produced unit to thereby bond these unit, and a method, in which a crystalline polyester unit and another polymer unit are concurrently or successively polymerized in the same reaction system to thereby obtain the resin. The first or second method is preferable as a reaction is easily controlled according to the intended design.

Examples of the first method include a method, in which a unit having active hydrogen, such as a hydroxyl group, at a terminal thereof is prepared in advance similarly to the aforementioned method for obtaining the resin in which the crystalline polyester unit is linked, and the unit is linked with polyisocyanate. As for the polyisocyanate, those listed in the description above can be used. Moreover, the polyisocyanate can be obtained by a method where an isocyanate group is introduced at a terminal of one unit, and the isocyanate group is allowed to react with active hydrogen of another unit. In accordance with this method, a urethane bond segment can be introduced in a skeleton of the resin, and therefore toughness of the resin can be enhanced.

As for the second method, in the case where a crystalline polyester unit is prepared first, and a polymer unit prepared next is a non-crystalline polyester unit, a polyurethane unit, or a polyurea unit, the resin in which the crystalline polyester unit and another polymer are bonded can be obtained by allowing a hydroxyl group or carboxyl group present at the terminal of the crystalline polyester unit to react with a monomer used to obtain another polymer unit.

### ———Non-Crystalline Polyester Unit———

Examples of the non-crystalline polyester unit include a polycondensation polyester unit synthesized from polyol and polycarboxylic acid. As for the polyol and the polycarboxylic acid, those listed in the descriptions of the crystalline polyester unit can be used. In order to design the unit not to have crystallinity, many folding points or branching points can be provided to a polymer skeleton. In order to give folding points, for example, bisphenol or a derivative thereof (e.g., AO (e.g., EO, PO, and BO) adduct (number of moles added: 2 to 30) of bisphenol A, bisphenol F, or bisphenol S) is used as the polyol, and phthalic acid, isophthalic acid, or t-butylisophthalic acid is used as the polycarboxylic acid. In order to introduce branching points, moreover, trihydric or higher polyol or trivalent or higher polycarboxylic acid can be used.

### ———Polyurethane Unit———

Examples of the polyurethane unit include a polyurethane unit synthesized from polyol (e.g., diol, and trihydric to octahydric or higher polyol) and polyisocyanate (e.g., diisocyanate, and trivalent or higher polyisocyanate). Among them, a polyurethane unit synthesized from the diol and the diisocyanate is preferable.

As for the diol and the trihydric to octahydric or higher polyol, those listed as the diol and the trihydric to octahydric or higher polyol in the description of the polyester resin can be used.

As for the diisocyanate and the trivalent or higher polyisocyanate, those listed as the diisocyanate and the trivalent or higher polyisocyanate above can be used.

### ———Polyurea Unit———

Examples of the polyurea unit include a polyurea unit synthesized from polyamine (e.g., diamine, and trivalent or higher polyamine), and polyisocyanate (e.g., diisocyanate, and trivalent or higher polyisocyanate).

The diamine is appropriately selected depending on the intended purpose without any limitation, and examples thereof include aliphatic diamine, and aromatic diamine. Among them, preferred are C2-C18 aliphatic diamine, and C6-C20 aromatic diamine. Moreover, the aforementioned trivalent or higher amine may be optionally used.

The C2-C18 aliphatic diamine is appropriately selected depending on the intended purpose without any limitation, and examples thereof include: C2-C6 alkylene diamine, such as ethylene diamine, propylene diamine, trimethylene diamine, tetramethylene diamine, and hexamethylene diamine; C4-C18 polyalkylene diamine, such as diethylene triamine, iminobispropyl amine, bis(hexamethylene) triamine, triethylene tetramine, tetraethylene pentamine, and pentaethylene hexamine; C1-C4 alkyl or C2-C4 hydroxyalkyl substitute of the alkylene diamine or the polyalkylene diamine, such as dialkylaminopropyl amine, trimethylhexamethylene diamine, aminoethyl ethanol amine, 2,5-dimethyl-2,5-hexamethylene diamine, and methyl iminobispropyl amine; C4-C15 alicyclic diamine, such as 1,3-diaminocyclohexane, isophorone diamine, menthane diamine, and 4,4′-methylene dicyclohexanediamine (hydrogenated methylene dianiline); C4-C15 heterocyclic diamine, such as piperazine, N-aminoethylpiperazine, 1,4-diaminoethylpiperazine, 1,4-bis(2-amino-2-methylpropyl)piperazine, and 3,9-bis(3-aminopropyl)-2,4,8,10-tetraoxaspiro[5,5]undecane; and C8-C15 aromatic ring-containing aliphatic amine, such as xylene diamine, and tetrachloro-p-xylene diamine.

The C6-C20 aromatic diamine is appropriately selected depending on the intended purpose without any limitation, and examples thereof include: unsubstituted aromatic diamine, such as 1,2-, 1,3-, or 1,4-phenylenediamine, 2,4′ or 4,4′-diphenylmethanediamine, crude dophenylmethanediamine (polyphenyl polymethylene polyamine), diaminodiphenyl sulfone, benzidine, thiodianiline, bis(3,4-diaminophenyl) sulfone, 2,6-diaminopyridine, m-aminobenzyl amine, triphenylmethane-4,4′,4″-triamine, and naphthylene diamine; aromatic diamine containing C1-C4 nucleus substituted alkyl group, such as 2,4- or 2,6-tolylenediamine, crude tolylene diamine, diethyltolylene diamine, 4,4′-diamino-3,3′-dimethyldiphenylmethane, 4,4′-bis(o-toluidine), dianisidine, diaminoditolylsulfone, 1,3-dimethyl-2,4-diamino benzene, 1,3-dimethyl-2,6-diamino benzene, 1,4-diisopropyl-2,5-diamino benzene, 2,4-diaminomesitylene, 1-methyl-3,5-diethyl-2,4-diamino benzene, 2,3-dimethyl-1,4-diaminonaphthalene, 2,6-dimethyl-1,5-diaminonaphthalene, 3,3′,5,5′-tetramethylbenzidine, 3,3′,5,5′-tetramethyl-4,4′-diaminodiphenylmethane, 3,5-diethyl-3′-methyl-2′,4-diaminodiphenylmethane, 3,3′-diethyl-2,2′-diaminodiphenylmethane, 4,4′-diamino-3,3′-dimethyldiphenylmethane, 3,3′,5,5′-tetraethyl-4,4′-diaminobenzophenone, 3,3′,5,5′-tetraethyl-4,4′-diaminodiphenyl ether, and 3,3′,5,5′-tetraisopropyl-4,4′-diaminodiphenylsulfone; mixtures of isomers of the unsubstituted aromatic diamine and/or the aromatic diamine having C1-C4 nucleus substituted alkyl groups with various ratios; aromatic diamine having a nucleus substituted electron withdrawing group (e.g., halogen, such as C1, Br, I, and F; an alkoxy group, such as a methoxy group, and an ethoxy group; and a nitro group), such as methylene bis-o-chloroaniline, 4-chloro-o-phenylenediamine, 2-chloro-1,4-phenylenediamine, 3-amino-4-chloroaniline, 4-bromo-1,3-phenylenediamine, 2,5-dichloro-1,4-phenylenediamine, 5-nitro-1,3-phenylenediamine, 3-dimethoxy-4-aminoaniline; 4,4′-diamino-3,3′-dimethyl-5,5′-dibromodiphenylmethane, 3,3′-dichlorobenzidine, 3,3′-dimethoxybenzidine, bis(4-amino-3-chlorophenyl)oxide, bis(4-amino-2-chlorophenyl)propane, bis(4-amino-2-chlorophenyl)sulfone, bis(4-amino-3-methoxyphenyl)decane, bis(4-aminophenyl)sulfide, bis(4-aminophenyl)telluride, bis(4-aminophenyl)selenide, bis(4-amino-3-methoxyphenyl)disulfide, 4,4′-methylene bis(2-iodoaniline), 4,4′-methylene bis(2-bromoaniline), 4,4′-methylene bis(2-fluoroaniline), 4-aminophenyl-2-chloroaniline; and aromatic diamine having a secondary amino group (e.g., part of or entire primary amino groups of the unsubstituted aromatic diamine, aromatic diamine containing a C1-C4 nucleus substituted alkyl group, mixture of isomers thereof at various blending ratios, and aromatic diamine having nucleus substituted electron-withdrawing group is substituted with a secondary amino group using a lower alkyl group, such as a methyl group, and an ethyl group), such as 4,4′-di(methylamino)diphenylmethane, and 1-methyl-2-methylamino-4-amino benzene.

As for the diamine, other than those listed above, usable are polyamine polyamine, such as low molecular polyamide polyamine obtained by condensation of dicarboxylic acid (e.g., dimmer acid) and an excess amount (2 moles or greater per mole of acid) of the polyamine (e.g., the alkylene diamine, and the polyalkylene poly); and polyether polyamine, such as hydride of cyanoethylated product of polyether polyol (e.g., polyalkylene glycol). Moreover, a compound obtained by capping the amino groups of the amino compound with a ketone compound may be used. Among them, preferred is a polyurea unit synthesized from the diamine and the diisocyanate.

Examples of the diisocyanate and the trivalent or higher polyisocyanate include those listed as the diisocyanate and the trivalent or higher polyisocyanate earlier.

### ———Vinyl Polymer Unit———

The vinyl polymer unit is a polymer unit obtained through homopolymerization or copolymerization of a vinyl monomer.

Examples of the vinyl monomer include the following (1) to (10):

### (1) Vinyl-Based Hydrocarbon

Examples of the vinyl-based hydrocarbon include aliphatic vinyl-based hydrocarbon, alicyclic vinyl-based hydrocarbon, and aromatic vinyl-based hydrocarbon.

Examples of the aliphatic vinyl-based hydrocarbon include: alkene (e.g., ethylene, propylene, butene, isobutylene, pentene, heptene, diisobutylene, octene, dodecene, and octadecene), and α-olefin other than the above; and alkadiene (e.g., butadiene, isoprene, 1,4-pentadiene, 1,6-hexadiene, and 1,7-octadiene).

Examples of the alicyclic vinyl-based hydrocarbon include: mono- or dicycloalkene and alkadiene (e.g., such as cyclohexene, (di)cyclopentadiene, vinylcyclohexene, and ethylidene bicycloheptane), and terpene (e.g., pinene, limonene, and indene).

Examples of the aromatic vinyl-based hydrocarbon include: styrene, and hydrocarbyl (e.g., alkyl, cycloalkyl, aralkyl and/or alkenyl) substituted products thereof (e.g., α-methyl styrene, vinyl toluene, 2,4-dimethyl styrene, ethyl styrene, isopropyl styrene, butyl styrene, phenyl styrene, cyclohexyl styrene, benzyl styrene, crotyl benzene, divinyl benzene, divinyl toluene, divinyl xylene, and trivinyl benzene), and vinyl naphthalene.

### (2) Carboxyl Group-Containing Vinyl Monomer and Salt Thereof

Examples of the carboxyl group-containing vinyl monomer and salt thereof include C3-C30 unsaturated monocarboxylic acid, unsaturated dicarboxylic acid, anhydride thereof and monoalkyl(C1-C24) ester thereof.

Examples of the C3-C30 unsaturated monocarboxylic acid, unsaturated dicarboxylic acid, anhydride thereof, and monoalkyl(C1-C24) ester thereof include a carboxyl group-containing vinyl monomer, such as (meth)acrylic acid, maleic acid (anhydride), monoalkyl maleate, fumaric acid, monoalkyl fumarate, crotonic acid, itaconic acid, monoalkyl itaconate, itaconic acid glycol monoether, citraconic acid, monoalkyl citraconate, and cinnamic acid.

### (3) Sulfone Group-Containing Vinyl Monomer, Vinyl Sulfonic Acid Monoester, and Salts Thereof

Examples thereof include: C2-C14 alkene sulfonic acid, such as vinyl sulfonic acid, (meth)allyl sulfonic acid, methylvinyl sulfonic acid, and styrene sulfonic acid; C2-C24 alkyl derivatives thereof, such as α-methyl styrene sulfonic acid; sulfo(hydroxy)alkyl-(meth)acrylate or (meth)acrylamide, such as sulfopropyl(meth)acrylate, 2-hydroxy-3-(meth)acryloxypropyl sulfonic acid, 2-(meth)acryloylamino-2,2-dimethylethane sulfonic acid, 2-(meth)acryloyloxyethane sulfonic acid, 3-(meth)acryloyloxy-2-hydroxypropane sulfonic acid, 2-(meth)acrylamide-2-methylpropane sulfonic acid, 3-(meth)acrylamide-2-hydroxypropane sulfonic acid, alkyl(C3-C18)allyl sulfosuccinic acid, sulfuric acid ester of poly(n=2 to 30)oxyalkylene (e.g., ethylene, propylene, and butylene alone, or in random form, or block form) mono(meth)acrylate [e.g., sulfuric acid ester of poly(n=5 to 15)oxypropylene monoacrylate], and sulfuric acid ester of polyoxyethylene polycyclic phenyl ether.

### (4) Phosphoric Acid Group-Containing Vinyl Monomer and Salt Thereof

Examples of the phosphoric acid group-containing vinyl monomer and salts thereof include (meth)acryloyloxyalkyl phosphoric acid monoester, and (meth)acryloyloxyalkyl(C1-C24)phosphoric acid.

Examples of the (meth)acryloyloxyalkyl phosphoric acid monoester include 2-hydroxyethyl(meth)acryloyl phosphate, and phenyl-2-acryloyloxyethyl phosphate.

Examples of the (meth)acryloyloxyalkyl(C1-C24)phosphoric acid include 2-acryloyloxyethyl phosphoric acid, and salts thereof.

Note that, examples of salts of (2) to (4) above include alkali metal salt (e.g., sodium salt, and potassium salt), alkali earth metal salt (e.g., calcium salt, and magnesium salt), ammonium salt, amine salt, and quaternary ammonium salt.

### (5) Hydroxyl Group-Containing Vinyl Monomer

Examples of the hydroxyl group-containing vinyl monomer include hydroxyl styrene, N-methylol (meth)acrylamide, hydroxyethyl (meth)acrylate, hydroxypropyl (meth)acrylate, polyethylene glycol mono(meth)acrylate, (meth)allyl alcohol, crotyl alcohol, isocrotyl alcohol, 1-buten-3-ol, 2-buten-1-ol, 2-butene-1,4-diol, propargyl alcohol, 2-hydroxyethylpropenyl ether, and sucrose allyl ether.

(6) Nitrogen-Containing Vinyl Monomer (e.g., Amino Group-Containing Vinyl Monomer, Amide Group-Containing Vinyl Monomer, Nitrile Group-Containing Vinyl Monomer, Quaternary Ammonium Cation Group-Containing Vinyl Monomer, and Nitro Group-Containing Vinyl Monomer)

Examples of the amino group-containing vinyl monomer include aminoethyl (meth)acrylate, dimethylaminoethyl (meth)acrylate, diethylaminoethyl (meth)acrylate, t-butylaminoethyl methacrylate, N-aminoethyl (meth)acryl amide, (meth)allyl amide, morpholinoethyl (meth)acrylate, 4-vinylpyridine, 2-vinylpyridine, crotyl amine, N,N-dimethylamino styrene, methyl-α-acetoaminoacrylate, vinyl imidazole, N-vinyl pyrrole, N-vinylthiopyrrolidone, N-arylphenylene diamine, aminocarbazole, aminothiazole, aminoindole, aminopyrrole, aminoimidazole, aminomercaptothiazole, and salts thereof.

Examples of the amide group-containing vinyl monomer include (meth)acrylamide, N-methyl(meth)acrylpyridine, N-butylacrylamide, diacetone acrylamide, N-methylol (meth)acrylamide, N,N-methylene-bis(meth)acrylamide, cinnamic acid amide, N,N-dimethylacrylamide, N,N-dibenzylacrylamide, methacryl formamide, N-methyl-N-vinyl acetoamide, and N-vinylpyrrolidone.

Examples of the nitrile group-containing vinyl monomer include (meth)acrylonitrile, cyanostyrene, and cyanoacrylate.

Examples of the quaternary ammonium cation group-containing vinyl monomer include dimethylaminoethyl (meth)acrylate, diethylaminoethyl (meth)acrylate, dimethylaminoethyl (meth)acrylamide, diethylaminoethyl (meth)acrylamide, and a quaternized product of tertiary amine (e.g. diallyl amine) group-containing vinyl monomer (e.g., a compound quaternized using a quaternization agent, such as methyl chloride, dimethyl sulfate, benzyl chloride, and dimethyl carbonate).

Examples of the nitro group-containing vinyl monomer include nitro styrene.

### (7) Epoxy Group-Containing Vinyl Monomer

Examples of the epoxy group-containing vinyl monomer include glycidyl (meth)acrylate, tetrahydrofurfuryl (meth)acrylate, and p-vinylphenyl phenyloxide.

### (8) Vinyl Eater, Vinyl (Thio) Ether, Vinyl Ketone, and Vinyl Sulfone

Examples of the vinyl ester include vinyl acetate, vinyl butylate, vinyl propionate, vinyl butyrate, diallyl phthalate, diallyl adipate, isopropenyl acetate, vinyl methacrylate, methyl-4-vinyl benzoate, cyclohexyl methacrylate, benzyl methacrylate, phenyl (meth)acrylate, vinylmethoxy acetate, vinyl benzoate, ethyl-α-ethoxy acrylate, alkyl (meth)acrylate containing C1-C50 alkyl group [e.g., methyl (meth)acrylate, ethyl (meth)acrylate, propyl (meth)acrylate, butyl (meth)acrylate, 2-ethylhexyl (meth)acrylate, dodecyl (meth)acrylate, hexadecyl (meth)acrylate, heptadecyl (meth)acrylate, and eicosyl (meth)acrylate], dialkyl fumarate (two alkyl groups are C2-C8 straight or branched chain or alicyclic alkyl groups), dialkyl maleate (two alkyl groups are C2-C8 straight or branched chain or alicyclic alkyl groups), poly(meth)allyloxy alkane [e.g., diallyloxy ethane, triallyloxy ethane, tetraallyloxy ethane, tetraallyloxy propane, tetraallyloxy butane, and tetramethallyloxy ethane], a vinyl monomer having a polyalkylene glycol chain [e.g., polyethylene glycol (molecular weight: 300) mono(meth)acrylate, polypropylene glycol (molecular weight: 500) monoacrylate, methyl alcohol ethylene oxide (10 mol) adduct (meth)acrylate, and lauryl alcohol ethylene oxide (30 mol) adduct (meth)acrylate], poly(meth)acrylate [e.g., poly(meth)acrylate of polyhydric alcohol, such as ethylene glycol di(meth)acrylate, propylene glycol di(meth)acrylate, neopentyl glycol di(meth)acrylate, trimethylol propane tri(meth)acrylate, and polyethylene glycol di(meth)acrylate].

Examples of the vinyl(thio) ether include vinylmethyl ether, vinylethyl ether, vinylpropyl ether, vinyl butyl ether, vinyl-2-ethyl hexyl ether, vinylphenyl ether, vinyl-2-methoxyethyl ether, methoxy butadiene, vinyl-2-butoxy ethyl ether, 3,4-dihydro-1,2-pyran, 2-butoxy-2′-vinyloxydiethyl ether, vinyl-2-ethylmercaptoethyl ether, acetoxy styrene, and phenoxy styrene.

Examples of the vinyl ketone include vinyl methyl ketone, vinyl ethyl ketone, and vinyl phenyl ketone.

Examples of the vinyl sulfone include divinyl sulfide, p-vinyldiphenyl sulfide, vinylethyl sulfide, vinylethyl sulfone, divinyl sulfone, and divinyl sulfoxide.

### (9) Other Vinyl Monomers

Examples of other vinyl monomers include isocyanate ethyl (meth)acrylate, and m-isopropenyl-α,α-dimethylbenzylisocyanate.

### (10) Fluorine Atom-Containing Vinyl Monomer

Examples of the fluorine atom-containing vinyl monomer include 4-fluoro styrene, 2,3,5,6-tetrafluoro styrene, pentafluorophenyl (meth)acrylate, pentafluorobenzyl (meth)acrylate, perfluorocyclohexyl (meth)acrylate, perfluorocyclohexyl methyl(meth)acrylate, 2,2,2-trifluoroethyl (meth)acrylate, 2,2,3,3-tetrafluoropropyl (meth)acrylate, 1H, 1H,4H-hexafluorobutyl (meth)acrylate, 1H,1H,5H-octafluoropentyl (meth)acrylate, 1H,1H,7H-dodecafluoroheptyl (meth)acrylate, perfluorooctyl (meth)acrylate, 2-perfluorooctyl ethyl(meth)acrylate, heptadecafluorodecyl (meth)acrylate, trihydroperfluoroundecyl (meth)acrylate, perfluoronorbornylmethyl (meth)acrylate, 1H-perfluoroisobornyl (meth)acrylate, 2-(N-butylperfluorooctane sulfoamide)ethyl (meth)acrylate, 2-(N-ethylperfluorooctane sulfoamide)ethyl (meth)acrylate, and a corresponding compound derived from α-fluoroacrylic acid, bis-hexafluoroisopropyl itaconate, bis-hexafluoroisopropyl maleate, bis-perfluorooctyl itaconate, bis-perfluorooctyl maleate, bis-trifluoroethyl itaconate, bis-trifluoroethyl maleate, vinyl heptafluorobutylate, vinyl perfluoroheptanoate, vinyl perfluorononanate, and vinyl perfluorooctanoate.

### ——Crystalline Resin Containing Urea Bond in Principle Chain Thereof——

The binder resin preferably contains a crystalline resin containing a urea bond in a principle chain thereof.

In accordance with Solubility Parameter Values (Polymer handbook 4th Ed), the cohesive energy of the urea bond is 50,230 [J/mol], which is about twice the cohesive energy (26,370 [J/mol]]) of a urethane bond. Therefore, it is expected that use of such a resin even in a small amount can improve toughness or offset resistance of the toner during fixing.

In order to obtain the resin containing a urea bond in its principle chain, a polyisocyanate compound and a polyamine compound are allowed to react, or the polyisocyanate compound and water are allowed to react, and amino groups generated by hydrolysis of isocyanate and remaining isocyanate groups are allowed to react. In the production of the resin containing a urea bond in its principle chain, other than the compounds mentioned above, a polyol compound is allowed to react at the same time, to thereby widen a degree of freedom in designing of a resin.

As for the polyisocyanate, other than the aforementioned diisocyanate, and trivalent or higher polyisocyanate (may be referred to as low molecular weight polyisocyanate hereinafter), a polymer having an isocyanate group at a terminal or side chain thereof (may be referred to as a prepolymer hereinafter) may be used. Examples of a preparation method of the prepolymer include: a method, in which a low molecular weight polyisocyanate and a polyamine compound described later are allowed to react with an excess amount of isocyanate to thereby obtain a polyurea prepolymer having an isocyanate group at a terminal thereof, and a method, in which low molecular weight polyisocyanate and a polyol compound are allowed to react with an excess amount of isocyanate to thereby obtain a prepolymer containing an isocyanate group at a terminal thereof. The prepolymer obtained in any of these methods may be used alone, or two or more prepolymers obtained in the same method, or two or more prepolymers obtained by the two different methods may be used in combination. Moreover, the prepolymer and one, or two or more types of low molecular weight polyisocyanate may be used in combination.

A ratio of the polyisocyanate for use is determined as an equivalent ratio [NCO]/[NH2] of isocyanate groups [NCO] to amino groups [NH₂] of polyamine, or an equivalent ratio [NCO]/[OH] of isocyanate groups [NCO] to hydroxyl groups [OH] of polyol, which is typically 5/1 to 1.01/1, preferably 4/1 to 1.2/1, and more preferably 2.5/1 to 1.5/1. When the molar ratio of [NCO] is grater than 5, urethane bonds or urea bonds therein are excessive, and therefore elastic modulus of a melted toner is too high as a resulting resin is used as a binder resin of the toner, leading to poor fixing ability of the toner. When the molar ratio of [NCO] is less than 1.01, degree of polymerization becomes high and a molecular weight of a generated prepolymer is large, and therefore it is difficult to mix the prepolymer with other materials in the production of a toner, or elastic modulus of a melted toner becomes too high, which may lead to poor fixing ability of the toner. Therefore, such ranges of molar ratios are not preferable.

Examples of the polyamine include the aforementioned diamine, and aforementioned trivalent or higher polyamine.

As for the polyol, other than the aforementioned diol, and trihydric to octahydric or higher polyol (may be referred to as low molecular weight polyol hereinafter), a polymer containing a hydroxyl group at a terminal or in a side chain thereof (may be referred to as high molecular weight polyol) may be used.

Examples of a preparation method of the high molecular weight polyol include: a method where low molecular weight polyisocyanate and low molecular weight polyol are allowed to react with an excessive amount of hydroxyl groups to thereby obtain polyurethane having a hydroxyl group at a terminal thereof, and a method where polycarboxylic acid and a low molecular weight polyol compound are allowed to react with an excessive amount of hydroxyl groups to thereby obtain polyester having a hydroxyl group at a terminal thereof.

In order to adjust the polyurethane or polyester having a hydroxyl group at a terminal thereof, a ratio [OH]/[NCO] of low molecular weight polyol to low molecular weight polyisocyanate, or a ratio [OH]/[COOH] of low molecular weight polyol to polycarboxylic acid is typically 2/1 to 1/1, preferably 1.5/1 to 1/1, and more preferably 1.3/1 to 1.02/1. When the molar ratio of the hydroxyl group is grater than 2, the polymerization reaction is not progressed so that target high molecular weight polyol may not be attained. When the molar ratio of the hydroxyl group is less than 1.02, a degree of polymerization becomes high, and a molecular weight of high molecular weight polyol becomes too large, and therefore it may be difficult to mix with other materials in the production of a toner, or elastic modulus of a melted toner becomes too high, which may lead to poor fixing ability of the toner. Therefore, such ranges of molar ratios are not preferable.

Examples of the polycarboxylic acid include the aforementioned dicarboxylic acid, and the aforementioned trivalent to hexavalent or higher polycarboxylic acid.

In order to give crystallinity to the obtained resin, a polymer unit having crystallinity in a principle chain thereof can be introduced into the resin. As for a crystalline polyester unit having a melting point suitable as a binder resin for a toner, there are a crystalline polyester unit, and a long-chain alkyl ester unit of polyacrylic acid or polymethacrylic acid. Among them, the crystalline polyester unit is preferable, as a unit having alcohol at a terminal can be easily produced, and it can be easily introduced as the polyol compound into a resin containing a urea bond.

Examples of the crystalline polyester unit include a polycondensation polyester unit synthesized from polyol and polycarboxylic acid, a lactone ring-opening polymerization product, and polyhydroxycarboxylic acid. Among them, a polycondensation polyester unit synthesized from diol and dicarboxylic acid is preferable in view of exhibition of crystallinity. As for the diol those listed as diol in the description of the polyol can be used. Among them, aliphatic diol, in which a number of carbon atoms in a chain thereof is 2 to 36, is preferable, and straight-chain aliphatic diol is more preferable. These may be used alone, or in combination. Among them, preferred are ethylene glycol, 1,3-propanediol, 1,4-butanediol, 1,6-hexanediol, 1,9-nonanediol, and 1,10-decanediol, in view of readily availability.

An amount of the straight chain aliphatic diol in the entire diols is appropriately selected depending on the intended purpose without any limitation, but the amount thereof is preferably 80 mol % or greater, more preferably 90 mol % or greater. The amount thereof being 80 mol % or greater is preferable because crystallinity of the resin improves, both low temperature fixing ability and heat resistant storage stability are desirably achieved, and hardness of the resin tends to improve. As for the dicarboxylic acid, those listed as the dicarboxylic acid in the description of the polycarboxylic acid can be used. Among them, straight-chain aliphatic dicarboxylic acid is more preferable.

Among the dicarboxylic acid, single use of the aliphatic dicarboxylic acid (preferably, adipic acid, sebacic acid, dodecane dicarboxylic acid, terephthalic acid, and isophthalic acid) is particularly preferable. Similarly, a copolymer of the aliphatic dicarboxylic acid and the aromatic dicarboxylic acid (preferably terephthalic acid, isophthalic acid, and t-butylisophthalic acid, and lower alkyl ester of any of these aromatic dicarboxylic acids) is also preferably used. The copolymerization amount of the aromatic dicarboxylic acid is preferably 20 mol % or less.

A toner can be obtained by using a resin, to which a urea bond is formed in advance, as a binder resin, mixing the binder resin with other toner constituting materials, such as colorant, releasing agent, and charge controlling agent, and granulating the mixture. However, a urea bond may be formed by mixing a polyisocyanate compound, a polyamine compound and/or water, and optionally the toner constituting materials other than the binder resin, such as a colorant, releasing agent, and charge controlling agent.

A high molecular weight crystalline resin containing a urea bond can be uniformly introduced into a toner especially by using a prepolymer as the polyisocyanate compound, and therefore a resulting toner has uniform thermal properties and charging properties, and both fixing ability and stress resistance of the toner can be attained. Therefore, use of the prepolymer is preferable. Moreover, the prepolymer is preferably a prepolymer obtained by allowing low molecular weight polyisocyanate and a polyol compound to react with an excessive amount of the isocyanate, as viscoelasticity is suppressed. The polyol compound is preferably polyester containing a hydroxyl group at a terminal thereof obtained by allowing polycarboxylic acid and a low molecular weight polyol compound with an excessive amount of hydroxyl groups, because thermal properties suitable for a toner can be attained. In the case where the polyester is composed of a crystalline polyester unit, it is preferable as a high molecular weight component of the toner exhibits sharp melting, and a toner having excellent low temperature fixing ability can be attained.

In the case where the toner of the present invention is obtained by granulating in an aqueous medium, moreover, a urea bond can be formed under mild conditions, as water serving as a dispersion medium reacts with the polyisocyanate compound. As for the binder resin, a single binder resin may be used, or a combination of two or more binder resins may be used. Moreover, the binder resins having different weight average molecular weights may be used in combination. It is preferred that the binder resin contain at least a first crystalline resin, and a second crystalline resin having the larger weight average molecular weight Mw than that of the first crystalline resin, as both excellent low temperature fixing ability and hot offset resistance can be attained. Moreover, the second crystalline resin is preferably obtained by using the crystalline resin precursor that is a modified crystalline resin containing an isocyanate group, and allowing the modified crystalline resin to react with a compound containing an active hydrogen group to elongate the resin. In this case, the reaction of the binder resin precursor and the compound containing an active hydrogen group is preferably performed during the production process of a toner. As a result of this, the binder resin having a large weight average molecular weight can be homogeneously dispersed in a toner, and variations in properties between toner particles can be prevented. Furthermore, it is preferred that the first crystalline resin be a crystalline resin containing a urethane bond and/or urea bond in a principle chain thereof and the second crystalline resin be obtained by allowing the binder resin precursor, which is obtained by modifying the first crystalline resin, to react with a compound containing an active hydrogen group, to thereby elongate the resin. By making the composition structures of the first crystalline resin and the second crystalline resin similar, these two types of the binder resins can be homogeneously dispersed in the toner, and variations in properties between toner particles can be suppressed even further. As for the crystalline resin, the crystalline resin and a non-crystalline resin may be used in combination. It is preferred that a main component of a binder resin be the crystalline resin.

In order to prevent a damage formed on an image by transferring, the toner preferably satisfies the following condition (1), where T1 is the maximum endothermic peak temperature of the toner on a DSC curve of second heating as measured by the following conditions, and T2 is the maximum exothermic peak temperature of the toner on a DSC curve of cooling as measured in the similar manner.

T1−T2≦30° C., and T2≧30° C. (1)

The maximum endothermic peak of the toner can be measured by means of a DSC system Q-200 (manufactured by TA Instruments Japan Inc.). Specifically, the measurement is performed in the following manner. First, a sample container formed of aluminum is charged with about 5.0 mg of a resin, the sample container is placed in a holder unit, and the holder unit is then set in an electric furnace. Next, the sample is heated from (YC to 100° C. in nitrogen atmosphere at 10° C./min, followed by cooling from 100° C. to 0° C. at 10° C./min. The sample is further heated from 0° C. to 100° C. at 10° C./min. A DSC curve of the second heating is selected using an analysis program stored in the DSC system Q-200 (manufactured by TA Instruments Japan Inc.), to thereby measure the maximum endothermic peak temperature T1 of the toner. In the similar manner, moreover, the maximum exothermic peak temperature T2 of the toner at the cooling is measured.

The maximum endothermic peak temperature T1 of the toner is preferably 50° C. to 70° C., more preferably 53° C. to 65° C., and even more preferably 58° C. to 62° C. When the T1 is 50° C. to 70° C., the minimum level of heat resistant storage stability required for a toner can be secured, and a toner having excellent low temperature fixing ability, which has not been realized in the art, can be obtained. When the T1 is lower than 50° C., low temperature fixing ability of a resulting toner is excellent, but heat resistant storage stability thereof is poor. When the T1 is higher than 70° C. on the other hand, heat resistant storage stability of a resulting toner is excellent, but low temperature fixing ability thereof is poor.

The maximum exothermic peak temperature T2 of the toner is preferably 30° C. to 55° C., more preferably 35° C. to 55° C., and particularly preferably 40° C. to 55° C. When the T2 is lower than 30° C., the speed of cooling and/or solidifying the fixed image is slow and hence blocking of a toner image (print) may occur or the toner image (print) may be damaged by transferring. Moreover, the T2 is preferably as high temperature as possible, but the T2 cannot be the temperature higher than the T1, which is a melting point, because the T2 is crystallization temperature. Specifically, a difference (T1−T2) between the T1 and T2 is preferably a relatively narrow range, in order to prevent blocking or transport damage of a toner image, while maintaining excellent heat resistant storage stability and low temperature fixing ability. The difference (T1−T2) is preferably 30° C. or less, more preferably 25° C. or less, and particularly preferably 20° C. or less. When the difference (T1−T2) is greater than 40° C., a difference between the fixing temperature and temperature at which a toner image is solidified is large, and therefore an effect of preventing blocking or transport damage of a toner image cannot be attained.

A capacity of heat of melting of the toner at the second heating is preferably 30 J/g to 75 J/g. When the capacity of heat of melting is less than 30 J/g, an amount of the segment having a crystalline structure is small in the toner, and therefore there are low sharp-melt characteristics. As a result, it is difficult to attain a desirable balance of heat resistant storage stability and low temperature fixing ability, and aggregation of the toner particles occur, which may cause formation of defective images. When the capacity of heat of melting is greater than 75 J/g, the energy required for melting the toner to fix the toner image becomes large, and therefore fixing ability may be poor depending on a fixing device for use.

The storage elastic modulus G′(70) of the toner at 70° C. is 5.0×10⁴ Pa≦G′(70)≦1.0×10⁶ Pa, and the storage elastic modulus G′(160) of the toner at 160° C. is 1.0×10³ Pa≦G′(160)≦1.0×10⁴ Pa.

When G′(70) is less than 5.0×10⁴ Pa, a strength of an image just after the fixing is excessively low, and therefore a surface of the image may be scratched only by being in contact with any of members without being rubbed by a discharging roller. When G′(70) is greater than 1.0×10⁶ Pa, the toner is insufficiently melted during the fixing performed at low temperature, and therefore low temperature fixing ability may be poor. When G′(160) is less than 1.0×10³ Pa, hot offset resistance of the toner may be poor. When G′(160) is greater than 1.0×10⁴ Pa, glossiness of a resulting image may be low.

The storage elastic modulus G′ of the toner can be measured by means of a dynamic viscoelastometer (e.g., ARES, manufactured by TA Instruments Japan Inc.). A sample is formed into a pellet having a diameter of 8 mm, and a thickness of 1 mm to 2 mm. The pellet sample is fixed to a parallel plate having a diameter of 8 mm, followed by stabilizing at 40° C. The sample is then heated to 200° C. at the heating rate of 2.0° C./min with frequency of 1 Hz (6.28 rad/s), and strain of 0.1% (in a strain control mode) to thereby measure dynamic viscoelastic values of the sample.

An output image of a toner containing, as the binder resin, a crystalline polyester resin containing a urethane bond and/or a urea bond tends to form transport marks. This is because the recrystallization speed thereof is slow, when the crystalline polyester resin containing a urethane bond and/or a urea bond is cooled from the melted state to temperature equal to or lower than the melting point thereof. The image obtained just after heat fixing a toner containing the resin having a slow recrystallization speed becomes temporarily in a supercooling state, as a recrystallization speed thereof after being cooled to the temperature around room temperature (25° C.) is also slow. In the supercooling state, the elasticity is significantly low compared to that in the crystallized state. Therefore, such the toner does not have a sufficient resistance to mechanical stress applied by a transport member to be in contact with just after fixing.

In accordance with a method for reducing an amount of a urethane bond and/or a urea bond to adjust physical crosslink points or unevenness of a molecular structure, formation of a mark tends to occur more as the strength of an image is reduced along with reduction in the elasticity, and hot offset resistance thereof is also impaired. Similarly, in the method for adjusting a molecular weight, formation of a transport mark cannot be inhibited, and recrystallization speed of an image and elasticity, which are paradoxical characteristics, cannot be improved at the same time.

As mentioned above, it is difficult to inhibit formation of a transport mark only with a crystalline polyester resin containing a urethane bond and/or a urea bond. Therefore, the present inventors have conducted researches and, as a result, they have found that it is possible to increase a recrystallization speed with maintaining elasticity, by using a crystalline polyester resin containing a urethane bond, a urea bond, or both thereof and an unmodified crystalline polyester resin in combination. Specifically, after cooling an image from a melted state thereof to temperature below a melting point thereof, unmodified crystalline polyester, in which molecular chains are easily moved as there is no physical crosslink point, and symmetry of a molecular chain is high, is immediately crystallized to form a crystal nucleus. As a result, crystallization of an entire image is accelerated, and a crystallization speed is significantly improved.

Even in the case where the crystalline resin containing a urethane bond and/or a urethane bond is used as a binder resin, elasticity and strength of an image can be significantly improved before being brought into contact with a transporting member by an effect of the unmodified crystalline polyester resin to improve a crystallization speed. Therefore, formation of a transport mark can be inhibited. Moreover, hot offset resistant is maintained because of a presence of the crystalline polyester resin containing a urethane bond and/or a urea bond, and the unmodified crystalline polyester resin effectively acts on low temperature fixing ability.

When the binder resin contains a crystalline polyester resin containing a urethane bond and/or a urea bond, and an unmodified crystalline polyester resin, low temperature fixing ability and heat resistant storage stability can be achieved to a high level, and formation of transfer damages and insufficient strength of output image can be prevented. This is because recrystallization speed of an image after heat fixing is improved and hardness of an output image can be improved before the image reaches a transporting member, which is a cause of a transport mark, as the crystalline polyester containing a urethane bond and/or a urea bond, which has high cohesive energy that would improve hot offset resistance, heat resistant storage stability, and strength of an output image, and the unmodified crystalline polyester resin are used in combination.

It is preferred that the unmodified crystalline polyester resin and the crystalline polyester resin containing a urethane bond and/or a urea bond be homogeneously mixed in an image. Therefore, these resins are preferably homogeneously mixed or uniformly distributed inside a toner particle. In view of homogeneous mixing and dispersibility inside a toner particle, the unmodified crystalline polyester resin, and a crystalline polyester segment of the crystalline polyester resin containing a urethane bond and/or a urea bond preferably have similar skeletons.

### <<<Nucleating Agent>>>

In order to accelerate recrystallization of the crystalline resin, a nucleating agent may be used.

The nucleating agent has an effect of elevating exothermic peak temperature of the crystalline resin for use in the present invention, and that of the toner.

The “exothermic peak temperature” means exothermic peak temperature as measured by differential scanning calorimetry (DSC), which is the same in the descriptions below unless otherwise stated. The nucleating agent has a melting point higher than that of the crystalline resin, and is incompatible to the crystalline resin. Therefore, the nucleating agent is crystallized at higher temperature than the crystalline resin, to thereby accelerate crystallization of the crystalline resin. Use of the nucleating agent gives an effect of improving crystallization degree of the crystalline resin in a production process of a toner, and can improve heat resistant storage stability of a toner. Moreover, the nucleating agent has an effect of accelerating crystallization of an image after fixing. Therefore, not only that an improvement of blocking resistance of a toner image (print) can be expected, but also a size of crystal nucleus can be uniformly reduced by an effect of the nucleating agent. Accordingly, a surface of the toner image becomes smooth, and glossiness thereof can be improved. In the case where the melting point of the nucleating agent is lower than that of the crystalline resin, an effect of the nucleating agent to accelerate crystallization of the crystalline resin may insufficiently exhibited, and heat resistant storage stability of a toner, and blocking resistance of a toner image after fixing may be impaired.

The nucleating agent is appropriately selected depending on the intended purpose without any limitation, and the nucleating agent may be an inorganic crystal nucleating agent, or an organic crystal nucleating agent.

Examples of the inorganic crystal nucleating agent include silica, talc, kaolin, alumina, alum, and titanium oxide.

Examples of the organic crystal nucleating agent include: dibenzylidene sorbitol; lower alkyl dibenzylidene sorbitol, such as, bis(p-methylbenzylidene)sorbitol, and bis(p-ethylbenzylidene)sorbitol; an aluminum benzoate compound; a phosphoric ester metal salt compound; a straight-chain fatty acid metal salt, such as a sodium salt of montanic acid; a partial metal salt of rosin acid; fatty acid amide; and fatty acid ester.

Among them, a phosphoric ester metal salt compound, a complex thereof, and a nitrogen-containing compound are preferably used as the nucleating agent. These organic compounds have an effect of increasing a crystallization speed of crystalline polyester, and significantly improving mechanical strength. Moreover, the sorbitol-based crystal nucleating agent is preferable, as it is easily decomposed at high temperature, and there is no need to consider odor due to the decomposition, and reduction in performance.

An amount of the nucleating agent in the toner is appropriately selected depending on the intended purpose without any limitation, but the amount thereof is preferably 0.1% by mass to 5.0% by mass, more preferably 0.3% by mass to 2.0% by mass. When the amount thereof is less than 0.1% by mass, a sufficient effect of accelerating crystallization cannot be attained, and therefore an effect of improving blocking resistance of a toner image may not be exhibited. When the amount thereof is greater than 5.0% by mass, a viscosity of the toner is increased, as the nucleating agent the melting point higher than those of the crystalline resin and the toner, and therefore sufficient low temperature fixing ability may not be attained.

In the present invention, exothermic peak temperature, and melting points of the toner and each material can be measured, for example, by means of a differential scanning calorimetry (DSC) system (DSC-60, manufactured by Shimadzu Corporation).

Specifically, the exothermic peak temperature and melting point of a target sample can be measured in the following manner.

A DSC curve of second heating is selected from the obtained DSC curve using an analysis program “endothermic peak temperature” in the DSC-60 system to determine a melting point (Tm) of the target sample of the second heating. Similarly, using the “endothermic peak temperature,” a DSC curve of cooling is selected to determine exothermic peak temperature (Tc) of the target sample.

### [Measurement Conditions]

Sample container: aluminum sample pan (with a lid)
Sample amount: 5 mg
Reference: aluminum sample pan (alumina [10 mg])
Atmosphere: nitrogen (flow rate: 50 mL/min)

### [Temperature Conditions]

Starting temperature: 20° C.
Heating rate: 10° C./min
Terminating temperature: 150° C.
Retention time: none
Cooling rate: 10° C./min
Terminating temperature: −20° C.
Retention time: none
Heating rate: 10° C./min
Terminating temperature: 150° C.

As a result of the research conducted by the present inventors, it has been found that characteristics (sharp melt) of a toner containing a crystalline resin as a main component of a binder resin that viscoelasticity thereof is rapidly reduces at temperature equal to or higher than a melting point, which has been conventionally considered as being effective for low temperature fixing ability, are a factor for causing a significant variation in a fixable temperature range depending on a type of paper for use. It is then found that fixing can be performed at constant temperature and at constant speed regardless of a type of paper for use, when a toner contains a component having a relatively high molecular weight as a binder resin used in a conventional toner having excellent low temperature fixing ability. Specifically, the toner contains a certain amount or greater of a component, which has a molecular weight of 100,000 or greater on polystyrene conversion basis, as measured by gel permeation chromatography (GPC) of a tetrahydrofuran (THF) soluble component of the toner, and moreover, the weight average molecular weight thereof is within a certain range.

An amount of the component having a molecular weight of 100,000 or greater is preferably 7% or greater, more preferably 9% or greater. When the toner contains the component having a molecular weight of 100,000 or greater in an amount of 7% or greater, temperature dependency of fluidity or viscoelasticity of the melted toner becomes small, fixing can be performed by a fixing unit at constant temperature and at constant speed without causing a large difference in fluidity or viscoelasticity of the toner even through thin paper, in which heat is easily transmitted, or a thick paper, in which heat is not easily transmitted, is used during the fixing. When the toner contains the component having a molecular weight of 100,000 or greater in an amount of less than 5%, fluidity or viscoelasticity of the melted toner significantly changes. For example, in case of fixing on thin paper, therefore, deformability of the toner becomes too great so that a contact area with the fixing unit increases. As a result, the toner cannot be desirably released from the fixing unit, which may cause paper to wrap around the fixing unit.

Reasons why the effect of the present invention is attained are considered as follows. Specifically, a crystalline resin has sharp melting characteristics as described above, but an internal aggregation force or viscoelasticity of a melted toner varies depending on a molecular weight or structure of the resin. In the case where the resin contains a urethane bond or urea bond, which is a coupling bond having a large cohesive energy, for example, the resin exhibit a behavior like that of an elastic body, such as rubber, at relatively low temperature even when the resin is melted, but thermal motion energy of a high molecular chain increases, as temperature increases. Therefore, aggregation between bonds is gradually loosened so that the resin acts more like a viscous body.

When such the resin is used as a binder resin for a toner, fixing can be performed without any problem at low fixing temperature, but so-called hot offset, which is a phenomenon that an upper side of a toner image is adhered to a fixing unit, may occur during fixing at high fixing temperature, because internal aggregation force of a melted toner is small at high fixing temperature. As a result, a quality of a resulting image is significantly impaired. When an amount of a urethane bond or urea bond segment is increased in order to prevent hot offset, fixing can be performed at high temperature. In the case where fixing is performed at low temperature, on the other hand, image gloss is low, and melt penetration of the toner to paper is insufficient, and therefore the image is easily released from paper. Especially when fixing is performed on paper having a thickness and surface irregularities, a fixed state of the toner may be deteriorated as heat transfer efficiency to a toner during fixing is low, or a fixed state of a toner especially in an elastic state is significantly impaired, as sufficient pressure is not applied to the toner by a fixing unit on recess area of the paper.

Considering a molecular weight as means for controlling viscoelasticity after melted, viscoelasticity is naturally large, as a molecular weight increases because the large molecular weight increases hindrance to the movement of the molecular chain. Moreover, when the molecular weight is large, involution occurs, and therefore the toner exhibits elastic behaviors. Considering fixing ability to paper, a toner of smaller molecular weight is preferable, as a viscosity thereof when melted is small. On the other hand, hot offset occurs unless the toner has a certain degree of elasticity. When a molecular weight of a binder resin is increased on the whole, fixing ability of a toner is impaired. In the case where fixing is performed on thick paper, especially, a fixed state of a toner is further impaired, as heat transfer efficiency to the toner during fixing is low. Therefore, a high molecular weight crystalline component is included in a binder resin without increasing a molecular weight of the binder resin as a whole so much, so that viscoelasticity of a toner after melted is appropriately controlled, and a toner, with which fixing can be performed at constant temperature and at constant speed regardless of a type of paper for use, such as thin paper and thick paper, can be attained.

The weight average molecular weight Mw of the toner is appropriately selected depending on the intended purpose without any limitation, but the weight average molecular weight thereof is preferably 20,000 to 70,000, more preferably 30,000 to 60,000, and even more preferably 35,000 to 50,000. When the weight average molecular weight thereof is greater than 70,000, fixing ability is poor, as a molecular weight of an entire binder resin is too high. As a result, glossiness of an image may be too low, and a fixed image is easily fall off upon application of external stress. Therefore, the toner having such weight average molecular weight is not preferable. When the weight average molecular weight of the toner is smaller than 20,000, internal aggregation force of the melted toner is too low even through a high molecular weight component is present in a large amount, and hot offset or wrapping of paper to a fixing unit is caused. Therefore, the toner having such weight average molecular weight is not preferable.

As for a method for obtaining a toner containing a binder resin having the aforementioned molecular weight distribution, there are a method where two or more resins having different molecular weight distributions to each other are used in combination; and a method where a resin a molecular weight of which is controlled during polymerization is used. In the case where the resins having different molecular weight distributions to each other are used in combination, at least two types of resins, which are a relatively high molecular weight resin, and a relatively low molecular weight resin, are used. As for the high molecular weight resin, a resin, which already has a large molecular weight, may be used, pr a high molecular weight resin may be formed through elongation of a modified resin having an isocyanate group at a terminal thereof during a production process of a toner. The latter resin is preferable, because the high molecular weight resin can be homogeneously provided inside a toner particle, and it is easily dissolved compared to a resin, which already has a high molecular weight, in a production method containing a step where a binder resin is dissolved in an organic solvent.

In the case where the binder resin is composed of two resins, which are a high molecular weight resin (including a modified resin containing an isocyanate group) and a low molecular weight resin, a mass ratio (high molecular weight resin/low molecular weight resin) of the high molecular weight resin to the low molecular weight resin is 5/95 to 60/40, preferably 8/92 to 50/50, more preferably 12/88 to 35/65, and even more preferably 15/85 to 25/75. When the molecular weight component is smaller than 5/95, or greater than 60/40, it is difficult to obtain a toner containing a binder resin having the aforementioned molecular weight distribution.

In the case where the resin a molecular weight of which is controlled during polymerization is used, in addition to a bifunctional monomer, a small amount of a monomer having a different number of functional group(s) is added to widen a molecular weight distribution in a polymerization system, such as condensation polymerization, polyaddition, and addition condensation. As for the monomer having a different number of functional group(s), there are a trifunctional or higher monomer, and a monofunctional monomer. When the trifunctional or higher monomer is used, a branch structure is generated.

Therefore, it may be difficult to form a crystalline structure with a resin having crystallinity. When the monofunctional monomer is used, a polymerization reaction is terminated with the monofunctional monomer, and therefore the polymerization reaction is partially progressed to form a high molecular weight component, while refining a low molecular weight resin in an embodiment where two or more resins are used as a binder resin.

The tetrahydrofuran soluble component of the toner, and a molecular weight distribution or weight average molecular weight (Mw) of the resin can be measured by means of a gel permeation chromatography (GPC) measuring device (e.g., GPC-8220GPC, manufactured by Tosoh Corporation).

As for a column, for example, TSKgel Super HZM-H, 15 cm, three connected columns (of Tosoh Corporation) are used. A resin to be measured is formed into a 0.15% solution with tetrahydrofuran (THF) (containing a stabilizer, manufactured by Wako Chemical Industries, Ltd.), the obtained solution is filtered with a filter having an opening size of 0.2 μm, and the filtrate is used as a sample. The THF sample solution (100 μL) is injected into the measuring device, and the measurement is performed in the environment having the temperature of 40° C. at the flow rate of 0.35 mL/min.

The molecular weight is calculated using a calibration curve prepared from a monodisperse polystyrene standard sample. As for the standard polystyrene sample, Showdex STANDARD series manufacture by SHOWA DENKO K.K., and toluene are used.

The following three THF solutions of the monodisperse polystyrene standard sample are prepared, and the measurement is performed under the aforementioned conditions. The retention time of the peak top is determined as a light scattering molecular weight of the monodisperse polystyrene standard sample, to thereby prepare a calibration curve.

Solution A: S-7450 (2.5 mg), S-678 (2.5 mg), S-46.5 (2.5 mg), S-2.90 (2.5 mg), THF (50 mL)

Solution B: S-3730 (2.5 mg), S-257 (2.5 mg), S-19.8 (2.5 mg), S-0.580 (2.5 mg), THF (50 mL)

Solution C: S-1470 (2.5 mg), S-112 (2.5 mg), S-6.93 (2.5 mg), toluene (2.5 mg), THF (50 mL)

As the detector, a refractive index (RI) detector is used. A proportion of the component having a molecular weight of 100,000 or greater, and a proportion of a component having a molecular weight of 250,000 or greater can be determined from a cross-link point with the molecular weight of 100.000 or a molecular weight of 250,000 on the integral molecular weight distribution curve.

It is important that the high molecular weight component has a resin structure similar to the entire binder resin. When the binder resin as a whole has crystallinity, the high molecular weight component also has crystallinity.

When the high molecular weight component has a significantly different structure to that of another resin component for use, the high molecular weight component easily causes phase separation to form a sea-island structure. Therefore, a contribution of the high molecular weight component for improvement of viscoelasticity or aggregation force to an entire toner cannot be expected. As for a comparison between a proportion of a crystalline structure in the high molecular weight component and that in the entire binder resin, for example, a ratio (ΔH(H)/ΔH(T)) of an endothermic value (ΔH(H)) of a tetrahydrofuran (THF)-ethyl acetate mixed solvent (blending ratio: 50:50 (mass ratio)) insoluble component as measured by differential scanning calorimetry (DSC) to an endothermic value (ΔH(T)) of the toner as measured by DSC is preferably in the range of 0.2 to 1.25, more preferably 0.3 to 1.0, and even more preferably 0.4 to 0.8. As for a specific test method for obtaining a component insoluble to a mixed solvent of tetrahydrofuran (THF) and ethyl acetate (blending ratio: 50:50 (mass ratio)), the following method can be used. To 40 g of the aforementioned mixed solvent having room temperature (20° C.), 0.4 g of the toner is added, and the mixture is mixed for 20 minutes. Thereafter, the insoluble component is separated by a centrifuge, and a supernatant is removed. The resultant is vacuum dried, to thereby obtain the aforementioned mixed solvent insoluble component.

An amount of N element (N element content) derived from a urethane bond and/or a urea bond of the THF soluble component of the toner is appropriately selected depending on the intended purpose without any limitation, but the amount thereof is preferably 0.3% by mass to 2.0% by mass, more preferably 0.5% by mass to 1.8% by mass, and even more preferably 0.7% by mass to 1.6% by mass. When the N element content is greater than 2.0% by mass, poor fixing ability, low glossiness, or poor electrostatic properties may be caused because of excessively high viscoelasticity of the melted toner. When the N element content is less than 0.3% by mass, aggregation of toner particles or deposition of toner on a member may be caused in an image forming apparatus due to reduction in toughness of the toner, and hot offset may occur due to reduction in viscoelasticity of the melted toner.

The N element content is obtained in the following manner. By means of varioMICROcube (available from Elementar), CHN simultaneous measurement is performed under the conditions that a combustion furnace is set to 950° C., a reduction furnace is set to 550° C., a helium flow rate is 200 mL/min, and an oxygen flow rate is 25 mL/min to 30 mL/min, and the average value of the two measurements is determined as the N element content. Note that, in the case where the N element content as measured by the aforementioned measuring method is less than 0.5% by mass, a measurement is further performed by means of a trace nitrogen analysis device ND-100 (manufactured by Mitsubishi Chemical Corporation). A quantitative element is performed under the following conditions using a calibration curve prepared with a pyridine standard solution. As for temperature of an electric furnace for use, the temperature at a heat decomposition section (horizontal reactor) is set to 800° C., and a catalyst section is set to 900° C. As for the measuring conditions, a main 0, flow rate is 300 ml/min, an 02 flow rate is 300 mL/min, an Ar flow rate is 400 mL/min, and sensitivity is set as “Low.” Note that, the THF soluble component in the toner is obtained by placing 5 g of toner in a Soxhlet extractor in advance, performing extraction with 70 mL of tetrahydrofuran (THF) for 20 hours using the extractor, and heating and vacuuming the result to remove THF.

The presence of a urea bond in the THF soluble component of the toner is important, as the urea bond can contribute on an improvement of toughness of a toner or offset resistance, with only a small amount thereof. The presence of a urea bond in the THF soluble component of the toner can be confirmed by ¹³C-NMR. Specifically, an analysis is performed in the following manner. After immersing 2 g of a sample to be analyzed in 200 mL of a 0.1 mol/L potassium hydroxide methanol solution for 24 hours at 50° C., the solvent is removed. The residues are washed with ion-exchanged water until the value of pH indicates neutral, and the remained solids are dried. The dried sample is added to a mixed solvent (volume ratio: 9/1) of dimethyl acetoamide (DMAc) and deuterated dimethyl sulfoxide (DMSO-d6) to give a concentration of 100 mg/0.5 mL, and was dissolved for 12 hours to 24 hours at 70° C. Thereafter, the temperature is adjusted to 50° C., and a ¹³C-NMR measurement is performed. Note that, a measuring frequency is 125.77 MHz, 1H_{—}60^{°} pulse is 5.5 μs, and as for a standard material, tetramethyl silane (TMS) is 0.0 ppm.

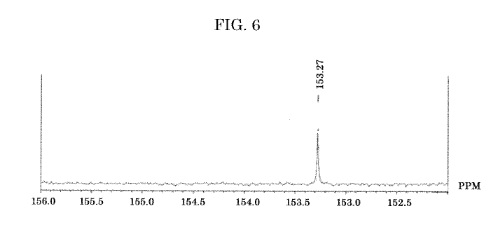

The presence of a urea bond in the sample is confirmed by a signal appeared in a chemical shift of a signal derived from carbonyl carbon of a urea bond segment of polyurea, which is a preparation. Typically, a chemical shift of carbonyl carbon is appeared at 150 ppm to 160 ppm. As for one example, a ¹³C-NMR spectrum diagram of polyurea in the region of carbonyl carbon of polyurea, which is a reaction product between 4,4′-diphenylmethane diisocyanate (MDI) and water, is presented in FIG. 6. In FIG. 6, a signal derived from carbonyl carbon is observed at 153.27 ppm.

### <<<Releasing Agent>>>

The releasing agent is appropriately selected from those known in the art depending on the intended purpose without any limitation. Examples of the releasing agent include wax, such as carbonyl group-containing wax, polyolefin wax, and ling-chain hydrocarbon. There may be used alone, or in combination. Among them, carbonyl group-containing wax is preferable.

Examples of the carbonyl group-containing wax include polyalkanoic acid ester, polyalkanol ester, polyalkanoic acid amide, polyalkyl amide, and dialkyl ketone.

Examples of the polyalkanoic acid ester include carnauba wax, montan wax, trimethylolpropane tribehenate, pentaerythritol tetrabehenate, pentaerythritol diacetate dibehenate, glycerin tribehenate, and 1,18-octadecanediol distearate.

Examples of the polyalkanol ester include tristearyl trimellitate, and distearyl maleate.

Examples of the polyalkanoic acid amide include dibehenyl amide.

Examples of the polyalkyl amide include trimellitic acid tristearyl amide.

Examples of the dialkyl ketone include distearyl ketone.

Among the carbonyl group-containing wax mentioned above, polyalkanoic acid ester is particularly preferable.

Examples of the polyolefin wax include polyethylene wax, and polypropylene wax.

Examples of the long chain hydrocarbon include paraffin wax, and sasol wax.

A melting point of the releasing agent is appropriately selected depending on the intended purpose without any limitation, but the melting point thereof is preferably 50° C. to 100° C., more preferably 60° C. to 90° C. When the melting point is lower than 50° C., use of such releasing agent may adversely affect the heat resistant storage stability of the resulting toner. When the melting point is greater than 100° C., the resulting toner is likely to cause cold offset during the fixing at low temperature.

The melting point of the releasing agent can be measured, for example, by means of a differential scanning calorimeter (TA-60WS and DSC-60, manufactured by Shimadzu Corporation). Specifically, the measurement is performed in the following manner. First, a sample container formed of aluminum is charged with 5.0 mg of the releasing agent, the sample container is placed in a holder unit, and the holder unit is set in an electric furnace. Next, the sample is heated from 0° C. to 150° C. at the heating rate of 10° C./min, followed by cooling the sample from 150° C. to 0° C. at the cooling rate of 10° C./min. Thereafter, the sample is further heated to 150° C. at the heating rate of 10° C./min, to thereby measure a DSC curve. The maximum peak temperature of heat of melting at the second heating is measured as a melting point from the obtained DSC curve using an analysis program in the DSC-60 system.

The melt viscosity of the releasing agent as measured at 100° C. is preferably 5 mPa·sec to 100 mPa·sec, more preferably 5 mPa·sec to 50 mPa·sec, and particularly preferably 5 mPa·sec to 20 mPa·sec. When the melt viscosity thereof is lower than 5 mPa·sec, releasing properties thereof may be low. When the melt viscosity thereof is greater than 100 mPa·sec, hot offset resistance and releasing properties at low temperature may be poor.

An amount of the releasing agent in the toner is appropriately selected depending on the intended purpose without any limitation, but the amount thereof is preferably 1% by mass to 20% by mass, more preferably 3% by mass to 10% by mass. When the amount thereof is less than 1% by mass, hot offset resistance of a resulting toner tends to be poor. When the amount thereof is greater than 20% by mass, heat resistant storage stability, electrostatic properties, transfer properties, and stress resistance of a resulting toner tends to be poor.

### <<<Colorant>>>

The colorant is appropriately selected from those colorants known in the art depending on the intended purpose without any limitation.

A color of the colorant for use in the toner is appropriately selected depending on the intended purpose without any limitation, and the color thereof is at least one selected from the group consisting of a black toner, a cyan toner, a magenta toner, and a yellow toner. The toner of each color can be attained by appropriately selecting a type of the colorant for use, and the toner is preferably a color toner.

Examples of the colorant used for black include: carbon black (C.I. Pigment Black 7), such as furnace black, lamp black, acetylene black, and channel black; metal, such as copper, iron (C.I. Pigment Black 11), and titanium oxide; and an organic pigment, such as aniline black (C.I. Pigment Black 1).

Examples of the colorant used for magenta include: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 150, 163, 177, 179, 184, 202, 206, 207, 209, 211, 269; C.I. Pigment Violet 19; and C.I. Violet Red 1, 2, 10, 13, 15, 23, 29, 35.

Examples of the colorant used for cyan include: C.I. Pigment Blue 2, 3, 15, 15:1, 15:2, 15:3, 15:4, 15:6, 16, 17, 60; C.I. Vat Blue 6: C.I. Acid Blue 45 or a copper phthalocyanine pigment, in which 1 to 5 phthalimidemethyl groups are introduced into the phthalocyanine skeleton thereof by substitution, C.I. Pigment Green 7, and C.I. Pigment Green 36.

Examples of the colorant used for yellow include: C.I. Pigment Yellow 1, 2, 3, 4, 5, 6, 7, 10, 11, 12, 13, 14, 15, 16, 17, 23, 55, 65, 73, 74, 83, 97, 110, 139, 151, 154, 155, 180, 185; and C.I. Vat Yellow 1, 3, 20, C.I. Pigment Orange 36.

An amount of the colorant in the toner is appropriately selected depending on the intended purpose without any limitation, but the amount thereof is preferably 1% by mass to 15% by mass, more preferably 3% by mass to 10% by mass. When the amount thereof is less than 1% by mass, tinting strength of a resulting toner may be low. When the amount thereof is greater than 15% by mass, a dispersion failure of the colorant is caused inside the toner particles, which may cause low tinting strength and insufficient electric properties of the toner.

The colorant may be used as a master batch, in which the colorant forms a composite with a resin. The resin is not particularly limited, but use of the aforementioned binder resin, or a resin having a structure similar to that of the binder resin is preferable in view of compatibility to the binder resin.

The master batch can be produced by mixing or kneading the resin and the colorant together through application of high shearing force. An organic solvent may be used in the production of the master batch for improving the interactions between the colorant and the resin. Moreover, a so-called flashing method is preferably used, since a wet cake of the colorant can be directly used without being dried. The flashing method is a method in which an aqueous paste containing a colorant is mixed or kneaded with a resin and an organic solvent, and then the colorant is transferred to the resin to remove the moisture and the organic solvent. In the mixing or kneading, a high-shearing disperser (e.g., a three-roll mill) is preferably used.

### <<<Other Components>>>

Other components are appropriately selected depending on the intended purpose without any limitation, and examples thereof include a charge controlling agent, a fluorine compound, and external additives.

### —Charge Controlling Agent—

The charge controlling agent is appropriately selected depending on the intended purpose without any limitation, but the charge controlling agent is preferably a material, which is colorless or in color close to white, because use of a color material may change a color tone of a resulting toner. Examples of the charge controlling agent include a triphenyl methane-based dye, a molybdic acid chelate pigment, a rhodamine dye, alkoxy amine, quaternary ammonium salt (including fluorine-modified quaternary ammonium salt), alkyl amide, phosphorus or a phosphorus compound, tungsten or a tungsten compound, a fluorine-based active agent, a metal salt of salicylic acid, and a metal salt of a salicylic acid derivative. These may be used alone, or in combination.

An amount of the charge controlling agent in the toner is appropriately selected depending on the intended purpose without any limitation, but the amount thereof is preferably 0.01% by mass to 5% by mass, more preferably 0.02% by mass to 2% by mass, relative to the binder resin. When the amount thereof is greater than 5% by mass, charging ability of the toner becomes excessively large, an effect of the charge controlling agent is reduced, and therefore electrostatic force with the developing roller increases to reduce flowability of the developer, or reduce image density. When the amount thereof is less than 0.01% by mass, charge start up or a charged amount of a toner is not sufficient, which may adversely affect a resulting toner image.

### —Fluorine Compound—

The fluorine compound is appropriately selected depending on the intended purpose without any limitation, but the fluorine compound is preferably a compound represented by the following general formula (1).

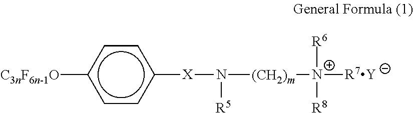

In the general formula (1), X is —SO₂— or —CO—; R⁵, R⁶, R⁷, and R⁸ are each independently a group selected from the group consisting of a hydrogen atom, a C1-C10 alkyl group, and an aryl group; m and n are positive numbers; and Y is a halogen atom, such as I, Br, and Cl, preferably I (iodine).

It is also preferred that the fluorine-containing quaternary ammonium salt represented by the general formula (1) be used in combination with a metal-containing azo dye.

Specific examples of the compound represented by the general formula (1) include the fluorine compounds represented by the following structural formulae (1) to (27), which are all in white or pale yellow.

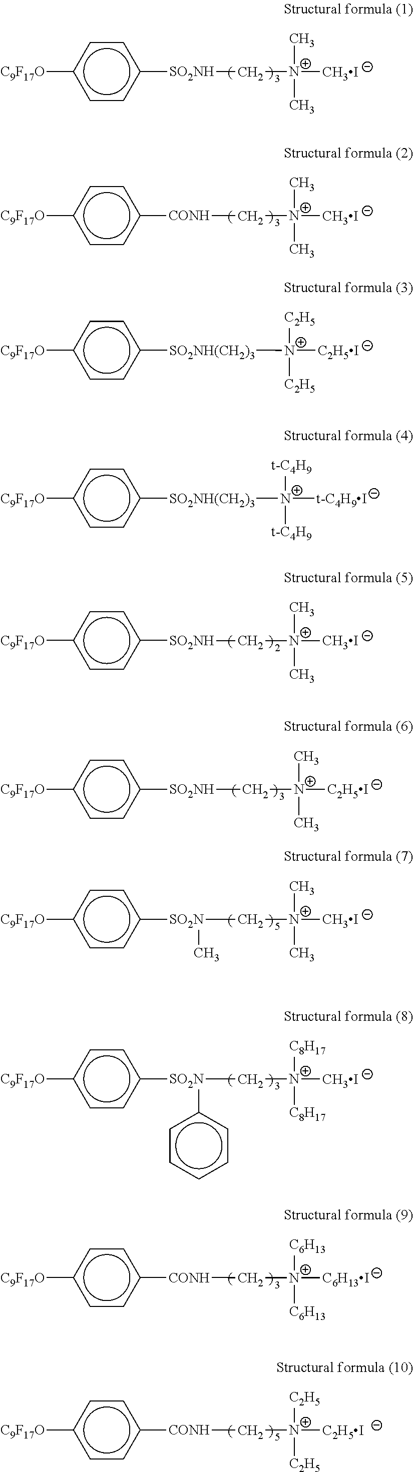

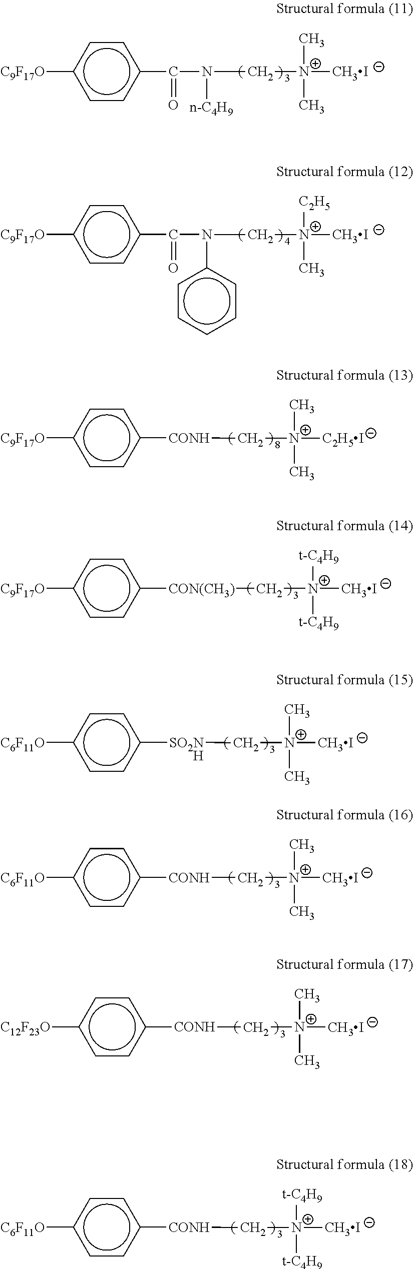

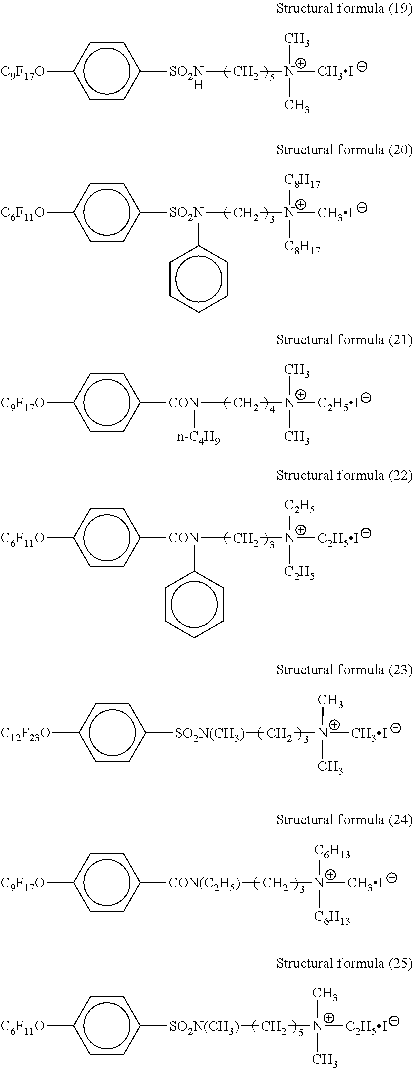

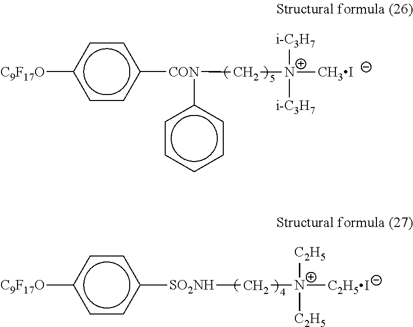

Among them, N,N,N-trimethyl-[3-(4-perfluorononenyloxybenzoamide)propyl]ammonium-iodide is preferable in view of an ability to impart charge.

The fluorine compound is appropriately selected depending on the intended purpose without any limitation, but the fluorine compound is preferably used to a surface treatment of the toner in the range of 0.01% by mass to 5% by mass relative to the toner, more preferably 0.01% by mass to 3% by mass. When the surface treatment amount with the fluorine compound is less than 0.01% by mass, an effect of the fluorine compound may not be sufficiently exhibited. When the surface treatment amount is greater than 5% by mass, a fixing failure of a toner may occur.

A method for surface treating the toner with the fluorine compound is appropriately selected depending on the intended purpose without any limitation, and for example, surface-treated toner base particles can be attained by dispersing toner base particles before addition of inorganic particles in an aqueous solvent (preferably water containing a surfactant), in which the fluorine compounds has been dispersed, to deposit (or bind through ionic bonds) the fluorine compound on surfaces of the toner particles, removing the solvent, and drying the toner base particles. In this process, preferably 5% by mass to 80% by mass, more preferably 10% by mass to 50% by mass of alcohol is added to the aqueous solvent, as dispersibility of the fluorine compound improves, a deposition state to surfaces of the toner particles becomes uniform, and charging uniformity between toner particles is improved.

Moreover, a conventional method for depositing or fixing the fluorine compound on surfaces of toner particles can be also used. Examples of the method thereof include: a method, in which the fluorine compound is fixed on surfaces of toner particles by performing deposition and fixing of the fluorine compound on the toner surfaces, and mixing using mechanical shear force, in combination with a heat treatment; a method, in which the fluorine compound is fixed on the toner surfaces using a combination of mixing and mechanical impacts; and a chemical method, in which the fluorine compound is fixed on toner surfaces through a chemical bond, such as a covalent bond, hydrogen bond, and ionic bond between the toner and fine powder of the fluorine compound.

### —External Additives—

Various external additives may be added to the toner for the purpose of improving flowability, adjusting charging capacity, and adjusting electric properties.

The external additives can be appropriately selected from those known in the art depending on the intended purpose without any limitation, and examples thereof include silica particles, hydrophobic silica, fatty acid metal salt (e.g., zinc stearate, aluminum stearate), metal oxide (e.g., titania, alumina, tin oxide, and antimony oxide), hydrophobic metal oxide and fluoropolymer. Among them, preferred are hydrophobic silica particles, titania particles, and hydrophobic titania particles.

Examples of the hydrophobic silica particles include: HDK H2000, HDK H2000/4, HDK H2050EP, HVK21, HDK H1303 (all manufactured by Hoechst AG); and R972, R974, RX200, RY200, R202, R805, R812 (all manufactured by Nippon Aerosil Co., Ltd.). Examples of the titania particles include: P-25 (manufactured by Nippon Aerosil Co., Ltd.); STT-30, STT-65C-S (both manufactured by Titan Kogyo, Ltd.); TAF-140 (manufactured by Fuji Titanium Industry Co., Ltd.); and MT-150W, MT-500B, MT-600B, MT-150A (all manufactured by TAYCA CORPORATION). Examples of the hydrophobic titanium oxide particles include: T-805 (manufactured by Nippon Aerosil Co., Ltd.); STT-30A, STT-66S-S (both manufactured by Titan Kogyo, Ltd.); TAF-500T, TAF-1500T (both manufactured by Fuji Titanium Industry Co., Ltd.); MT-100S, MT-100T (both manufactured by TAYCA CORPORATION); and IT-S (manufactured by ISHIHARA SANGYO KAISHA, LTD.). These may be used alone, or in combination.

The hydrophobic silica particles, hydrophobic titania particles, and hydrophobic alumina particles can be obtained by treating hydrophilic particles with a silane coupling agent, such as methyl trimethoxy silane, methyl triethoxy silane, and octyl trimethoy silane. Examples of the hydrophobic treating agent include: silane coupling agent (e.g., dialkyl dihalogenated silane, trialkyl halogenated silane, alkyl trihalogenated silane, and hexaalkyl disilazane), a sililation agent, a silane coupling agent containing a fluoroalkyl group, an organic titanate-based coupling agent, an aluminum-based coupling agent, silicone oil, and silicone varnish. These may be used alone, or in combination.

The average particle diameter of primary particles of the inorganic particles is appropriately selected depending on the intended purpose without any limitation, but the average particle diameter thereof is preferably 1 nm to 100 nm, more preferably 3 nm to 70 nm. When the average particle diameter thereof is smaller than 1 nm, the inorganic particles are embedded in a toner particle, and therefore it may be difficult to effectively exhibit a function of the inorganic particles. When the average particle diameter thereof is greater than 100 nm, the inorganic particles may unevenly damage a surface of the electrostatic latent image bearing member.

As for the external additives, inorganic particles or hydrophobic inorganic particles may be used in combination. It is preferred that the external additives contain at least two types of hydrophobic inorganic particles having the average primary particle diameter of 20 nm or smaller, and one type of inorganic particles having the average primary particle diameter of 30 nm or greater. Moreover, the BET specific surface area of the inorganic particles is preferably 20 m²/g to 500 m²/g. An amount of the external additives is preferably 0.1% by mass to 5% by mass, more preferably 0.3% by mass to 3% by mass, relative to the toner.

Resin particles can be also added as the external additives. Examples of the resin particles include: polystyrene obtained through soap-free emulsion polymerization, suspension polymerization, or dispersion polymerization; a copolymer of methacrylic acid ester or acrylic acid ester; polycondensation polymer particles, such as silicone, benzoguanamine, and nylon; and polymer particles of a thermoset resin.

Use of such resin particles in combination can enhance electrostatic properties of a toner, reduces reverse charging of a toner, and can reduce background depositions. An amount of the resin particles is preferable 0.01% by mass to 5% by mass, more preferably 0.1% by mass to 2% by mass, relative to the toner.

### <<Production Method of Toner>>

The production method of the toner is not particularly limited, and can be selected from any of the methods known in the art. Examples of the production method thereof include a knead-pulverization method, and a so-called chemical method where a toner is granulated in an aqueous medium.

Examples of the chemical method include: a suspension polymerization method, emulsion polymerization method, seed polymerization method, and dispersion polymerization method, all of which use a monomer as a starting material; a dissolution suspension method in which a resin or resin precursor is dissolved in an organic solvent, and the resulting solution is dispersed and/or emulsified in an aqueous medium; a method (production method (I)), in which an oil phase composition containing a resin precursor containing a functional group reactable with an active hydrogen group (reactive group-containing prepolymer) is emulsified and/or dispersed in an aqueous medium containing resin particles in the dissolution suspension method, and an active hydrogen group-containing compound and the reactive group-containing prepolymer are allowed to react in the aqueous medium; a phase-transfer emulsification method in which water is added to a solution containing a resin or resin precursor, and an appropriate emulsifying agent to proceed phase transfer; and an aggregation method, in which resin particles obtained in any of the aforementioned methods are dispersed an aqueous medium, and in this state the resin particles are aggregated and heated and fused to granulate particles of the predetermined size. Among them, the toner obtained by the dissolution suspension method, the production method (I), or the aggregation method is preferable because of granulation ability of the crystalline resin (e.g., easiness in control of particle size distribution, and control of particle shape), and the toner obtained by the production method (I) is more preferable.

### —Kneading-Pulverization Method—

The kneading-pulverization method is a method for producing base particles of the toner, for example, by melt-kneading toner materials containing at least a colorant, a binder resin, and a releasing agent, pulverizing the resulting kneaded product, and classifying the pulverized product.

In the melt-kneading, the toner materials are mixed, and a melt-kneader is charged with the resulting mixture to perform melt-kneading. As for the melt-kneader, a single or twin screw continuous kneader, or a batch-type kneader using a roll mill can be used. For example, preferably used are KTK twin-screw extruder (manufactured by Kobe Steel, Ltd.)), TEM extruder (manufactured by Toshiba Machine Co., Ltd.), a twin-screw extruder (manufactured by KCK K.K.), PCM twin-screw extruder (manufactured by Ikegai, Ltd.), and Buss Cokneader (manufactured by Buss A.G.). The melt-kneading is ideally performed under the conditions with which molecular chains of the binder resin are not cut. Specifically, the temperature of the melt-kneading is adjusted by taking a softening point of the binder resin under the consideration. When the temperature of the melt-kneading is very high compared to the softening point thereof, the scission of the molecular chains of the binder resin occurs significantly. When the temperature thereof is very low compared to the softening point thereof, the dispersing may not be progressed.

In the pulverizing, the kneaded product obtained by the kneading is pulverized. In the pulverizing, it is preferred that the kneaded product be coarsely pulverized, followed by finely pulverized. For the pulverizing, a method in which the kneaded product is pulverized by making the kneaded product crush into an impact plate in the jet stream, a method in which particles of the kneaded product are made crushed each other in the jet stream to thereby pulverize the kneaded product, or a method in which the kneaded product is pulverized in a narrow gap between a mechanically rotating rotor and a stator is preferably used.

The classifying is classifying the pulverized product obtained by the pulverizing into particles having the predetermined particle diameters. The classifying can be performed by removing the fine particles component, for example, by means of a cyclone, a decanter, or a centrifugal separator. After the completion of the pulverizing and the classifying, the classified pulverized product is classified in an air stream by centrifugal force to thereby produce toner base particles having the predetermined particle diameters.

The dissolution suspension method is a method for producing base particles of the toner, for example, by dispersing and/or emulsifying, in an aqueous medium, an oil phase composition, which is obtained by dissolving and/or dispersing a toner composition containing at least a binder resin and/or a resin precursor, a colorant, and a releasing agent into an organic solvent.

As for the organic solvent used for dissolving and/or dispersing the toner composition therein, a volatile organic solvent having a boiling point of lower than 100° C. is preferable, because removal of the organic solvent performed later is easy.

The organic solvent is appropriately selected depending on the intended purpose without any limitation, and examples thereof include: an esterbased solvent or ester ether based solvent, such as ethyl acetate, butyl acetate, methoxy butyl acetate, methyl cellosolve acetate, and ethyl cellosolve acetate; an etherbased solvent, such as diethyl ether, tetrahydrofuran, dioxane, ethyl cellosolve, butyl cellosolve, and propylene glycol monomethyl ether; a ketone-based solvent, such as acetone, methyl ethyl ketone, methyl isobutyl ketone, di-n-butyl ketone, and cyclohexanone; and an alcohol-based solvent, such as methanol, ethanol, n-propanol, isopropanol, n-butanol, isobutanol, t-butanol, 2-ethylhexyl alcohol, and benzyl alcohol. These may be used alone, or in combination.

In the dissolution suspension method, an emulsifying agent or a dispersing agent may be optionally used when the oil phase composition is dispersed and/or emulsified in the aqueous medium.

The emulsifying agent or dispersing agent is not particularly limited, a conventional surfactant or water-soluble polymer can be used.

The surfactant is not particularly limited, and examples thereof include: an anionic surfactant (e.g., alkyl benzene sulfonate, and phosphonic acid ester); a cationic surfactant (e.g., a quaternary ammonium salt-based surfactant, and an amine salt-based surfactant); an amphoteric surfactant (e.g., a carboxylic acid salt-based surfactant, a sulfuric acid ester salt-based surfactant, a sulfonic acid salt-based surfactant, and a phosphoric acid ester salt-based surfactant); and a nonionic surfactant (e.g., an AO adduct-based surfactant, and a polyhydric alcohol-based surfactant). These may be used alone, or in combination.

Examples of the water-soluble polymer include a cellulose-based compound (e.g., methyl cellulose, ethyl cellulose, hydroxyethyl cellulose, ethyl hydroxyethyl cellulose, carboxymethyl cellulose, hydroxypropyl cellulose, and a saponificated product thereof), gelatin, starch, dextrin, Arabian gum, chitin, chitosean, polyvinyl alcohol, polyvinyl pyrrolidone, polyethylene glycol, polyethylene imine, polyacryl amide, acrylic acid (salt)-containing polymer (e.g., sodium polyacrylate, potassium polyacrylate, ammonium polyacrylate, a partially neutralized product of polyacrylic acid with sodium hydroxide, and sodium acrylate-acrylic acid ester copolymer), a (partially) neutralized product of styrene-maleic anhydride copolymer with sodium hydroxide, and water-soluble polyurethane (e.g., a reaction product of polyisocyanate with polyethylene glycol or polycaprolactone diol). These may be used alone, or in combination. Note that, as for an aid for emulsification or dispersion, the organic solvent or plasticizer may be used in combination.

### —Dissolution Suspension Method—

As for the dissolution suspension method, base particles of the toner are preferably granulated by the method (production method (I)) where an oil phase composition containing at least a binder resin, a binder resin precursor containing a functional group reactable with an active hydrogen group (a reactive group-containing prepolymer), a colorant, and a releasing agent is dispersed and/or emulsified in an aqueous medium containing resin particles, and an active hydrogen group-containing compound and the reactive group-containing prepolymer contained in the oil phase composition and/or aqueous medium are allowed to react.

The resin particles can be formed in accordance with any of conventional polymerization methods, but the resin particles are preferably obtained as an aqueous dispersion liquid of resin particles. Examples of a method for preparing the aqueous dispersion liquid of the resin particles include methods described in the following (a) to (h):

(a) A method where a vinyl monomer is used as a starting material, the vinyl monomer is polymerized through a polymerization reaction that is any of a suspension polymerization, an emulsion polymerization method, a seed polymerization method, or a dispersion polymerization method, to thereby directly prepare an aqueous dispersion liquid of resin particles.
(b) A method where a precursor (e.g., a monomer, and an oligomer) of a polyaddition or polycondensation resin, such as a polyester resin, a polyurethane resin, and an epoxy resin, or a solvent solution thereof is dispersed in an aqueous medium in the presence of an appropriate dispersing agent, followed by curing through application of heat or a curing agent, to thereby prepare an aqueous dispersion liquid of resin particles.
(c) A method where an appropriate emulsifying agent is dissolved in a precursor (e.g., a monomer, and an oligomer) of a polyaddition or polycondensation resin, such as a polyester resin, a polyurethane resin, and an epoxy resin, or a solvent solution thereof (preferably a liquid, or may be liquidized by heating), followed by adding water to perform phase-transfer emulsification, to thereby prepare an aqueous dispersion liquid of resin particles.
(d) A method where a resin, which is synthesized through a polymerization reaction (e.g., addition polymerization, ring-opening polymerization, polyaddition, addition condensation, and condensation polymerization) in advance, is pulverized by a pulverizer of a mechanical rotation-type or a jet-type, followed by classifying to obtain resin particles, and the resin particles are dispersed in water in the presence of an appropriate dispersing agent, to thereby prepare an aqueous dispersion liquid of the resin particles.
(e) A method where a resin, which is synthesized through a polymerization reaction (e.g., addition polymerization, ring-opening polymerization, polyaddition, addition condensation, and condensation polymerization) in advance, is dissolved in a solution to prepare a resin solution, and the resin solution is sprayed in a mist form to form resin particles, and the resin particles are dispersed in water in the presence of an appropriate dispersing agent, to thereby prepare an aqueous dispersion liquid of the resin particles.
(f) A method where a resin, which is synthesized through a polymerization reaction (e.g., addition polymerization, ring-opening polymerization, polyaddition, addition condensation, and condensation polymerization) in advance, is dissolved in a solution to prepare a resin solution, and resin particles are precipitated by adding a poor solvent to the resin solution, or cooling the resin solution, which has been heated and dissolved in a solvent in advance, and the solvent is removed to form resin particles, and the resin particles are dispersed in water in the presence of an appropriate dispersing agent, to thereby prepare an aqueous dispersion liquid of the resin particles.
(g) A method where a resin, which is synthesized through a polymerization reaction (e.g., addition polymerization, ring-opening polymerization, polyaddition, addition condensation, and condensation polymerization) in advance, is dissolved in a solution to prepare a resin solution, the resin solution is dispersed in an aqueous medium in the presence of an appropriate dispersing agent, followed by heating or reducing pressure to remove the solvent, to thereby prepare an aqueous dispersion liquid of resin particles.
(h) A method where a resin, which is synthesized through a polymerization reaction (e.g., addition polymerization, ring-opening polymerization, polyaddition, addition condensation, and condensation polymerization) in advance, is dissolved in a solution to prepare a resin solution, an appropriate emulsifying agent is dissolved in the resin solution, followed by adding water to perform phase-transfer emulsification, to thereby prepare an aqueous dispersion liquid of resin particles.

The volume average particle diameter of the resin particles is appropriately selected depending on the intended purpose without any limitation, but the volume average particle diameter thereof is preferably 10 nm to 300 nm, more preferably 30 nm to 120 nm. When the volume average particle diameter is smaller than 10 nm, or greater than 300 nm, a particle size distribution of a resulting toner may be undesirable.

The solid content of the oil phase is appropriately selected depending on the intended purpose without any limitation, but the solid content thereof is preferably 40% by mass to 80% by mass. The excessively high solid content thereof causes difficulties in dissolving or dispersing, and increases the viscosity of the oil phase which is difficult to handle. The excessively low solid content thereof leads to a low yield of the toner.

Materials of the toner composition, other than the binder resin, such as the colorant, and the releasing agent, and a master batch thereof may be each separately dissolved or dispersed in an organic solvent, followed by mixing the resultant with a binder resin solution or dispersion liquid.

As for the aqueous medium, water may be used solely, or water may be used in combination with water-miscible solvent. Examples of the water-miscible solvent include alcohol (e.g., methanol, isopropanol, and ethylene glycol), dimethyl formamide, tetrahydrofuran, cellosolve (e.g., methyl cellosolve), and lower ketone (e.g., acetone, and methyl ethyl ketone).

The method for emulsifying and/or dispersing in the aqueous medium is appropriately selected depending on the intended purpose without any limitation, and examples thereof include methods using a low-speed shearing disperser, a high-speed shearing disperser, a friction disperser, a high-pressure jetting disperser and ultrasonic wave disperser. Among them, the method using the high-speed shearing disperser is preferable, in view of reducing the size of particles. In the case where the high-speed shearing disperser is used, the rotating speed thereof is appropriately selected depending on the intended purpose without any limitation, but the rotating speed thereof is preferably 1,000 rpm to 30,000 rpm, more preferably 5,000 rpm to 20,000 rpm. The temperature for the dispersing is preferably 0° C. to 150° C. (in the pressurized state), more preferably 20° C. to 80° C.

In order to remove the organic solvent from the obtained emulsified dispersion liquid, a conventional method known in the art can be used without any limitation. For example, a method, in which the temperature of the entire system is gradually increased under normal pressure or reduced pressure, to completely evaporate and remove the organic solvent in the droplets, can be employed.

As for a method for washing and drying the toner base particles dispersed in the aqueous medium, a conventional method can be used. Specifically, a toner powder is obtained by, after performing a solid-liquid separation using a centrifugal separator or filter press, dispersing the obtained toner cake in ion-exchanged water of room temperature to about 40° C., optionally adjusting pH thereof with acid or alkali, again performing solid-liquid separation, repeating these steps to remove impurities or surfactant, and drying the resultant using a flash dryer, circulating dryer, vacuum dryer, or vibration fluidized bed dryer. During this process, a fine particle component of the toner may be removed by centrifugal separation. Alternatively, moreover, a desired particle size distribution of the toner is attained optionally by means of a conventional classifier after the drying.

### —Aggregation Method—

The aggregation method is, for example, a method, in which a resin particle dispersion liquid containing at least a binder resin, a colorant particle dispersion liquid, and optionally a releasing agent particle dispersion liquid together to aggregate particles to thereby produce toner base particles. The resin particle dispersion liquid is obtained by a conventional method, such as emulsion polymerization, seed polymerization, and phase-transfer emulsification. The colorant particle dispersion liquid or releasing agent particle dispersion liquid is obtained by dispersing a colorant or a releasing agent in water in accordance with a conventional wet dispersing method.

In order to control the aggregation state, a method such as heating, adding a metal salt, and adjusting pH can be preferably used. The metal salt is appropriately selected depending on the intended purpose without any limitation, and examples thereof include: a monovalent metal salt including salts of sodium and potassium; a bivalent metal salt including salts of calcium and magnesium; and a trivalent metal salt including a salt of aluminum. Examples of an anion for constituting the aforementioned salt include chloride ion, bromide ion, iodide ion, carbonic ion, and sulfuric ion. Among them, magnesium chloride, aluminum chloride, a complex or multimer thereof are preferable. Heating during or after the aggregating accelerates fusion between resin particles, which is preferable in terms of homogeneity of the toner. Further, the shapes of the toner particles, i.e., the shape of the toner, can be controlled by the heating. Generally, the shapes of the toner particles become closer to spherical shapes as heating continues.

For washing and drying of the base particles of the toner dispersed in the aqueous medium, the aforementioned method can be used.

In order to flowability, storage stability, developing ability, and transferring properties of the toner, moreover, inorganic particles, such as hydrophobic silica powder, may be added to and mixed with the toner base particles produced in the aforementioned manner.

As for mixing of additives, a typical mixer for powder is used, but a mixer, which is equipped with a jacket, and can control internal temperature thereof, is preferable. In order to change a history of load applied to the additive, the additive is added in the middle of the process, or is added gradually. In this case, a rotation speed, rolling speed, process time, and temperature may be changed. Alternatively, strong load may be applied first, followed by applying relatively weak load may be applied, or vice versa. Examples of an usable mixing equipment include a V-type mixer, a rocking mixer, a lodige mixer, Nauta mixer, and HENSCHEL MIXER. Subsequently, the resulting particles are passed through a sieve with 250-mesh or greater to remove coarse particles or aggregated particles, to thereby a toner.

A shape, and size of the toner are appropriately selected depending on the intended purpose without any limitation, but the toner preferably has the following average circularity, volume average particle diameter, and a ratio (volume average particle diameter/number average particle diameter) of the volume average particle diameter to the number average particle diameter.

The average circularity is a value obtained by dividing a boundary length of a corresponding circle having the equal area to the projected area of a shape of the toner, with a boundary length of the actual toner particle. For example, the average circularity is preferably 0.950 to 0.980, more preferably 0.960 to 0.975. Note that, it is preferred that particles having the average circularity of less than 0.95 be contained in an amount of 15% or less.

When the average circularity is less than 0.950, desirable transferring properties of a toner or a high quality image without dust particles may not be attained. When the average circularity is greater than 0.980, a cleaning failure occur on a photoconductor or transfer belt in an image forming system employing blade cleaning, an image may be smeared, for example, in the case where an image having a high imaging area, such as a photographic image, is formed, a toner constituting an untransferred image due to a failure of paper feeding is accumulated as the residual toner, which may cause background deposition of an image, or pollute a charging roller that is used to contact charge the photoconductor, and as a result an original charging ability may not be exhibited.

The average circularity was measured by a flow particle image analyzer (FPIA-2100, manufactured by Sysmex Corporation), and analyzed using an analysis software (FPIA-2100 Data Processing Program for FPIA version 00-10). Specifically, a 100 mL beaker formed of glass is charged with 0.1 mL to 0.5 mL of a 10% by mass surfactant (alkylbenzene sulfonate, NEOGEN SC-A, manufactured by DAI-ICHI KOGYO SEIYAKU CO., LTD.). To this, 0.1 g to 0.5 g of a toner is added, and the resulting mixture is stirred with a micro spatula, followed by adding 80 mL of ion-exchanged water. The obtained dispersion liquid is subjected to a dispersion treatment for 3 minutes by means of an ultrasonic disperser (manufactured by Honda Electronics). The resulting dispersion liquid having a concentration of 5,000 particles/L to 15,000 particles/μL is subjected to measurement of the shape and distribution of the toner by means of FPIA-2100. In this measuring method, it is important that the concentration of the dispersion liquid is 5,000 particle/μL to 15,000 particles/μL in view of measurement reproducibility of the average circularity. In order to obtain the concentration of the dispersion liquid, it is necessary to adjust the conditions of the dispersion liquid, i.e., an amount of the surfactant added, and an amount of the toner added. Similarly to the measurement of the toner particle diameters described earlier, an amount of the surfactant required is different depending on hydrophobicity of a toner. When the amount of the surfactant is large, noise occurs due to bubbles as formed. When the amount thereof is small, dispersion is insufficient. Moreover, an amount of the toner added is different depending on the particle diameters of the toner. It is necessary that the toner having small particle diameters is added in a small amount, and the toner having large particle diameters is added in a large amount. In the case where the particle diameters of the toner are in the range of 3 μm to 10 μm, it is possible to adjust the concentration of the dispersion liquid to the range of 5,000 particles/μL to 15,000 particles/μL by adding 0.1 g to 0.5 g of the toner.

The volume average particle diameter of the toner is appropriately selected depending on the intended purpose without any limitation, but the volume average particle diameter thereof is preferably 3 μm to 10 μm, more preferably 4 μm to 7 μm. When the volume average particle diameter thereof is smaller than 3 μm, in case of a two-component developer, a toner is fused on a surface of carrier particles due to stirring performed for a long period in the developing unit, and therefore charging ability of the carrier is reduced. When the volume average particle diameter thereof is greater than 10 μm, it is difficult to attain a high quality image with high resolution. In the case where a toner is supplied to a developer to compensate the toner use, moreover, variation in particle diameters of the toner becomes large.

A ratio (volume average particle diameter/number average particle diameter) of the volume average particle diameter of the toner to the number average particle diameter thereof is preferably 1.00 to 1.25, more preferably 1.00 to 1.15. The ratio (volume average particle diameter/number average particle diameter) of the volume average particle diameter of the toner to the number average particle diameter thereof is measured by a particle size analyzer (Multisizer III, manufactured by Beckman Coulter Inc.) with an aperture diameter of 100 μm, and analyzed by an analysis software (Beckman Coulter Mutlisizer 3 Version 3.51). Specifically, a 100 mL beaker formed of glass is charged with 0.5 mL of a 10% by mass surfactant (alkylbenzene sulfonate, NEOGEN SC-A, manufactured by DAI-ICHI KOGYO SEIYAKU CO., LTD.). To this, 0.5 g of a toner is added, and the resulting mixture is stirred with a micro spatula, followed by adding 80 mL of ion-exchanged water. The obtained dispersion liquid is subjected to a dispersion treatment for 10 minutes by means of an ultrasonic disperser (W-113MK-II, manufactured by Honda Electronics). The dispersion liquid was subjected to a measurement by using the Multisizer, and ISOTON III (manufactured by Beckman Coulter, Inc.) as a solution for the measurement. As for the measurement, the toner sample dispersion liquid is added dropwise so that a concentration indicated by the device is to be 8%±2%. It is important in this measuring method that the concentration is adjusted to 8%±2% in view of measurement reproducibility of the particle diameter. When the concentration is within the aforementioned range, an error in the particle diameter is not caused.

### <Transferring Step and Transferring Unit>

The transferring step contains transferring the visible image onto a recording medium. A preferable embodiment thereof uses an intermediate transfer member, and contains primary transferring the visible image onto the intermediate transfer medium, followed by secondary transferring the visible image onto a recording medium. A more preferably embodiment thereof use two colors or more of the toner, preferably a full-color toner, and contains a first transferring step, which contains transferring visible images onto an intermediate transfer member to form a composite transfer image, and a second transferring step, which contains transferring the composite transfer image onto a recording medium. The transferring can be performed, for example, by charging the electrostatic latent image bearing member (photoconductor) using a transfer charger. The transferring unit preferably contains a first transferring unit configured to transfer visible images on an intermediate transfer member to form a composite transfer image, and a second transferring unit configured to transfer the composite transfer image onto a recording medium. Note that, the intermediate transfer member is appropriately selected from conventional transfer members depending on the intended purpose without any limitation, and examples thereof include a transfer belt

The transferring unit (the first transferring unit, the second transferring unit) preferably contains at least a transferring device configured to charge and release the visible image formed on the electrostatic latent image bearing member (photoconductor) to the side of the recording medium. One or two or more transferring units may be provided. Examples of the transferring device include a corona transferring device using corona discharge, a transfer belt, a transfer roller, a pressure transfer roller, and an adhesion transfer member. Note that, the recording medium is appropriately selected from conventional recording media (recording paper) without any limitation.

### <Fixing Step and Fixing Unit>

The fixing step contains pressurizing and heating the visible image transferred on the recording medium, when the recording medium is passed between a heating member and a pressurized member, which are in contact with each other with pressure, to thereby fix the visible image on the recording medium. The fixing step is carried out by the fixing unit.

The fixing may be performed every time when an image formed of the toner of each color is transferred onto the recording medium. Alternatively, the fixing may be performed after the toners of all the colors are transferred to the recording medium in a laminated state.

The fixing unit is appropriately selected depending on the intended purpose without any limitation, but it is preferably a conventional heat press member. Examples of the heat press member include a combination of a heat roller and a press roller, and a combination of a heat roller, a press roller, and an endless belt. The fixing unit is preferably a unit, which contains a heater equipped with a heating element, a film in contact with the heater, and a pressing member in contact with the heater with pressure via the film, and is configured to pass through a recording medium, on which a non-fixed image has been formed, between the film and the pressing member, to thereby heat and fix the image. The heating by the heat press member is typically, preferably 80° C. to 200° C.

### <Discharging Step and Discharging Unit>

The discharging step contains discharging the recording medium, on which the transferred image has been fixed, to the outside, and is carried out by the discharging unit.

The discharging unit is appropriately selected depending on the intended purpose without any limitation, and examples thereof include a transport roller, and a pair of discharging rollers.

In the present invention, the fixing unit and the discharging unit can be preferably separately driven, in view of a control of a linear speed difference between the fixing unit and the discharging unit.

### <Other Steps and Other Units>

Other steps are appropriately selected depending on the intended purpose without any limitation, and examples thereof include a diselectrification step, a cleaning step, a recycling step, and a controlling step.

Other units are appropriately selected depending on the intended purpose without any limitation, and examples thereof include a diselectrification unit, a cleaning unit, a recycling unit, and a controlling unit.

The diselectrification step contains applying diselectrification bias to the electrostatic latent image bearing member to diselectrify the electrostatic latent image bearing member, and is suitably carried out by the diselectrification unit. The diselectrification unit is appropriately selected from conventional diselectrification units known in the art without any limitation, provided that it is capable of applying diselectrification bias to the electrostatic latent image bearing member. Examples thereof include a diselectrification lamp.

The cleaning step contains removing the toner remained on the electrostatic latent image bearing member, and is suitably carried out by the cleaning unit. The cleaning unit is appropriately selected from conventional cleaners known in the art without any limitation, provided that it is capable of removing the toner remained on the electrostatic latent image bearing member. Examples thereof include a magnetic brush cleaner, an electrostatic brush cleaner, a magnetic roller cleaner, a blade cleaner, a brush cleaner, and a web cleaner.

The recycling step contains recycling the toner removed by the cleaning step to the developing unit, and is suitably carried out by the recycling unit. The recycling unit is not particularly limited, and examples thereof include conventional conveying units.

The controlling step contains controlling operations of each unit, and is suitably carried out by the controlling unit. The controlling unit is appropriately selected depending on the intended purpose without any limitation, provided that it is capable of controlling operations of each unit. Examples thereof include devices, such as a sequencer, and a computer.

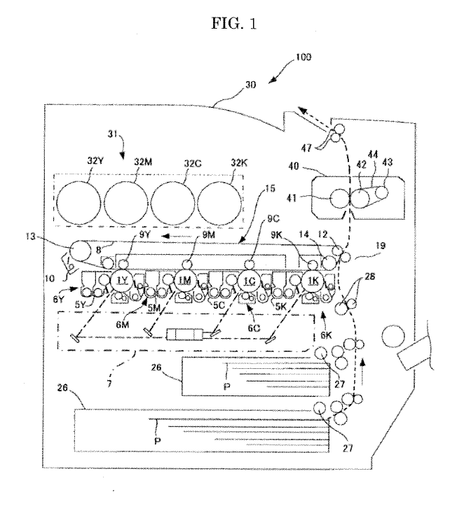

FIG. 1 is a schematic structure diagram of an image forming apparatus (printer 100) containing an image forming unit 2 provided inside a main body of the image forming apparatus, and a fixing unit 20.

As illustrated in FIG. 1, four toner cartridges (toner containers) 32Y, 32M, 32C, 32K serving as powder housing units, corresponding to respective colors (yellow, magenta, cyan, black) are detachably (replacably) provided in a toner supply unit 31, serving as a powder supply device, provided at the top of the image forming apparatus main body 100.

Part of the toner supply unit 31 other than the toner cartridges is a toner transporting unit, which serves as a powder transport device, and is configured to transport a toner, which is powdery image forming agent (powder) discharged from the toner cartridge to the below-mentioned developing unit. At the bottom of the toner supply unit 31, an intermediate transfer unit 15 is provided. Image forming units 6Y, 6M, 6C, 6K corresponding to respective colors (yellow, magenta, cyan, black) are parallel provided in order to face an intermediate transfer belt 8 serving as an intermediate transfer member of the intermediate transfer unit 15.

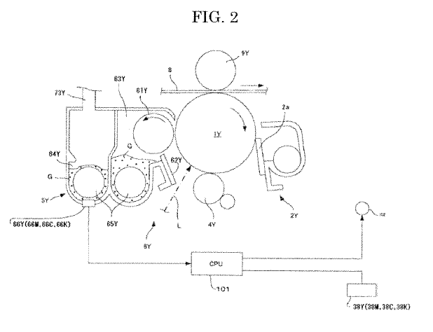

FIG. 2 is an enlarged diagram of the image forming unit 6Y. As illustrated in FIG. 2, the image forming unit 6Y corresponding to yellow is composed of a photoconductor drum 1Y serving as an electrostatic latent image bearing member, and a charging unit 4Y, a developing unit 5Y (developing unit), a cleaning unit 2Y, a diselectrification unit (not illustrated), which are provided in the surrounding area of the photoconductor drum 1Y. Then, an image forming step (a charging step, an exposing step, a developing step, a transferring step, a cleaning step, and a diselectrification step) is carried out on the photoconductor drum 1Y to thereby form a yellow image on the photoconductor drum 1.

Note that, other three image forming units 6M, 6C, 6K have the same structures to that of the image forming unit 6Y corresponding to yellow, provided that a color of the toner for use is different, and forms image corresponding to the color of the toner for use. Hereinafter, explanations of other three image forming units 6M, 6C, 6K are appropriately omitted, and only the image forming unit 6Y corresponding to yellow is explained.

In FIG. 2, the photoconductor drum 1Y is driven to rotate in a clockwise direction in FIG. 2 by means of a driving motor (not illustrated). Then, a surface of the photoconductor drum 1Y is uniformly charged by the charging unit 4Y in a charging position (charging step). Thereafter, the surface of the photoconductor drum 1Y reaches a radiation position of laser light L emitted from the exposing unit 7 (see FIG. 1), and in this position, an electrostatic latent image corresponding to yellow is formed by exposure scanning (exposing step).

Thereafter, the surface of the photoconductor drum 1Y reaches a counter position of the cleaning unit 2Y. In this position, the untrasferred toner remained on the photoconductor drum 1Y is mechanically scraped with a cleaning blade 2a, and then collected (cleaning step).

Finally, the surface of the photoconductor drum 1Y reaches a counter position of the diselectrification unit (not illustrated), and the residual potential on the photoconductor drum 1 is removed in this position.

With the above, a series of image forming processes performed on the photoconductor drum 1 is completed.

Note that, the aforementioned image forming processes are performed in other image forming units 6M, 6C, 6K in the same manner as in the yellow image forming unit 6Y. Specifically, the exposing unit 7 provided at the bottom of the image forming unit emits laser light L towards the photoconductor drum of each of the image forming units 6M, 6C, 6K, based on the image information. The exposing unit 7 applies laser light L in the following manner. The laser light L is emitted from a light source, and is applied on the photoconductor drum through a plurality of optical elements, while scanning the laser light L with a rotationally driven polygon mirror, which is a polygonal rotating mirror.

Thereafter, the developing step is performed, and toner images of the aforementioned colors formed on the respective photoconductor drums are transferred and superimposed on the intermediate transfer belt 8 (primary transferring step). In this manner, a color image is formed on the intermediate transfer belt 8.

As illustrated in FIG. 1, the intermediate transfer unit 16 is composed of the intermediate transfer belt 8, four primary transfer bias rollers 9Y, 9M, 9C, 9K, a secondary transfer back-up roller 12, a cleaning back-up roller 13, a tension roller 14, and an intermediate transfer cleaning unit 10. The intermediate transfer belt 8 is suspended and supported around the three rollers 12 to 14, and is endlessly moved in the direction depicted with the arrow in FIG. 1 by the rotational driving of the roller 12.

The four primary transfer bias rollers 9Y, 9M, 9C, 9K nip the intermediate transfer belt 8 with the photoconductor drums 1Y, IM, IC. 1K, respectively, to thereby form primary transfer nips. To the primary transfer bias rollers 9Y, 9M, 9C, 9K, transfer bias, which has reverse polarity to that of the toner, is applied. Then, the intermediate transfer belt 8 travels in the direction shown with the arrow, and sequentially passes through the primary transfer nips of the primary transfer bias rollers 9Y, 9M, 9C, 9K. In this manner, the toner images of the aforementioned colors are overlapped and primary transferred on the intermediate transfer belt 8.

Thereafter, the intermediate transfer belt 8, on which the toner images of the aforementioned colors have been superimposed and transferred, reaches a counter position of the secondary transfer roller 19. In this position, the secondary transfer back-up roller 12 nips the intermediate transfer belt 8 with the secondary transfer roller 19, to thereby form a secondary transfer nip. The toner images of four colors formed on the intermediate transfer belt 8 are transferred onto a recording medium P, such as transfer paper, which has been transported to the position of the secondary transfer nip (secondary transferring step). During this process, the untransferred toner, which has not been transferred to the recording medium P, is remained on the intermediate transfer belt 8.

Thereafter, the intermediate transfer belt 8 reaches a position of the intermediate transfer cleaning unit 10. In this position, the untransferred toner on the intermediate transfer belt 8 is collected. With the above, a series of transfer processes performed on the intermediate transfer belt 8 is completed.

The recording medium P transported to the position of the secondary transfer nip has been transported from a paper feeding unit 26, which is provided at the bottom of the apparatus main body 100 passing through a paper feeding roller 27 and a pair of registration rollers. Specifically, a plurality of sheets of recording media P, such as transfer paper, is stored in the paper feeding unit 26. Once the paper feeding roller 27 is rotationally driven in the anti-clockwise direction in FIG. 1, the recording medium P placed on the top is fed through to a nip between the pair of the registration rollers 28.

The recording medium P transported to the pair of the registration rollers 28 is temporarily stopped at a position of the roller nip of the pair of the registration rollers, the rotations of which have been stopped. Then, the pair of the registration rollers 28 are rotationally driven synchronously with the timing of the color image on the intermediate transfer belt 8, to thereby transport the recording medium P to the secondary transfer nip. In this manner, the desired color image is transferred on the recording medium P.

Thereafter, the recording medium P, on which the color image is transferred at the secondary transfer nip, is transported to a position of the fixing unit 40. In this position, the color image transferred on a surface of the recording medium P is fixed by heat and pressure applied by the fixing roller 42 and the press roller 41. Thereafter, the recording medium P passes through between a pair of discharging rollers 29, and is discharged to outside the apparatus. The recording medium P discharged to the outside the apparatus by the pair of the discharging rollers 29 is sequentially stacked on a stacking unit 30 as an output image.

With the above, a series of image forming processes by the printer is completed.

Next, a structure and operation of the developing unit in the image forming unit is more specifically explained with reference to FIG. 2. The developing unit 5Y is composed of a developing roller 61Y facing the photoconductor drum 1Y, a doctor blade 62Y facing the developing roller 61Y, transport screws 65Y, which are two transport members provided in the developer housing units 63Y, 64Y, and a density detective sensor configured to detect the toner density in the developer. The developing roller 61Y is composed of a magnet fixed in an inner part thereof and a sleeve rotating around the surrounding of the magnet. The developer housing units 63Y and 64Y each houses therein a two-component developer G containing a carrier and a toner. The developer housing unit 64Y is connected to a toner transport pipe 73Y, serving as a channel forming member that forms a powder transport channel, through an opening formed at a top part of the developer housing unit 64Y.

The developing unit 5Y having the above-described structure is operated as follows. The sleeve of the developing roller 61Y rotates in the direction depicted with an arrow in FIG. 2. The developer G held on the developing roller 61Y with a magnetic field formed by the magnet travels on the developing roller 61Y along the rotation of the sleeve.

The developer G in the developing unit 5Y is adjusted so that a ratio of the toner (toner density) in the developer is to be within a predetermined range. Specifically, the toner housed in the toner cartridge 32Y is supplied to the developer housing unit 64Y through a toner supply channel depending on the consumption of the toner in the developing unit 5Y.

Thereafter, the toner supplied onto the developer housing unit 64Y is circulated in the two developer housing units 63Y, 64Y (moved in the direction vertical to the paper plane in FIG. 2), while mixed and stirred with the developer G by two transport screws 66Y. The toner in the developer G is then adsorbed on the carrier due to friction charging with the carrier, and held on the developing roller 5Y together with the carrier by a magnetic force formed on the developing roller 61Y.

The developer G held on the developing roller 61Y is transported in the direction depicted with the arrow in FIG. 2, and reaches the position of the doctor blade 62Y. Then, the developer G on the developing roller 61Y is adjusted in terms of the amount thereof at this position, followed by transported to a counter position (a developing region) of the photoconductor drum 1Y. Then, the toner is adsorbed onto a latent image formed on the photoconductor drum 1 by an electric field formed in the developing region. Thereafter, the developer G remained on the developing roller 61Y reaches the upper part of the developer housing unit 63Y along the rotation of the sleeve, and is separated from the developing roller 61Y at this position.

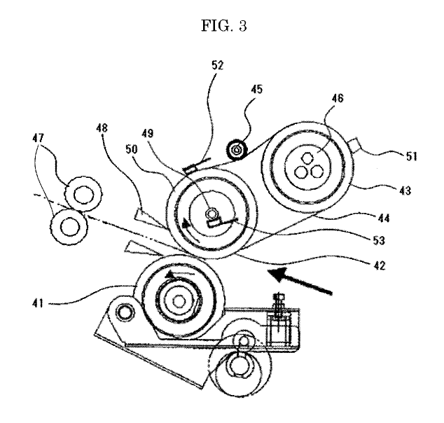

Next, the fixing unit 40 is explained. As illustrated in FIG. 3, the fixing unit 40 employs a belt fixing system, and contains a heat roller 43 having a heat source 46, a fixing roller 42, in which an elastic layer 50 is provided to the periphery of a metal core 49, an endless fixing belt 44 held around the heat roller 43 and the fixing roller 42, and a press roller provided at the peripheral side of the fixing belt 44. The fixing unit 40 is configured to pass a sheet bearing an unfixed toner image through a nip between the fixing belt 44 and the press roller 41 formed by contact between the fixing roller 42 and the press roller 41 with pressure, to thereby heat and fix the image.

The fixing belt 44 is provided around the fixing roller 42 and the heat roller 43, and is closely in contact with the heat roller 43 and the fixing roller 42 by applying tension by a tension roller 45. the pressure roller 41 is pressed against part of the fixing belt 44 composed in the aforementioned manner, which is corresponding to the fixing roller 42, to thereby form a fixing nip.

Moreover, the fixing belt 44 is, for example, composed of a PI belt, which is an endless belt formed of a heat resistant resin having a thickness of 90 μm, and on a surface layer thereof an offset inhibitor, such as PFA (tetrafluoroethylene perfluoroalkylvinyl ether copolymer resin) is coated.

The heat source 46 is provided in a hollow space of the heat roller 43, but the fixing roller 42 does not contain a heat source. The fixing roller 42 is formed by coating the core (cored bar 49) having high rigidity, such as a metal (e.g., iron, and aluminum) with the thick elastic layer 50, such as silicone rubber. As for the heat source 46, a halogen heater, an infrared heater, or a thermal resistance element can be used. Moreover, it is preferred that a heat source be provided inside the pressure roller 41.

The fixing roller 42 and the press roller 41 are robber rollers provided to face each other. A nip between the heat roller 41 and the fixing belt 44 is formed by pressurizing the fixing roller 42 in the direction towards a center thereof with the press roller 41 via the fixing belt 44. Moreover, the driving unit is equipped with a motor and an array of reduction gears, and is connected to the fixing roller 42 with the gears. When the driving motor rotationally drives in the direction depicted with the arrow in FIG. 3, the fixing roller 42 is rotated in the direction depicted with the arrow. The pressure roller 41 and the fixing belt 44 in contact with the fixing roller 42 is rotated in the direction depicted with the arrow at the same speed by the rotation of the fixing roller 42.

Then, the heat applied from the heat source 46 provided in the hollow space of the heat roller 43 is transferred to the fixing belt 44 via the heat roller 43 to heat the fixing belt 44. The sheet is transported by counter rotation of the press roller 41 and the fixing belt 44, while the toner image of the sheet is heated and melting at the nip.

Note that, the tension roller 45 is provided at a substantially middle position of the fixing belt 44 held around the heat roller 43 and the fixing roller 42, and is pressed by a press member (not illustrated), such as a spring from the outside of the belt loop. As for the tension roller 45, a material having high rigidity, such as a metal (e.g., a cylindrical aluminum tube), is used as a core, and a surface of the core is coated with a material having a certain degree of elasticity, such as heat resistant felt, and silicone rubber. Note that, the tension roller 45 may be provided to press the fixing belt 44 from the inner side thereof.

Next, a thermistor serving as a temperature detecting unit is explained. The fixing unit 40 of the image forming apparatus of the present embodiment is provided with three thermistors. First, a thermistor (first thermistor, which may be also referred to as a heat roller temperature detecting member) 51 is provided at a position which is outside the fixing belt 44 and on a surface area of the heat roller, and is configured to detect the temperature of the fixing belt 44 in contact with the thermistor. Based on the temperature detected by the first thermistor 51, temperature of the nip, which is associated with fixing of a toner image, is controlled.

Moreover, a thermistor (second thermistor, which may be also referred to as a fixing roller surface temperature detecting member) 52 is provided at a position, which is outside the fixing belt, and on a surface area of the fixing roller, and is configured to detect temperature of the fixing roller through the fixing belt 44. Furthermore, a thermistor (third thermistor, which may be also referred to as a core temperature detecting member) 53 is provided at the part of the core of the fixing roller 42, and is configured to detect temperature of the core 49 of the fixing roller 42.

In the fixing unit 40 of the above-described structure, a sheet, on which a toner image has been formed, is transported in the direction depicted with the arrow in FIG. 3 from a fixing pre-guide (not illustrated) that is provided in upstream of the sheet transport direction of the fixing belt 44, and the toner image of the sheet is heated and melted at the nip, to thereby fix the toner image. Thereafter, the sheet is separated by a separation plate 48, and is then discharged to a sheet discharge section 30 by a pair of discharging roller 47 provided in downstream of the sheet transport direction.

In the case where a toner image composed of a toner containing a crystalline resin as a main binder resin is fixed, a toner image having excellent low temperature fixing ability can be attained with inhibiting a mark due to a discharging unit by making the passing speed of the recording paper in the fixing unit 40 faster than the passing speed of the recording paper at the discharging rollers.

Moreover, a toner having excellent low temperature fixing ability, hot offset resistance, and heat resistant storage stability can be attained by optimizing the structure of the toner, and satisfying the following formula:

S1−S2>0

where S1 is the passing speed of the recording medium in the fixing unit and S2 is the passing speed of the recording medium in the discharging unit.

When the passing speed of the recording medium in the fixing unit 40 is determined as S1, and the passing speed of the recording medium at the discharging rollers 47 serving as a discharging unit just after the fixing is determined as S2, S1 and S2 typically have a relationship of S1≦S2. This is because S1 and S2 are set in order to prevent paper jam, or gives margins in transporting. In the case where a toner containing a crystalline resin as a binder resin is used in the aforementioned setting, especially the case where the crystalline resin is a main component of the binder resin, however, hardness of the resin is low and therefore hardness of the toner is low, through the toner has excellent low temperature fixing ability. Therefore, the fixed toner image on the recording medium is rubbed with the discharging rollers just after the fixing, and therefore a mark of the discharging roller is formed on the image. By setting S1 faster than S1 to satisfy the formula: S1−S2>0, rubbing of the image by the discharging rollers does not occur, and therefore formation of marks due to the discharging rollers can be inhibited.

When the passing speed of the recording medium in the fixing unit is determined as S1, and the passing speed of the recording medium in the discharging unit is determined as S2, S1 and S2 preferably satisfy the following formula:

2%≦[(S1−S2)/S1]×100≦5%

When the value of [(S1−S2)/S1]×100 is less than 2%, S2 may become faster than S1 due to heat expansion of the discharging rollers caused over time. As a result, a mark due to the discharging unit may be formed. When the value of [(S1−S2)/S]×100 is greater than 5%, deflection of the recording paper becomes too large when the recording paper enters the discharging rollers, and therefore paper jam may occur. The image forming apparatus and image forming method can give excellent low temperature fixing ability, hot offset resistance, and heat resistant storage stability, can inhibit formation of a mark due to a discharging unit, and can form a high quality image.

### EXAMPLES

Examples of the present invention are explained hereinafter, but Examples shall not be construed as to limit the scope of the present invention in any way.

Note that, values of physical properties in Production Examples, Examples, and Comparative Examples were measured in the measurement methods described earlier.

### Production Example 1

### Production of Crystalline Polyurethane Resin A-1

A reaction vessel equipped with a stirrer and a thermoset was charged with 45 parts by mass (0.50 mol) of 1,4-butanediol, 59 parts by mass (0.50 mol) of 1,6-hexanediol, and 200 parts by mass of methyl ethyl ketone (MEK). To the resulting solution, 250 parts by mass (1.00 mol) of 4,4′-diphenylmethane diisocyanate (MDI), and the resultant was allowed to react for 5 hours at 80° C., followed by removing the solvent, to thereby obtain Crystalline Polyurethane Resin A-1.

Crystalline Polyurethane Resin A-1 had the weight average molecular weight Mw of 20,000, and the melting point of 60° C.

### Production Example 2

### Production of Urethane-Modified Crystalline Polyester Resin A-2

A reaction tank equipped with a cooling tube, a stirrer, and a nitrogen-inlet tube was charged with 202 parts by mass (1.00 mol) of sebasic acid, 15 parts by mass (0.10 mol) of adipic acid, 177 parts by mass (1.50 mol) of 1,6-hexanediol, and 0.5 parts by mass of tetrabutoxy titanate serving as a condensation catalyst, and the resulting mixture was allowed to react for 8 hours at 180° C. under a nitrogen gas flow while removing water generated.

The resultant was allowed to react for 4 hours under a nitrogen gas flow with gradually heating up to 220° C., while removing water generated and 1,6-hexanediol. The resultant was further allowed to react under the reduced pressure of 5 mmHg to 20 mmHg until the weight average molecular weight Mw of a reaction product reached about 12,000, to thereby obtain Crystalline Polyester Resin A′-2.

Crystalline Polyester Resin A′-2 had the weight average molecular weight Mw of 12,000.

Subsequently, Crystalline Polyester Resin A′-2 was transferred into a reaction tank equipped with a cooling tube, a stirrer, and a nitrogen-inlet tube. To the reaction tank, 350 parts by mass of ethyl acetate, and 30 parts by mass (0.12 mol) of 4,4′-diphenylmethane diisocyanate (MDI) were added, and the resulting mixture was allowed to react for 5 hours at 80° C. under a nitrogen gas flow. Next, ethyl acetate was removed under the reduced pressure, to thereby obtain Urethane-Modified Crystalline Polyester Resin A-2.

Urethane-Modified Crystalline Polyester Resin A-2 had the weight average molecular weight Mw of 22,000, and the melting point of 62° C.

### Production Example 3

### Production of Urethane-Modified Crystalline Polyester Resin A-3

A reaction tank equipped with a cooling tube, a stirrer, and a nitrogen inlet tube was charged with 185 parts by mass (0.91 mol) of sebasic acid, 13 parts by mass (0.09 mol) of adipic acid, 106 parts by mass (1.18 mol) of 1,4-butanediol, and 0.5 parts by mass of titanium dihydroxybia(triethanolaminate) serving as a condensation catalyst, and the resulting mixture was allowed to react for 8 hours at 180° C. under a nitrogen gas flow, while removing water generated. Subsequently, the resultant was allowed to react for 4 hours under a nitrogen gas flow with gradually heating up to 220° C., while removing water generated and 1,4-butanediol. The resultant was further allowed to react under the reduced pressure of 5 mmHg to 20 mmHg until the weight average molecular weight Mw of a reaction product reached about 14,000, to thereby obtain Crystalline Polyester Resin A′-3.

Crystalline Polyester Resin A′-3 had the weight average molecular weight Mw of 14,000.

Subsequently, Crystalline Polyester Resin A′-3 was transferred into a reaction tank equipped with a cooling tube, a stirrer, and a nitrogen-inlet tube. To the reaction tank, 250 parts by mass of ethyl acetate, and 12 parts by mass (0.07 mol) of hexamethylene diisocyanate (HDI) were added, and the resulting mixture was allowed to react for 5 hours at 80° C. under a nitrogen gas flow. Next, ethyl acetate was removed under the reduced pressure, to thereby obtain Urethane-Modified Crystalline Polyester Resin A-3.

Urethane-Modified Crystalline Polyester Resin A-3 had the weight average molecular weight Mw of 39,000, and the melting point of 63° C.

### Production Example 4

### Production of Urethane-Modified Crystalline Polyester Resin A-4

A reaction tank equipped with a cooling tube, a stirrer, and a nitrogen inlet tube was charged with 202 parts by mass (1.00 mol) of sebasic acid, 149 parts by mass (1.28 mol) of 1,6-hexanediol, and 0.5 parts by mass of tetrabutoxy titanate serving as a condensation catalyst, the resulting mixture was allowed to react for 8 hours at 180° C. under a nitrogen gas flow, while removing water generated. Subsequently, the resultant was allowed to react for 4 hours under a nitrogen gas flow with gradually heating up to 220° C., while removing water generated and 1,6-hexanediol. The resultant was further allowed to react under the reduced pressure of 5 mmHg to 20 mmHg until the weight average molecular weight Mw of a reaction product reached about 9,000, to thereby obtain Crystalline Polyester Resin A′-4.

Crystalline Polyester Resin A′-4 had the weight average molecular weight Mw of 9,000.

Subsequently, Crystalline Polyester Resin A′-4 was transferred into a reaction tank equipped with a cooling tube, a stirrer, and a nitrogen inlet tube. To the reaction tank, 250 parts by mass of ethyl acetate, and 28 parts by mass (0.11 mol) of 4,4′-diphenylmethane diisocyanate (MDI) were added, and the resulting mixture was allowed to react for 5 hours at 80° C. under a nitrogen gas flow. Next, ethyl acetate was removed under the reduced pressure, to thereby obtain Urethane-Modified Crystalline Polyester Resin A-4.

Urethane-Modified Crystalline Polyester Resin A-4 had the weight average molecular weight Mw of 30,000, and the melting point of 67° C.

### Production Example 6

### Production of Block Resin A-5 Composed of Crystalline Segment and Non-crystalline Segment

A reaction tank equipped with a cooling tube, a stirrer, and a nitrogen inlet tube was charged with 25 parts by mass (0.33 mol) of 1,2-propylene glycol, and 170 parts by mass of methyl ethyl ketone (MEK), followed by stirring the mixture. To the mixture, 147 parts by mass (0.59 mol) of 4,4′-diphenylmethane diisocyanates (MDI) was added, and the resulting mixture was allowed to react for 5 hours at 80° C., to thereby obtain a MEK solution of Non-crystalline Segment c-1 having an isocyanate group at a terminal thereof.

Separately, a reaction tank equipped with a cooling tube, a stirrer, and a nitrogen inlet tube was charged with 202 parts by mass (1.00 mol) of sebasic acid, 160 parts by mass (1.35 mol) of 1,6-hexanediol, and 0.5 parts by mass of tetrabutoxy titanate serving as a condensation catalyst, and the resulting mixture was allowed to react for 8 hours at 180° C. under a nitrogen gas flow while removing water generated. Subsequently, the resultant was allowed to react for 4 hours under a nitrogen gas flow with gradually heating up to 220° C., while removing water generated and 1,6-hexanediol. The resultant was further allowed to react under the reduced pressure of 5 mmHg to 20 mmHg until the weight average molecular weight Mw of a reaction product reached about 9,000, to thereby obtain Crystalline Polyester Resin A′-5.

Crystalline Polyester Resin A′-5 had the weight average molecular weight Mw of 8,500, and the melting point of 63° C.

Subsequently, a solution, in which 320 parts by mass of Crystalline Polyester Resin A′-5 serving as a crystalline segment was dissolved in 320 parts by mass of methyl ethyl ketone (MEK), was added to 340 parts by mass of the methyl ethyl ketone (MEK) solution of Non-crystalline Segment c-1, and the resulting mixture was allowed to react for 5 hours at 80° C. under a nitrogen gas flow. Subsequently, the methyl ethyl ketone (MEK) was removed under the reduced pressure, to thereby obtain Block Resin A-5.

Block Resin A-5 had the weight average molecular weight Mw of 26,000, and the melting point of 62° C.

### Production Example 6

### Production of Crystalline Polyurea Resin A-6

A reaction tank equipped with a cooling tube, a stirrer, and a nitrogen inlet tube was charged with 123 parts by mass (1.40 mol) of 1,4-butanediamine, 212 parts by mass (1.82 mol) of 1,6-hexanediamine, and 100 parts by mass of methyl ethyl ketone (MEK), followed by stirring the mixture. To the mixture, 336 parts by mass (2.00 mol) of hexamethylene diisocyanate (HDI) was added, and the resulting mixture was allowed to react for 5 hours at 60° C. under a nitrogen gas flow. Subsequently, the methyl ethyl ketone (MEK) was removed under the reduced pressure, to thereby obtain Crystalline Polyurea Resin A-6.

Crystalline Polyurea Resin A-6 had the weight average molecular weight Mw of 23,000, and the melting point of 64° C.

### Production Example 7

### Production of Crystalline Polyester Resin A-7

A reaction tank equipped with a cooling tube, a stirrer, and a nitrogen inlet tube was charged with 185 parts by mass (0.91 mol) of sebasic acid, 13 parts by mass (0.09 mol) of adipic acid, 125 parts by mass (1.39 mol) of 1,4-butanediol, and 0.5 parts by mass of titanium dihydroxybis(triethanolaminate) as a condensation catalyst, and the resulting mixture was allowed to react for 8 hours at 180° C. under a nitrogen gas flow, while removing water generated. Subsequently, the resultant was allowed to react for 4 hours under a nitrogen gas flow with gradually heating up to 220° C., while removing water generated and 1,4-butanediol. The resultant was further allowed to react under the reduced pressure of 5 mmHg to 20 mmHg until the weight average molecular weight Mw of a reaction product reached about 10,000, to thereby obtain Crystalline Polyester Resin A-7.

Crystalline Polyester Resin A-7 had the weight average molecular weight Mw of 9,500, and the melting point of 57° C.

### Production Example 8

### Production of Crystalline Resin Precursor B′-1

A reaction tank equipped with a cooling tube, a stirrer, and a nitrogen inlet tube was charged with 202 parts by mass (1.00 mol) of sebasic acid, 122 parts by mass (1.03 mol) of 1,6-hexanediol, and 0.5 parts by mass of titanium dihydroxybis(triethanolaminate) serving as a condensation catalyst, and the resulting mixture was allowed to react for 8 hours at 180° C. under a nitrogen gas flow, while removing water generated. Subsequently, the resultant was allowed to react for 4 hours under a nitrogen gas flow with gradually heating up to 220° C., while removing water generated and 1,6-hexanediol. The resultant was further allowed to react under the reduced pressure of 5 mmHg to 20 mmHg until the weight average molecular weight Mw of a reaction product reached about 25,000, to thereby obtain a crystalline resin.

The obtained crystalline resin was transferred into a reaction 1 tank equipped with a cooling tube, a stirrer, and a nitrogen inlet tube. To the reaction tank, 300 parts by mass of ethyl acetate, and 27 parts by mass (0.16 mol) of hexamethylene diisocyanate (HDD, and the resulting mixture was allowed to react for 5 hours at 80° C. under a nitrogen gas flow, to thereby obtain a 50% by mass ethyl acetate solution of Crystalline Resin Precursor B′-1 having an isocyanate group at a terminal thereof. The obtained ethyl acetate solution of Crystalline Resin Precursor B′-1 (10 parts by mass) was mixed with 10 parts by mass of tetrahydrofuran (THF), and 1 part by mass of dibutyl tin amine was added to the mixture, and the resultant was stirred for 2 hours.

The obtained solution was used as a sample, and subjected to GPC. As a result, Crystalline Resin Precursor B′-1 had the weight average molecular weight Mw of 54,000. Moreover, the solvent was removed from the solution to thereby obtain a sample, and the sample was subjected to DSC. As a result, Crystalline Resin Precursor B′-1 had the melting point of 57° C.

### Production Example 9

### Production of Urethane-Modified Crystalline Polyester Resin B-2

A reaction tank equipped with a cooling tube, a stirrer, and a nitrogen inlet tube was charged with 204 parts by mass (1.01 mol) of sebasic acid, 13 parts by mass (0.09 mol) of adipic acid, 136 parts by mass (1.15 mol) of 1,6-hexanediol, and 0.5 parts by mass of tetrabutoxy titanate serving as a condensation catalyst, and the resulting mixture was allowed to react for 8 hours at 180° C. under a nitrogen gas flow, while removing water generated. Subsequently, the resultant was allowed to react for 4 hours under a nitrogen gas flow with gradually heating up to 220° C., while removing water generated and 1,6-hexanediol. The resultant was further allowed to react under the reduced pressure of 5 mmHg to 20 mmHg until the weight average molecular weight Mw of a reaction product reached about 20,000, to thereby obtain Crystalline Polyester Resin B′-2.

Crystalline Polyester Resin B′-2 had the weight average molecular weight Mw of 20,000.

Subsequently, Crystalline Polyester Resin B′-2 was transferred into a reaction tank equipped with a cooling tube, a stirrer, and a nitrogen inlet tube. To the reaction tank, 200 parts by mass of ethyl acetate, and 15 parts by mass (0.06 mol) of 4,4′-diphenylmethane diisocyanate (MDI) were added, and the resulting mixture was allowed to react for 5 hours at 80° C. under a nitrogen gas flow. Subsequently, the ethyl acetate was removed under the reduced pressure, to thereby obtain Urethane-Modified Crystalline Polyester Resin B-2.

Urethane-Modified Crystalline Polyester Resin B-2 had the weight average molecular weight Mw of 39,000, and the melting point of 63° C.

### Production Example 10

### Production of Crystalline Polyurea Resin B-3

A reaction tank equipped with a cooling tube, a stirrer, and a nitrogen inlet tube was charged with 79 parts by mass (0.90 mol) of 1,4-butanediamine, 116 parts by mass (1.00 mol) of 1,6-hexanediamine, and 600 parts by mass of methyl ethyl ketone (MEK), followed by stirring the mixture. To the mixture, 475 parts by mass (1.90 mol) of 4,4′-diphenylmethane diisocyanate (MDI) was added, and the resulting mixture was allowed to react for 5 hours at 60° C. under a nitrogen gas flow. Subsequently, the methyl ethyl ketone (MEK) was removed under the reduced pressure, to thereby obtain Crystalline Polyurea Resin B-3.

Crystalline Polyurea Resin B-3 had the weight average molecular weight Mw of 57,000, and the melting point of 66° C.

### Production Example 11

### Production of Crystalline Polyester Resin B-4

A reaction tank equipped with a cooling tube, a stirrer, and a nitrogen inlet tube was charged with 230 parts by mass (1.00 mol) of dodecanedioic acid, 118 parts by mass (1.00 mol) of 1,6-hexanediol, and 0.5 parts by mass of tetrabutoxy titanate serving as a condensation catalyst, and the resulting mixture was allowed to react for 8 hours at 180° C. under a nitrogen gas flow, while removing water generated. Subsequently, the resultant was allowed to react for 4 hours under a nitrogen gas flow with gradually heating up to 220° C., while removing water generated and 1,6-hexanediol. The resultant was further allowed to react under the reduced pressure of 5 mmHg to 20 mmHg until the weight average molecular weight Mw of a reaction product reached about 50,000, to thereby obtain Crystalline Polyester Resin B-4.

Crystalline Polyester Resin B-4 had the weight average molecular weight Mw of 52,000, and the melting point of 66° C.

The raw materials used for the productions of the crystalline resins above, and physical properties of the crystalline resins are summarized in the folowing tables 1 to 3.

TABLE 1

| | | Polyurethane resin | | Urethane-modified polyester resin | | | | | |
|---|---|---|---|---|---|---|---|---|---|
| | | A-1 | | A-2 | | A-3 | | A-4 | |
| | | parts by | | parts by | | parts by | | parts by | |
| | Component | mass | mol | mass | mol | mass | mol | mass | mol |
| Alcohol | 1,4-butanediol | 45 | 0.50 | — | — | 106 | 1.18 | — | — |
| | 1,6-hexanediol | 59 | 0.50 | 177 | 1.50 | — | — | 149 | 1.28 |
| Carboxylic | adipic acid | — | — | 15 | 0.10 | 13 | 0.09 | — | — |
| acid | sebasic acid | — | — | 202 | 1.00 | 185 | 0.91 | 202 | 1.00 |
| Isocyanate | hexamethylene diisocyanate | — | — | — | — | 12 | 0.07 | — | — |
| | 4,4′-diphenylmethane | 250 | 1.00 | 30 | 0.12 | — | — | 28 | 0.11 |
| | diisocyanate | | | | | | | | |
| Amine | 1,4-butanediamine | — | — | — | — | — | — | — | — |
| | 1,6-hexanediamine | — | — | — | — | — | — | — | — |

| | | | | | |
|---|---|---|---|---|---|
| Catalyst | titanium dihydroxy | — | — | 0.5 | — |
| | bis(triethanolaminate) | | | | |
| | tetrabutoxy titanate | — | 0.5 | — | 0.5 |
| | dibutyl tin oxide | — | — | — | — |

| | | | | |
|---|---|---|---|---|
| Tm (° C.) | 60 | 62 | 63 | 67 |
| Mw | 20,000 | 22,000 | 39,000 | 30,000 |

| | | Polyurea Resin | | Polyester Resin | |
|---|---|---|---|---|---|
| | | A-6 | | A-7 | |
| | Component | parts by mass | mol | parts by mass | mol |
| Alcohol | 1,4-butanediol | — | — | 125 | 1.39 |
| | 1,6-hexanediol | — | — | — | — |
| Carboxylic | adipic acid | — | — | 13 | 0.09 |
| acid | sebasic acid | — | — | 185 | 0.91 |
| Isocyanate | hexamethylene diisocyanate | 336 | 2.00 | — | — |
| | 4,4′-diphenylmethane diisocyanate | — | — | — | — |
| Amine | 1,4-butanediamine | 123 | 1.40 | — | — |
| | 1,6-hexanediamine | 212 | 1.82 | — | — |

| | | | |
|---|---|---|---|
| Catalyst | titanium | — | 0.05 |
| | dihydroxybis(triethanolaminate) | | |
| | tetrabutoxy titanate | — | — |
| | dibutyl tin oxide | — | — |

| | | |
|---|---|---|
| Tm (° C.) | 64 | 57 |
| Mw | 23,000 | 9,500 |

TABLE 2

| | | Crystalline | |
|---|---|---|---|
| | | Segment/ | |
| | | Non-crystalline | |
| | | Segment Block | |
| | | Resin | |
| | | A-5 | |
| | | parts by | |
| | Component | mass | mol |
| Non-crystalline | 1,2-propylene glycol | 25 | 0.33 |
| Segment | 4,4′-diphenylmethane diisocyanate | 147 | 0.59 |
| Crystalline | 1,6-hexanediol | 160 | 1.35 |
| Segment | sebasic acid | 202 | 1.00 |

| | | |
|---|---|---|
| Catalyst | tetrabutoxy titanate | 0.5 |

| | |
|---|---|
| Tm (° C.) | 62 |
| Mw | 26,000 |

TABLE 3

| | | Crystalline | | Urethane- | |
|---|---|---|---|---|---|
| | | Resin | | Modified | |
| | | Precursor | | Polyester Resin | |
| | | B′-1 | | B-2 | |
| | | parts by | | parts by | |
| | Component | mass | mol | mass | mol |
| Alcohol | 1,4-butanediol | — | — | — | — |
| | 1,6-hexanediol | 122 | 1.03 | 136 | 1.15 |
| Carboxylic | adipic acid | — | — | 13 | 0.09 |
| acid | sebasic acid | 202 | 1.00 | 204 | 1.01 |
| | dodecanedioic acid | — | — | — | — |
| | dimethyl terephthalate | — | — | — | — |
| Isocyanate | hexamethylene diisocyanate | 27 | 0.16 | — | — |
| | 4,4′-diphenylmethane diisocyanate | — | — | 15 | 0.06 |
| Amine | 1,4-butanediamine | — | — | — | — |
| | 1,6-hexanediamine | — | — | — | — |
| Catalyst | titanium dihydroxybis(triethanolaminate) | 0.5 | | — | |
| | tetrabutoxy titanate | — | | 0.5 | |
| Tm (° C.) | | 57 | | 63 | |
| Mw | | 54,000 | | 39,000 | |
| | | Polyurea | | Polyester | |
| | | Resin | | Resin | |
| | | B-3 | | B-4 | |
| | | parts by | | parts by | |
| | Component | mass | mol | mass | mol |
| Alcohol | 1,4-butanediol | — | — | — | — |
| | 1,6-hexanediol | — | — | 118 | 1.00 |
| Carboxylic | adipic acid | — | — | — | — |
| acid | sebasic acid | — | — | — | — |
| | dodecanedioic acid | — | — | 230 | 1.00 |
| | dimethyl terephthalate | — | — | — | — |
| Isocyanate | hexamethylene diisocyanate | — | — | — | — |
| | 4,4′-diphenylmethane diisocyanate | 475 | 1.90 | — | — |
| Amine | 1,4-butanediamine | 79 | 0.90 | — | — |
| | 1,6-hexanediamine | 116 | 1.00 | — | — |

| | | | |
|---|---|---|---|
| Catalyst | titanium dihydroxybis(triethanolaminate) | — | — |
| | tetrabutoxy titanate | — | 0.5 |

| | | |
|---|---|---|
| Tm (° C.) | 66 | 66 |
| Mw | 57,000 | 52,000 |

### Production Example 12

### Production of Non-Crystalline Resin C-1

A reaction tank equipped with a cooling tube, a stirrer, and a nitrogen inlet tube was charged with 222 parts by mass of bisphenol A EO (2 mol) adduct, 129 parts by mass of bisphenol A PO (2 mol) adduct, 166 parts by mass of isophthalic acid, and 0.5 parts by mass of tetrabutoxy titanate, and the resulting mixture was allowed to react for 8 hours at 230° C. under a nitrogen gas flow at atmospheric pressure, while removing water generated. Subsequently, the resultant was further allowed to react under the reduced pressure of 5 mmHg to 20 mmHg, and the reaction mixture was cooled to 180° C. when the acid value thereof became 2 mgKOH/g. To the resultant, 35 parts by mass of trimellitic acid anhydride was added, and the resulting mixture was allowed to react for 3 hours under atmospheric pressure, to thereby obtain Non-crystalline Resin C-1.

Non-crystalline Resin C-1 had the weight average molecular weight Mw of 8,000, and the glass transition temperature Tg of 62° C.

### Production Example 13

### Production of Non-Crystalline Resin Precursor C-2

A reaction tank equipped with a cooling tube, a stirrer, and a nitrogen inlet tube was charged with 720 parts by mass of bisphenol A EO (2 mol) adduct, 90 parts by mass of bisphenol A PO (2 mol) adduct, 290 parts by mass of terephthalic acid, and 1 part by mass of tetrabutoxy titanate, and the resulting mixture was allowed to react for 8 hours at 230° C. under a nitrogen gas flow at atmospheric pressure, while removing water generated. Subsequently, the resultant was further allowed to react for 7 hours under the reduced pressure of 10 mmHg to 15 mmHg, to thereby obtain Non-crystalline Resin C-2′.

Subsequently, a reaction tank equipped with a cooling tube, a stirrer, and a nitrogen inlet tube was charged with 400 parts by mass of Non-crystalline Resin C-2′, 95 parts by mass of isophorone diisocyanate, and 500 parts by mass of ethyl acetate, and the resulting mixture was allowed to react for 8 hours at 80° C. under a nitrogen gas flow, to thereby obtain a 50% by mass ethyl acetate solution of Non-crystalline Resin Precursor C-2 having an isocyanate group at a terminal thereof.

### Production Example 14

### Production of Aqueous Dispersion Liquid of Resin Particles

A reaction vessel equipped with a stirring rod and a thermometer was charged with 600 parts by mass of water, 120 parts by mass of styrene, 100 parts by mass of methacrylic acid, 45 parts by mass of butyl acrylate, 10 parts by mass of sodium alkylallylsulfossucinate (ELEMINOL JS-2, manufactured by Sanyo Chemical Industries, Ltd.), and 1 part by mass of ammonium persulfate, and the resulting mixture was stirred for 20 minutes at 400 rpm, to thereby obtain white emulsion. The emulsion was heated to elevate the system temperature to 75° C., and was allowed to react for 6 hours. To the resultant, 30 parts by mass of a 1% by mass ammonium persulfate aqueous solution was added, and the resultant was aged for 6 hours at 75° C., to thereby obtain Aqueous Dispersion Liquid of Resin Particles.

### Production Example 15

### Production of Graft Polymer

A reaction vessel equipped with a stirring rod and a thermometer was charged of 480 parts by mass of xylene, and 100 parts by mass of low molecular weight polyethylene (SANWAX LEL-400, manufactured by Sanyo Chemical Industries, Ltd., softening point: 128° C.), and the polyethylene was sufficiently dissolved, followed by purging the reaction vessel with nitrogen. To the reaction vessel, a mixed solution containing 740 parts by mass of styrene, 100 parts by mass of acrylonitrile, 60 parts by mass of butyl acrylate, 36 parts by mass of di-t-butylperoxyhexahydroterephthalate, and 100 parts by mass of xylene was added dropwise over 3 hours at 170° C., and the temperature was maintained for 30 minutes. Subsequently, the solvent was removed from the reaction mixture to thereby synthesize a graft polymer.

### Production Example 16

### Preparation of Releasing Agent Dispersion Liquid (1)

A vessel equipped with a stirring rod and a thermometer was charged with 50 parts by mass of paraffin wax (hydrocarbon-based wax, HNP-9, manufactured by manufactured by NIPPON SEIRO CO., LTD., melting point: 75° C., SP value: 8.8), 30 parts by mass of the graft polymer, and 420 parts by mass of ethyl acetate, and the resulting mixture was heated to 80° C. with stirring, and the temperature was maintained at 80° C. for 5 hours, followed by cooling down to 30° C. over 1 hour. The resultant was dispersed by means of a bead mill (ULTRA VISCOMILL, manufactured by AIMEX CO., Ltd.) under the conditions: a liquid feed rate of 1 kg/hr, disc circumferential velocity of 6 m/s, 0.5 mm-zirconia beads packed to 80% by volume, and 3 passes, to thereby obtain Releasing Agent Dispersion Liquid (1).

### Production Example 17

### Production of Master Batch (1) to (8)

| | |
|---|---|
| Crystalline Polyurethane Resin A-1 | 100 parts by mass |
| Carbon black | 100 parts by mass |
| (Printex 35, manufactured by Evonik Degussa | |
| Japan Co., Ltd., DBP oil absorption: 42 mL/100 g, | |
| pH: 9.5) | |
| Ion-exchanged water | 50 parts by mass |

The raw materials listed above were mixed by means of HENSCHEL MIXER (manufactured by NIPPON COKE & ENGINEERING CO., LTD.). The obtained mixture was kneaded with a two-roll kneader. The kneading was initiated at the kneading temperature of 90° C., and then the temperature gradually reduced to 50° C. The obtained kneaded product was pulverized by a pulverizer (manufactured by Hosokawa Micron Corporation), to thereby produce Master Batch (1).

Master Batch (2) to Master Batch (8) were each produced in the same manner as the production of Master Batch (1), provided that the binder resin for use was changed as depicted in Table 4.

TABLE 4

| | Binder Resin |
|---|---|
| Master Batch (1) | A-1 |
| Master Batch (2) | A-2 |
| Master Batch (3) | A-3 |
| Master Batch (4) | A-4 |
| Master Batch (5) | A-5 |
| Master Batch (6) | A-6 |
| Master Batch (7) | A-7 |
| Master Batch (8) | C-1 |

### Production Example 18

### Production of Oil Phase (1) to (3), (5) to (8), (10), (12), (13)

A vessel equipped with a thermometer and a stirrer was charged with 35 parts by mass of Urethane-Modified Crystalline Polyester Resin A-2. To this, ethyl acetate was added in such an amount that a solid content of a mixture was to be 50% by mass. The resulting mixture was heated to temperature equal to or higher than the melting point of the resin, and the resin therein was sufficiently dissolved. To the resultant, 90 parts by mass of a 50% by mass ethyl acetate solution of Non-crystalline Resin C-1, 60 parts by mass of Releasing Agent Dispersion Liquid (1), and 12 parts by mass of Master Batch (2), and the resulting mixture was stirred at 50° C. by means of a TK homomixer (manufactured by PRIMIX Corporation) at 5,000 rpm to homogeneously dissolve and disperse, to thereby obtain Oil Phase (1′). Note that, the temperature of Oil Phase (1′) was maintained at 50° C. in the vessel, and Oil Phase (1′) was used within 5 hours from the production so that Oil Phase (1′) was not crystallized at the time of use.

Subsequently, just before the below-mentioned production of toner base particles, 28 parts by mass of a 50% by mass ethyl acetate solution of Crystalline Resin Precursor B-1 was added to 235 parts by mass of Oil Phase (1′) the temperature of which had been maintained at 50° C. and the resulting mixture was stirred by means of a TK homomixer (manufactured by PRIMIX Corporation) at 5,000 rpm to homogeneously dissolve and disperse, to thereby prepare Oil Phase (1).

Oil Phases (2), (3), (5) to (8), (10), (12), and (13) were each produced in the same manner as the production of Oil Phase (1), provided that a type and amount of Crystalline Resin A, a type and amount of Crystalline Resin B, an amount of Non-crystalline Resin C, and a type of the master batch were changed as depicted in Table 5. Note that, similarly to Crystalline Resin Precursor B-1 in the preparation of Oil Phase (1), Crystalline Resin B-1, and Non-crystalline Resin Precursor C-2 in Table 5 were added just before the production of toner base particles, to thereby prepare each oil phase.

### Production Example 19

### Production of Oil Phase (4), (9), (11)

A vessel quipped with a thermometer and a stirring rod was charged with 60 parts by mass of Urethane-Modified Crystalline Polyester Resin A-2, and 14 parts by mass of Urethane-Modified Crystalline Polyester Resin B-2. To this, ethyl acetate was added in such an amount that a solid content of a resulting mixture was to be 50% by mass, and the resulting mixture was heated to the temperature equal to or higher than the melting point of the resins to thereby sufficiently dissolve the resins. To the resultant, 40 parts by mass of a 50% by mass ethyl acetate solution of Non-crystalline Resin C-1, 60 parts by mass of Releasing Agent Dispersion Liquid (1), and 12 parts by mass of Master Batch (2) were added, and the resulting mixture was stirred at 50° C. by means of a TK homomixer (manufactured by PRIMIX Corporation) at 5,000 rpm to homogeneously dissolve and disperse, to thereby obtain Oil Phase (4). Note that, the temperature of Oil Phase (4) was maintained at 50° C. in the vessel and Oil Phase (4) was used within 5 hours from the production so that Oil Phase (4) was not crystallized at the time of use.

Oil Phases (9) and (11) were each produced in the same manner as the production of Oil Phase (4), provided that a type and amount of Crystalline Resin A, a type and amount of Crystalline Resin B, an amount of Non-crystalline Resin C, and a type of the master batch were changed as depicted in Table 5.

TABLE 5

| | Binder Resin | | | | | | | | |
|---|---|---|---|---|---|---|---|---|---|
| | Crystalline | | Crystalline | | | | | | |
| | Resin (A) | | Resin (B) | | Non-crystalline Resin (C) | | | | Master Batch |
| Oil Phase (1) | A-2 | 35 | B-1 | 14 | C-1 | 45 | — | — | Master Batch (2) |
| Oil Phase (2) | A-2 | 46.5 | B-1 | 17.5 | C-1 | 30 | — | — | Master Batch (2) |
| Oil Phase (3) | A-2 | 64 | B-1 | 30 | — | — | — | — | Master Batch (2) |
| Oil Phase (4) | A-2 | 60 | B-2 | 14 | C-1 | 20 | — | — | Master Batch (2) |
| Oil Phase (5) | A-3 | 54 | B-1 | 20 | C-1 | 20 | — | — | Master Batch (3) |
| Oil Phase (6) | A-4 | 54 | B-1 | 20 | C-1 | 20 | — | — | Master Batch (4) |
| Oil Phase (7) | A-5 | 54 | B-1 | 20 | C-1 | 20 | — | — | Master Batch (5) |
| Oil Phase (8) | A-2 | 54 | B-1 | 20 | C-1 | 20 | — | — | Master Batch (2) |
| Oil Phase (9) | A-6 | 52 | B-3 | 19 | C-1 | 22 | — | — | Master Batch (6) |
| Oil Phase (10) | A-1 | 54 | B-1 | 20 | C-1 | 20 | — | — | Master Batch (1) |
| Oil Phase (11) | A-7 | 54 | B-4 | 20 | C-1 | 20 | — | — | Master Batch (7) |
| Oil Phase (12) | A-2 | 15 | — | — | C-1 | 62 | C-2 | 17 | Master Batch (8) |
| Oil Phase (13) | A-2 | 30 | B-1 | 14 | C-1 | 50 | — | — | Master Batch (2) |

In Table 5, all the values are based on parts by mass.

### Production Example 20

### Preparation of Water Phase (1)

Water (990 parts by mass), 83 parts by mass of Aqueous Dispersion Liquid of Resin Particles, 37 parts by mass of a 48.5% aqueous solution of sodium dodecyldiphenyl ether disulfonate (ELEMINOL MON-7, manufactured by Sanyo Chemical Industries, Ltd.), and 90 parts by mass of ethyl acetate were mixed together and stirred, to thereby obtain Water Phase (1).

### Production Example 21

### Preparation of Water Phase (2)

Water (990 parts by mass), 37 parts by mass of a 48.5% aqueous solution of sodium dodecyldiphenyl ether disulfonate (ELEMINOL MON-7, manufactured by Sanyo Chemical Industries, Ltd.), and 90 parts by mass of ethyl acetate were mixed together and stirred, to thereby obtain Water Phase (2).

### Production Example 22

### Production of Toner Base Particles (1) to (3), (5) to (8), (10), (12), (13)

A vessel equipped with a stirrer and a thermometer was charged with 520 parts by mass of Water Phase (1), Water Phase (1) was heated to 40° C. While stirring Water Phase (1) at 13,000 rpm by a TK homomixer (manufactured by PRIMIX Corporation) with maintaining the temperature in the range of 40° C. to 50° C., Oil Phase (1) was added to Water Phase (1), and the mixture was emulsified for 1 minute, to thereby obtain Emulsified Slurry 1.

Subsequently, a vessel equipped with a stirrer and a thermometer was charged with Emulsified Slurry 1, and the solvent therein was removed at 60° C. for 6 hours, to thereby obtain Slurry 1. After subjecting Slurry 1 to vacuum filtration, the following washing treatment was performed.

(1) To the filtration cake, 100 parts by mass of ion-exchanged water was added, and the mixture was stirred by a TK homomixer (at 6,000 rpm for 5 minutes), followed by filtration.
(2) To the filtration cake obtained in (1), 100 parts by mass of a 10% by mass sodium hydroxide aqueous solution was added, and the resulting mixture was mixed by a TK homomixer (at 6,000 rpm for 10 minutes), followed by vacuum filtration.
(3) To the filtration cake obtained in (2), 100 parts by mass of 10% by mass hydrochloric acid, and the resulting mixture was mixed by a TK homomixer (at 6,000 rpm for 5 minutes), followed by filtration.
(4) To the filtration cake obtained in (3), 300 parts by mass of ion-exchanged water was added, and the resulting mixture was mixed by a TK homomixer (at 6,000 rpm for 5 minutes), followed by filtration. This course of process was performed twice, to thereby obtain Filtration Cake (1). Filtration Cake (1) was dried by a circulating dryer at 45° C. for 48 hours. Thereafter, the resultant was sieved with a mesh having an opening size of 75 μm, to thereby produce Toner Base Particles (1).

In the similar manner, Toner Base Particles (2) to (3), (5) to (8), (10), (12), and (13) were produced using Oil Phases (2), (3), (5) to (8), (10), (12), and (13), respectively.

### Production Example 23

### Production of Toner Base Particles (4), (9), (11)

A vessel equipped with a stirrer and a thermometer was charged with 520 parts by mass of Water Phase (2), Water Phase (2) was heated to 40° C. While stirring Water Phase (2) at 13,000 rpm by a TK homomixer (manufactured by PRIMIX Corporation) with maintaining the temperature in the range of 40° C. to 50° C., Oil Phase (4) was added to Water Phase (2), and the mixture was emulsified for 1 minute, to thereby obtain Emulsified Slurry 4.

Subsequently, a vessel equipped with a stirrer and a thermometer was charged with Emulsified Slurry 4, and the solvent therein was removed at 60° C. for 6 hours, to thereby obtain Slurry 4. After subjecting Slurry 4 to vacuum filtration, the following washing treatment was performed.

(1) To the filtration cake, 100 parts by mass of ion-exchanged water was added, and the mixture was stirred by a TK homomixer (at 6,000 rpm for 5 minutes), followed by filtration.
(2) To the filtration cake obtained in (1), 100 parts by mass of a 10% by mass sodium hydroxide aqueous solution was added, and the resulting mixture was mixed by a TK homomixer (at 6,000 rpm for 10 minutes), followed by vacuum filtration.
(3) To the filtration cake obtained in (2), 100 parts by mass of 10% by mass hydrochloric acid, and the resulting mixture was mixed by a TK homomixer (at 6,000 rpm for 5 minutes), followed by filtration.
(4) To the filtration cake obtained in (3), 300 parts by mass of ion-exchanged water was added, and the resulting mixture was mixed by a TK homomixer (at 6,000 rpm for 5 minutes), followed by filtration. This course of process was performed twice, to thereby obtain Filtration Cake (4).

Filtration Cake (4) was dried by a circulating dryer at 45° C. for 48 hours. Thereafter, the resultant was sieved with a mesh having an opening size of 75 μm, to thereby produce Toner Base Particles (4).

In the similar manner, Toner Base Particles (9) and (11) were produced using Oil Phase (9) and (11), respectively.

### Production Example 24

### Production of Toner (1) to (13)

By means of HENSCHEL MIXER (manufactured by NIPPON COKE & ENGINEERING CO., LTD.). 100 parts by mass of each of Toner Base Particles (1) to (13), and 1.0 part by mass of hydrophobic silica (HDK-2000, manufactured by Wacker Chemie AG) serving as external additives were mixed for 30 seconds at the rim speed of 30 m/sec, followed by rested for 1 minute. This cycle of the mixing process was performed 5 times, followed by sieving the resultant with a mesh having an opening size of 35 μm, to thereby produce Toners (1) to (13).

Toners (1) to (13) were subjected to the measurements of particle size distribution (Dv, Dn, Dv/Dn), storage elastic modulus G′(70), storage elastic modulus G′(160), crystallization degree C/(C+A), maximum peak temperature of second heating in DSC, capacity of heat of melting for second heating in DSC, ratio (Tsh2nd/Tsh1st), molecular weight distribution, and N element content. These measurements were performed in accordance with the aforementioned measurement methods. The results are depicted in Table 6.

### Production Example 25

### Production of Carrier

| | |
|---|---|
| Silicone resin | 100 parts by mass |
| (SR2400, manufactured by Dow Corning Toray Co., | |
| Ltd.) | |
| γ-(2-aminoethyl)aminopropyltrimethoxysilane | 5 parts by mass |
| Carbon black | 10 parts by mass |
| (REGAL E400R, manufactured by Cabot | |
| Corporation) | |
| Toluene | 100 parts by mass |

The raw materials listed above were dispersed by means of a homomixer for 20 minutes, to thereby prepare a resin layer coating liquid. Thereafter, the resin layer coating liquid was applied on a surface of spherical ferrite (1,000 parts by mass) having the volume average particle diameter of 35 μm by means of a fluidized-bed coater, to thereby produce a carrier.

### Production Example 26

### Production of Developer

Each of Toners (1) to (13) (5 parts by mass) was mixed with 95 parts by mass of the carrier, to thereby produce each of Developers (1) to (13).

Subsequently, evaluations of fixing ability (minimum fixing temperature and fixing width) and heat resistant storage stability were performed using each of Toners (1) to (13) and each of Developers (1) to (13). The results are depicted in Table 6.

### <Fixing Ability (Minimum Fixing Temperature)>

The image forming apparatus 100 illustrated in FIG. 1 was used. Toner (1) was set in a toner bottle 32K, and Developer (1) was set in the developing unit 5K. A solid image (image size: 3 cm×8 cm) was formed on an entire area of transfer paper (Copy Printing Sheet <70>, available from Ricoh Business Expert Co., Ltd.) so that the deposition amount of the toner after transferring was 0.85 mg/cm²±0.10 mg/cm², and the image was fixed with varying the temperature of the fixing belt. A surface of the obtained fixed image was subjected to a drawing test with a ruby needle (tip radius: 260 μm to 320 μm, tip angle: 60°), and load of 50 g, by means of a spiral scoring tester (AD-401, manufactured by Ueshima Seisakusho Co., Ltd.). The drawn surface was strongly rubbed with cloth (Hanicot #440, manufactured by Hanilon K.K.) 5 times. The temperature of the fixing belt at which hardly any image was scraped was determined as the minimum fixing temperature. Moreover, the solid image was formed in a position, which was 3.0 cm from the edge of the feeding direction. Note that, the traveling speed to pass the nip of the fixing unit was 120 mm/s. The lower the minimum fixing temperature is, more excellent the low temperature fixing ability is.

### <Fixing Ability (Fixing Width)>

The image forming apparatus 100 illustrated in FIG. 1 was used. Toner (1) was set in a toner bottle 32K, and Developer (1) was set in the developing unit 5K. A solid image (image size: 3 cm×8 cm) was formed on an entire area of transfer paper (Type 6200, manufactured by Ricoh Company Limited) so that the deposition amount of the toner after transferring was 0.85 mg/cm²±0.10 mg/cm², and the image was fixed with varying the temperature of the fixing belt. The presence of hot offset was visually observed, and a difference between the upper temperature at which hot offset did not occur and the minimum fixing temperature was determined as a fixing width.

Moreover, the solid image was formed in a position, which was 3.0 cm from the edge of the feeding direction. Note that, the traveling speed to pass the nip of the fixing unit was 120 mm/s.

Note that, the wider the fixing width is, more excellent hot offset resistance is. The average temperature width of a conventional full color toner is 50° C.

### <Heat Resistant Storage Stability (Penetration Degree)>

A 50 mL glass vessel was charged with each toner, and the glass vessel was left to stand in a thermostat the temperature of which was set to 50° C. for 24 hours. The toner was then cooled to 24° C., and subjected to a penetration degree test (JIS K2235-1991) to measure a penetration degree (mm). The results were evaluated based on the following criteria. Note that, the toner having the larger penetration degree means the toner having excellent storage stability against heat. The toner having the penetration degree of less than 5 mm highly likely causes a problem on practical use. Note that, in the present invention, the penetration degree is represented by a depth (mm) of penetration.

### [Evaluation Criteria]

A: Penetration degree was 25 mm or greater

B: Penetration degree was 15 mm or greater but less than 25 mm

C: Penetration degree was 5 mm or greater but less than 15 mm

D: Penetration degree was less than 5 mm

TABLE 6

| | | | | | | | Crystallization |
|---|---|---|---|---|---|---|---|
| | | | | | Storage elastic | | degree |
| | | Particle diameter | | | modulus G′[Pa] | | Mass ratio |
| Toner No. | | Dv(μm) | Dn(μm) | Dv/Dn | G′(70) | G′(160) | C/(C + A) |
| Toner | (1) | 6 | 5.2 | 1.15 | 960,000 | 3,000 | 0.16 |
| Toner | (2) | 5.7 | 5 | 1.14 | 200,000 | 6,000 | 0.21 |
| Toner | (3) | 5.9 | 5.1 | 1.16 | 50,000 | 8,500 | 0.31 |
| Toner | (4) | 6 | 4.6 | 1.3 | 100,000 | 1,100 | 0.27 |
| Toner | (5) | 5.4 | 4.6 | 1.17 | 400,000 | 6,000 | 0.25 |
| Toner | (6) | 5.8 | 5.1 | 1.14 | 200,000 | 8,000 | 0.25 |
| Toner | (7) | 6.2 | 5.4 | 1.15 | 60,000 | 5,000 | 0.22 |
| Toner | (8) | 5.2 | 4.6 | 1.13 | 60,000 | 4,000 | 0.23 |
| Toner | (9) | 6.3 | 4.8 | 1.31 | 620,000 | 1,000 | 0.12 |
| Toner | (10) | 5.6 | 4.8 | 1.17 | 590,000 | 15,000 | 0.14 |
| Toner | (11) | 5.9 | 4.4 | 1.34 | 10,000 | 800 | 0.39 |
| Toner | (12) | 6.3 | 4.8 | 1.31 | 900,000 | 900 | 0.01 |
| Toner | (13) | 6.2 | 5.4 | 1.15 | 1,120,000 | 2,300 | 0.15 |

| | | DSC | | |
|---|---|---|---|---|
| | | DSC peak | Capacity of heat of | |
| | | temperature | melting for second | |
| Toner No. | | (° C.) | heating (J/g) | Tsh2nd/Tsh1st |
| Toner | (1) | 54.8 | 31.0 | 0.85 |
| Toner | (2) | 56.6 | 42.2 | 0.90 |
| Toner | (3) | 62.0 | 72.1 | 1.05 |
| Toner | (4) | 60.1 | 51.8 | 0.95 |
| Toner | (5) | 59.4 | 50.9 | 0.95 |
| Toner | (6) | 62.3 | 50.9 | 0.95 |
| Toner | (7) | 57.7 | 48.2 | 0.90 |
| Toner | (8) | 57.7 | 50.9 | 0.95 |
| Toner | (9) | 63.4 | 46.7 | 0.85 |
| Toner | (10) | 57.2 | 46.3 | 0.85 |
| Toner | (11) | 56.5 | 55.7 | 1.05 |
| Toner | (12) | 55.8 | 9.0 | 0.30 |
| Toner | (13) | 57.1 | 33.2 | 0.85 |

| | | Molecular weight | | | | | | N element |
|---|---|---|---|---|---|---|---|---|
| | | | | | Mw/ | 100,000 or | 250,000 or | content |
| Toner No. | | Mn | Mw | Mpt | Mn | greater (%) | greater (%) | (mass %) |
| Toner | (1) | 8,800 | 24,000 | 20,900 | 2.7 | 13.8 | 1.2 | 0.42 |
| Toner | (2) | 10,300 | 27,800 | 25,900 | 2.7 | 14.8 | 1.5 | 0.62 |
| Toner | (3) | 14,800 | 43,000 | 37,600 | 2.9 | 22.3 | 2.1 | 0.95 |
| Toner | (4) | 7,800 | 23,000 | 19,100 | 2.9 | 4.0 | 1.1 | 0.58 |
| Toner | (5) | 14,200 | 42,500 | 39,500 | 3.0 | 16.3 | 1.4 | 0.64 |
| Toner | (6) | 13,900 | 38,800 | 34,900 | 2.8 | 18.6 | 1.6 | 0.73 |
| Toner | (7) | 11,000 | 33,100 | 30,100 | 3.0 | 16.5 | 1.7 | 1.93 |
| Toner | (8) | 12,000 | 32,300 | 30,400 | 2.7 | 15.8 | 1.6 | 0.71 |
| Toner | (9) | 11,000 | 32,000 | 26,200 | 2.9 | 17.2 | 1.7 | 8.99 |
| Toner | (10) | 11,400 | 30,900 | 27,800 | 2.7 | 18.4 | 1.7 | 4.53 |
| Toner | (11) | 5,800 | 16,900 | 15,200 | 2.9 | 1.1 | 0.1 | 0 |
| Toner | (12) | 3,200 | 9,600 | 8,900 | 3.0 | 15.4 | 1.5 | 0.13 |
| Toner | (13) | 9,000 | 29,000 | 20,900 | 3.2 | 15.1 | 1.3 | 0.46 |

| | | Fixing ability (° C.) | | Heat resistant |
|---|---|---|---|---|
| Toner No. | | Min. fixing | Fixing width | storage stability |
| Toner | (1) | 115 | 60 | B |
| Toner | (2) | 100 | >100 | A |
| Toner | (3) | 110 | >100 | A |
| Toner | (4) | 110 | 40 | A |
| Toner | (5) | 110 | >100 | A |
| Toner | (6) | 105 | >100 | A |
| Toner | (7) | 105 | >100 | A |
| Toner | (8) | 105 | >100 | A |
| Toner | (9) | 115 | 70 | C |
| Toner | (10) | 120 | >100 | C |
| Toner | (11) | 105 | 40 | C |
| Toner | (12) | 140 | 55 | B |
| Toner | (13) | 135 | 55 | C |

### Examples 1 to 8 and Comparative Examples 1 to 13-2

Next, by means of an image forming apparatus, in which a toner and a discharging unit were combined as depicted in Tables 7 and 8, evaluation of “mark due to a discharging unit” was performed in the following manner. The results are depicted in Tables 7 and 8.

### <Evaluation of Mark Due to Discharging Unit>

The image forming apparatus 100 illustrated in FIG. 1 was used. Each toner was set in a toner bottle 32K, and each developer was set in the developing unit 5K. A solid image (image size: A4) was formed on an entire area of transfer paper (Copy Printing Sheet <70>, available from Ricoh Business Expert Co., Ltd.) so that the deposition amount of the toner after transferring was 0.85 mg/cm²′ 0.10 mg/cm².

The passing speed S1 of the transfer sheet in the fixing unit was set to 120 mm/sec, and the passing speed S2 of the transfer paper in the discharging unit was adjusted to 126 mm/sec, 114 mm/sec, and 105 mm/sec. The presence of the roller mark of the discharging unit on the output image was visually observed, and evaluated based on the following criteria.

### [Evaluation Criteria of Mark Due to Discharging Unit]

I: No mark due to the discharging unit was confirmed.

II: No mark due to the discharging unit was confirmed when the image was observed from the top, but a mark due to the discharging unit could be confirmed when the image was observed from angle.

III: A mark due to the discharging unit could be confirmed when the image was observed from the top.

TABLE 7

| | | | | Heat | | | | Mark |
|---|---|---|---|---|---|---|---|---|
| | | Fixing ability (° C.) | | resistant | | | | due to |
| | | Min. | Fixing | storage | S1 | S2 | S1-S2 | discharging |
| | Toner | fixing | width | stabilty | (mm/sec) | (mm/sec) | (mm/sec) | unit |
| Ex. 1 | Toner (1) | 115 | 60 | B | 120 | 114 | 6 | II |
| Ex. 2 | Toner (2) | 100 | >100 | A | 120 | 114 | 6 | I |
| Ex. 3 | Toner (3) | 110 | >100 | A | 120 | 114 | 6 | I |
| Ex. 4 | Toner (4) | 110 | 40 | A | 120 | 114 | 6 | II |
| Ex. 5 | Toner (5) | 110 | >100 | A | 120 | 114 | 6 | I |
| Ex. 6 | Toner (6) | 105 | >100 | A | 120 | 114 | 6 | I |
| Ex. 7 | Toner (7) | 105 | >100 | A | 120 | 114 | 6 | I |
| Ex. 8 | Toner (8) | 105 | >100 | A | 120 | 114 | 6 | I |

TABLE 8

| | | | | Heat | | | | Mark |
|---|---|---|---|---|---|---|---|---|
| | | Fixing ability (° C.) | | resistant | | | | due to |
| | | Min. | Fixing | storage | S1 | S2 | S1-S2 | discharging |
| | Toner | fixing | width | stabilty | (mm/sec) | (mm/sec) | (mm/sec) | unit |
| Comp. | Toner (1) | 115 | 60 | B | 120 | 126 | −6 | III |
| Ex. 1 | | | | | | | | |
| Comp. | Toner (2) | 100 | >100 | A | 120 | 126 | −6 | III |
| Ex. 2 | | | | | | | | |
| Comp. | Toner (3) | 110 | >100 | A | 120 | 126 | −6 | III |
| Ex. 3 | | | | | | | | |
| Comp. | Tenet (4) | 110 | 40 | A | 120 | 126 | −6 | III |
| Ex. 4 | | | | | | | | |
| Comp. | Toner (5) | 110 | >100 | A | 120 | 126 | −6 | III |
| Ex. 5 | | | | | | | | |
| Comp. | Toner (6) | 105 | >100 | A | 120 | 126 | −6 | III |
| Ex. 6 | | | | | | | | |
| Comp. | Toner (7) | 105 | >100 | A | 120 | 126 | −6 | III |
| Ex. 7 | | | | | | | | |
| Comp. | Toner (8) | 105 | >100 | A | 120 | 126 | −6 | III |
| Ex. 8 | | | | | | | | |
| Comp. | Toner (9) | 120 | 65 | C | 120 | 126 | −6 | III |
| Ex. 9-1 | | | | | | | | |
| Comp. | Toner (9) | 120 | 65 | C | 120 | 114 | 6 | I |
| Ex. 9-2 | | | | | | | | |
| Comp. | Toner (10) | 120 | >100 | C | 120 | 126 | −6 | III |
| Ex. 10-1 | | | | | | | | |
| Comp. | Toner (10) | 120 | >100 | C | 120 | 114 | 6 | I |
| Ex. 10-2 | | | | | | | | |
| Comp. | Toner (11) | 105 | 40 | C | 120 | 126 | −6 | II |
| Ex. 11-1 | | | | | | | | |
| Comp. | Toner (11) | 105 | 40 | C | 120 | 114 | 6 | II |
| Ex. 11-2 | | | | | | | | |
| Comp. | Toner (12) | 140 | 55 | B | 120 | 126 | −6 | III |
| Ex. 12-1 | | | | | | | | |
| Comp. | Toner (12) | 140 | 55 | B | 120 | 114 | 6 | III |
| Ex. 12-2 | | | | | | | | |
| Comp. | Toner (13) | 135 | 55 | C | 120 | 126 | −6 | III |
| Ex. 13-1 | | | | | | | | |
| Comp. | Toner (13) | 135 | 55 | C | 120 | 114 | 6 | I |
| Ex. 13-2 | | | | | | | | |

As depicted in Tables 7 and 8, Examples 1 to 8 had the results that formation of the mark due to the discharging unit (a discharging roller) could be prevented, as the toner having excellent heat resistant storage stability as well as excellent low temperature fixing ability and a wide fixing width was used.

The embodiments of the present invention are, for example, as follows:

<1> An image forming method, containing:

forming an electrostatic latent image on an electrostatic latent image bearing member;

developing the electrostatic latent image with a toner to form a visible image;

transferring the visible image onto a recording medium;

fixing the transferred image on the recording medium; and

discharging the recording medium, on which the transferred image has been fixed, to outside the image forming apparatus,

wherein the toner contains a binder resin, a colorant, and a releasing agent,

wherein the binder resin contains a crystalline resin containing a urethane bond, or a urea bond, or both thereof, and the toner satisfies:

C/(C+A)≧0.15

where C is an integrated intensity of part of a spectrum derived from a crystalline structure of the binder resin, and A is an integrated intensity of part of the spectrum derived from a non-crystalline structure, and the spectrum is a diffraction spectrum of the toner as obtained by X-ray diffraction spectroscopy,

wherein a storage elastic modulus G′(70) of the toner at 70° C. is 5.0×10⁴ Pa≦G′(70)≦1.0×10⁶ Pa, and a storage elastic modulus G′(160) of the toner at 160° C. is 1.0×10³ Pa≦G′(160)≦1.0×10⁴ Pa, and wherein the image forming apparatus satisfies the following formula:

S1−S2>0

where S1 is a passing speed of the recording medium in a fixing unit used for the fixing, and S2 is a passing speed of the recording medium in a discharging unit used for the discharging.

<2> The image forming method according to <1>, wherein a maximum peak temperature of heat of melting of the toner for second heating is 50° C. to 70° C., and a capacity of the heat of melting of the toner for second heating is 30 J/g to 75 J/g, as measured by a differential scanning calorimeter (DSC).
<3> The image forming method according to <1> or <2>, wherein a tetrahydrofuran (THF) soluble component of the toner as measured by gel permeation chromatography (GPC) has 7% or greater of a component having a molecular weight of 100,000 or greater, and the toner has a weight average molecular weight Mw of 20,000 to 70,000.
<4> The image forming method according to any one of <1> to <3>, wherein the crystalline resin is a resin containing a crystalline polyester unit.
<5> The image forming method according to any one of <1> to <4>, wherein the crystalline resin is a block polymer of polyester and polyurethane.
<6> The image forming method according to any one of <1> to <5>, wherein the fixing and the discharging can be each separately driven.
<7> An image forming apparatus, containing:

an electrostatic latent image bearing member;

an electrostatic latent image forming unit configured to form an electrostatic latent image on the electrostatic latent image bearing member;

a developing unit configured to develop the electrostatic latent image with a toner, to thereby form a visible image;

a transferring unit configured to transfer the visible image onto a recording medium;

a fixing unit configured to fix the transferred image on the recording medium; and

a discharging unit configured to discharge the recording medium, on which the transferred image has been fixed, to outside the image forming apparatus,

wherein the toner contains a binder resin, a colorant, and a releasing agent,

wherein the binder resin contains a crystalline resin containing a urethane bond, or a urea bond, or both thereof, and the toner satisfies:

C/(C+A)≧0.15

where C is an integrated intensity of part of a spectrum derived from a crystalline structure of the binder resin, and A is an integrated intensity of part of the spectrum derived from a non-crystalline structure, and the spectrum is a diffraction spectrum of the toner as obtained by X-ray diffraction spectroscopy,

wherein a storage elastic modulus G′(70) of the toner at 70° C. is 5.0×10⁴ Pa≦G′(70)≦1.0×10⁶ Pa, and a storage elastic modulus G′(160) of the toner at 160° C. is 1.0×10³ Pa≦G′(160)≦0.1×10⁴ Pa, and wherein the image forming apparatus satisfies the following formula:

S1−S2>0

where S1 is a passing speed of the recording medium in the fixing unit, and S2 is a passing speed of the recording medium in the discharging unit.

This application claims priority to Japanese application No. 2013-118712, filed on Jun. 5, 2013 and incorporated herein by reference.

What is claimed is:

1. An image forming method, comprising:
forming an electrostatic latent image on an electrostatic latent image bearing member;
developing the electrostatic latent image with a toner to form a visible image;
transferring the visible image onto a recording medium;
fixing the transferred image on the recording medium; and
discharging the recording medium, on which the transferred image has been fixed, to outside the image forming apparatus,
wherein the toner contains a binder resin, a colorant, and a releasing agent,
wherein the binder resin contains a crystalline resin containing a urethane bond, or a urea bond, or both thereof, and the toner satisfies:
C/(C+A)≧0.15
where C is an integrated intensity of part of a spectrum derived from a crystalline structure of the binder resin, and A is an integrated intensity of part of the spectrum derived from a non-crystalline structure, and the spectrum is a diffraction spectrum of the toner as obtained by X-ray diffraction spectroscopy,
wherein a storage elastic modulus G′(70) of the toner at 70° C. is 5.0×10⁴ Pa≦G′(70)≦1.0×10⁶ Pa, and a storage elastic modulus G′(160) of the toner at 160° C. is 1.0×10³ Pa≦G′(160)≦1.0×10⁴ Pa, and
wherein the image forming apparatus satisfies the following formula:
S1−S2>0
where S1 is a passing speed of the recording medium in a fixing unit used for the fixing, and S2 is a passing speed of the recording medium in a discharging unit used for the discharging.

2. The image forming method according to claim 1, wherein a maximum peak temperature of heat of melting of the toner for second heating is 50° C. to 70° C., and a capacity of the heat of melting of the toner for second heating is 30 J/g to 75 J/g, as measured by a differential scanning calorimeter (DSC).

3. The image forming method according to claim 1, wherein a tetrahydrofuran (THF) soluble component of the toner as measured by gel permeation chromatography (GPC) has 7% or greater of a component having a molecular weight of 100,000 or greater, and the toner has a weight average molecular weight Mw of 20,000 to 70,000.

4. The image forming method according to claim 1, wherein the crystalline resin is a resin containing a crystalline polyester unit.

5. The image forming method according to claim 1, wherein the crystalline resin is a block polymer of polyester and polyurethane.

6. The image forming method according to claim 1, wherein the fixing and the discharging can be each separately driven.

7. An image forming apparatus, comprising:
an electrostatic latent image bearing member;
an electrostatic latent image forming unit configured to form an electrostatic latent image on the electrostatic latent image bearing member;
a developing unit configured to develop the electrostatic latent image with a toner, to thereby form a visible image;
a transferring unit configured to transfer the visible image onto a recording medium;
a fixing unit configured to fix the transferred image on the recording medium; and
a discharging unit configured to discharge the recording medium, on which the transferred image has been fixed, to outside the image forming apparatus,
wherein the toner contains a binder resin, a colorant, and a releasing agent,
wherein the binder resin contains a crystalline resin containing a urethane bond, or a urea bond, or both thereof, and the toner satisfies:
C/(C+A)≧0.15
where C is an integrated intensity of part of a spectrum derived from a crystalline structure of the binder resin, and A is an integrated intensity of part of the spectrum derived from a non-crystalline structure, and the spectrum is a diffraction spectrum of the toner as obtained by X-ray diffraction spectroscopy,
wherein a storage elastic modulus G′(70) of the toner at 70° C. is 5.0×10⁴ Pa≦G′(70)≦1.0×10⁶ Pa, and a storage elastic modulus G′(160) of the toner at 160° C. is 1.0×10³ Pa≦G′(160)≦1.0×10⁴ Pa, and
wherein the image forming apparatus satisfies the following formula:
S1−S2>0
where S1 is a passing speed of the recording medium in the fixing unit, and S2 is a passing speed of the recording medium in the discharging unit.
